(19) United States
(12) Patent Application Publication
(10) Pub. No.: US 2009/0086125 A1
(43) Pub. Date: Apr. 2, 2009

(54) Process for producing cellulose acylate film, cellulose acylate film, optically- compensatory film, polarizing plate and liquid-crystal display device

(75) Inventors: Sumio Ohtani, Kanagawa (JP); Takahiro Moto, Kanagawa (JP); Yosuke Nishiura, Kanagawa (JP); Takako Nishiura, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporatin, Tokyo (JP)

(21) Appl. No.: 11/919,753

(22) PCT Filed: Jun. 8, 2006
(86) PCT No.: PCT/JP2006/311970

§ 371 Date: Nov. 1, 2007

(30) Foreign Application Priority Data
Jun. 8, 2005 (JP) 2005-168479
Nov. 25, 2005 (JP) 2005-340911

(51) Int. Cl. G02F 1/1335; B29C 67/24; B29C 67/00; C08B 1/00; G02B 1/08

(52) U.S. Cl. 349/96; 264/330; 264/489; 536/56; 359/500

(57) ABSTRACT

A process for producing a cellulose acylate film comprising: casting a solution of a cellulose acylate having an acyl substitution degree of from 2.85 to 3.00 dissolved in at least one organic solvent onto an endless metal support; cooling the solution at 0° C. to −50° C. to effect gelation, so as to form a film; peeling the film off from the endless metal support; and drying the film.

### TECHNICAL FIELD

The present invention relates to a cellulose acylate film and a process for producing the same. Moreover, it further relates to optical materials such as an optically-compensatory film and a polarizing plate and a liquid-crystal display device using the same.

### BACKGROUND ART

Hitherto, cellulose acylate films have been used as supports for photographs, and various optical materials in view of the toughness and flame retardancy. In particular, recently, they have widely been used as optical transparent films for liquid-crystal display devices. Since cellulose acylate films have a high optical transparency and a high optical isotropy, they are excellent as optical materials for devices handling polarized light such as liquid-crystal display devices. Thus, they have hitherto been used as protective films for polarizers and supports for optically-compensatory films capable of improving the display viewed from an oblique direction (compensation of viewing angle).

In a polarizing plate which is one member for liquid-crystal display devices, a protective film for polarizers is formed by attachment to at least one side of the polarizer. A general polarizer is obtained by dyeing a stretched polyvinyl alcohol (PVA)-based film with iodine or a dichroic dye. In most cases, as the protective film for polarizers, a cellulose acylate film, especially a cellulose triacetate film, which is capable of direct attachment to PVA, is employed. It is important for the protective film for polarizers to be excellent in optical isotropy and the optical properties of the protective film for polarizers affect the properties of a polarizing plate to a large extent.

In recent liquid-crystal display devices, it has been strongly desired to improve a viewing angle property. Optical transparent films such as protective films for polarizers and supports for optically-compensatory films are desired to be more optically isotropic. It is important for optical isotropy to be a small retardation value represented by the product of birefringence and thickness of the optical film. In particular, in order to improve the display viewed from an oblique direction, it is necessary to lessen not only retardation in the in-plane direction (Re) but also retardation in the thickness direction (Rth). Specifically, at evaluation of optical properties of the optical transparent film, it is required that Re measured in front of the film is small and Re thereof does not change even when measured with changing the angle.

Thus, using polycarbonate-based films and thermoplastic cycloolefin films instead of cellulose acylate films, optically transparent films having a small change in Re with angle have been proposed [ZEONOR (manufactured by Nippon Zeon Corporation), ARTON (manufactured by JSR), etc.]. However, when these optically transparent films are used as protective films for polarizers, there arises a problem in attaching ability to PVA owing to hydrophobicity of the films. Also, heterogeneity of optical properties over the whole film surface is another problem. On the other hand, in JP-A-2005-120352, a cellulose acylate film, which is known to be excellent in attaching suitability to PVA, is upgraded by lowering optical anisotropy, and thus an optically isotropic and optically transparent film having an in-line Re of near zero and a small change in retardation with angle, i.e., Rth of near zero has been proposed. The patent document discloses that optical anisotropy can be lowered by increasing the acyl substitution degree of the cellulose acylate.

On the other hand, as a process for high-speed film preparation of a cellulose acylate film, a cooling gelation film preparation process is known (JP-A-62-115035). The process comprises casting a high concentration solution of a cellulose acylate, effecting gelation by immediately cooling it with hardly drying it, peeling off the gel from a support, and drying it. In this film preparation process, since double-side drying is carried out from the early stage of drying, drying is fastened and hence a high-speed film preparation can be achieved.

### DISCLOSURE OF THE INVENTION

In the above JP-A-2005-120352, a cellulose acylate film having a small optical anisotropy is successfully obtained but the disclosed production process does not necessarily have a sufficient productivity and thus a further improvement of productivity has been required. Furthermore, when the acyl substitution degree of the cellulose acylate is increased, there is observed a tendency of lowering solubility in a solvent and it is found that there are problems that filtration of the solution becomes difficult and foreign matter may remarkably increase in a film formed using a cellulose acylate having a high substitution degree.

Namely, a first object of the invention is to provide a process for producing a substantially optically isotropic cellulose acylate film having a small optical anisotropy (Re Rth) with high productivity and at low cost using a cellulose acylate having a large acyl substitution degree. A second object of the invention is to provide a cellulose acylate film having the above properties wherein insufficient solubility of the cellulose acylate having a high substitution degree is overcome and luminous foreign matter is present in a small amount.

As a result of extensive studies, the inventors of the invention have succeeded in production of a cellulose acylate film having a small optical anisotropy by producing a film using a highly substituted cellulose acylate having a substitution degree of from 2.85 to 3.00 by a cooling gelation film preparation process. Furthermore, they have found that, according to the cooling gelation film preparation process, there is exhibited an unexpectedly excellent effect that a cellulose acylate film having a larger elastic modulus and a smaller water vapor permeability can be obtained.

Moreover, against the problem that an insufficient dissolution occurs when a highly substituted cellulose acylate is tried to dissolve in a high concentration to thereby generate luminous foreign matter in a resultant film, they have found that the dissolution of the highly substituted cellulose acylate can be remarkably accelerated and the problem of the luminous foreign matter can be solved by the use of a specific cellulose acylate, specifically a cellulose acylate having a parameter of from 2.5 to 14.0 is used, the parameter being obtained by dividing a 6% viscosity value by a storage elastic modulus E′ (25) value of a 17% by mass solution when dissolved at 25° C., as well as by the dissolution of the cellulose acylate at a high temperature of 70° C. or higher and the like. (In this specification, mass ratio is equal to weight ratio.)

Namely, in the invention, it has been found that a cellulose acylate having a small optical anisotropy, a small water vapor permeability, and a large elastic modulus can be produced in a high speed and a high efficiency. In the invention, the above cellulose acylate containing little luminous foreign matter can be produced at high speed and high efficiency. Specifically, it can be achieved by the following means for solution.

(1) A process for producing a cellulose acylate film comprising:

casting a solution of a cellulose acylate having an acyl substitution degree of from 2.85 to 3.00 dissolved in at least one organic solvent onto an endless metal support;

cooling the solution at 0° C. to −50° C. to effect gelation, so as to form a film;

peeling the film off from the endless metal support; and

drying the film.

(2) The process for producing a cellulose acylate film as described in (1) above,

wherein the solution is a cellulose acylate solution containing a cellulose acylate in an amount of from 18 to 24% by mass.

(3) The process for producing a cellulose acylate film as described in (1) or (2) above,

wherein the cellulose acylate is dissolved in at least one organic solvent at a temperature of 70° C. or higher.

(4) The process for producing a cellulose acylate film as described in (3) above,

wherein the cellulose acylate is dissolved in at least one organic solvent under heating in line.

(5) The process for producing a cellulose acylate film as described in (3) or (4) above,

wherein the cellulose acylate is dissolved in at least one organic solvent under heating by utilizing a microwave.

(6) The process for producing a cellulose acylate film as described in any of (1) to (5) above,

wherein the cellulose acylate is a cellulose acylate having a parameter of from 2.5 to 14.0, in which the parameter is obtained by dividing a 6% viscosity value of the cellulose acylate by a storage elastic modulus E′ (25) value of a 17% by mass solution when dissolved at 25° C.

(7) The process for producing a cellulose acylate film as described in any of (1) to (6) above,

wherein the acyl group of the cellulose acylate is an acetyl group.

(8) A cellulose acylate film produced by a process as described in any of (1) to (7) above.

(9) The cellulose acylate film as described in (8) above, which has an absolute value of a retardation in a thickness direction Rth of 25 nm or less.

(10) The cellulose acylate film as described in (8) or (9) above, which has an elastic modulus of from 4.2 GPa to 6.0 GPa.

(11) The cellulose acylate film as described in any of (8) to (10) above,
wherein a water vapor permeability of the cellulose acylate film when a thickness of the cellulose acylate film is converted into 80 μm is from 350 to 450 g/m²/day.

(12) An optically-compensatory film comprising a cellulose acylate film as described in any of (8) to (11) above.

(13) A polarizing plate comprising:

a polarizer; and

at least one cellulose acylate film as described in any of (8) to (11) above,

wherein the at least one cellulose acylate film is utilized as a protective film of the polarizer.

(14) A liquid-crystal display device comprising at least one of a cellulose acylate film as described in any of (8) to (11) above, an optically-compensatory film as described in (12) above and a polarizing plate as described in (13) above.

### BRIEF DESCRIPTION OF THE DRAWING

FIG. 1 is a schematic diagram illustrating a dope-preparation line in a process for producing a film according to the invention; and

FIG. 2 is a schematic diagram illustrating another embodiment of a dope-preparation line in a process for producing a film according to the invention,

wherein 10 denotes a tank; 11, 13a and 16 denote jackets; 12 and 14 denote screw extruders; 13 and 21 denote heat exchangers for heating; 15 denotes a heat exchanger for cooling; 17 denotes a flight; 18 denotes a screw; 19 denotes a dope; 20 denotes a tank; 22 denotes a flush valve; 23 denotes a flushing tank; 24 denotes a static mixer; and 25 denotes a scraping machine.

### BEST MODE FOR CARRYING OUT THE INVENTION

The following will describe specific embodiments of the invention in detail. In the following description of the invention, the content of components contained in a cellulose acylate, e.g., the amount of residual sulfuric acid, the amount of minor metal components, and the like are described as “ppm” on the basis of mass relative to the cellulose acylate according to the conventional manner in the art, which is the same as “mg/kg” relative to the cellulose acylate.

### [Retardation, Re, Rth]

In the specification, Re and Rth represent in-plane retardation and retardation in a thickness direction at a wavelength λ, respectively. Re is measured with entering a light having a wavelength of λ nm in the normal line direction of the film on “KOBRA 21ADH” (manufactured by Oji Scientific Instruments). Rth is calculated based on retardation values measured in three directions in total, i.e., the above Re, a retardation value measured with entering a light having a wavelength of λ nm from the direction +40° tilted to the normal line direction of the film using the in-plane slow axis (judged by KOBRA 21ADH) as a tilt axis (rotation axis), and a retardation value measured with entering a light having a wavelength of λ nm from the direction −40° tilted to the normal line direction of the film using the in-plane slow axis as a tilt axis (rotation axis). As hypothetical values of mean refractive index herein, catalog values of various optical films in Polymer Handbook (JOHN WILEY & SONS, INC) can be employed. With regard to unknown values of mean refractive index, the values can be measured on an Abbe's refractometer. The values of mean refractive index of main optical films are exemplified in the following: cellulose acetate (1.48), cycloolefin polymer (1.52), polycarbonate (1.59), polymethyl methacrylate (1.49), polystyrene (1.59).

With inputting these hypothetical values of mean refractive index and the film thickness, KOBRA 21ADH calculates nx, ny, and nz.

The optical anisotropy of the cellulose acylate film of the invention, especially in-plane retardation Re(590) and retardation in the thickness direction Rth(590) measured at a wavelength of 590 nm, are preferably in the range satisfying the following formula (I) or (II).

0≦Re(590)≦10 (I)

|Rth(590)|≦25 (II)

The above formulae (I) and (II) are preferably,

0≦Re(590)≦5 (I)

|Rth(590)|≦10 (II),

more preferably,

0≦Re(590)≦3 (I)

|Rth(590)|≦5 (II),

particularly preferably,

0≦Re(590)≦2 (I)

|Rth(590)|≦2 (II).

### (Wavelength Dispersion |Re(400)−Re(700)| and |Rth(400)−Rth(700)|)

In the invention, the wavelength dispersion of retardation is determined as the absolute values of respective differences of Re's and Rth's at wavelengths of 400 nm and 700 nm calculated by the above method. A film having smaller wavelength dispersion of retardation can produce a display device which exhibit smaller tint change when seen from an oblique direction and is excellent in visibility.

The optical anisotropy of the cellulose acylate film of the invention, especially in-plane retardations and retardations in the thickness direction at wavelengths of 400 nm and 700 nm, are preferably in the range satisfying the following formula (I) or (II).

|Re(400)−Re(700)|≦10 (I)

|Rth(400)−Rth(700)|≦35 (II)

The above formulae (I) and (II) are more preferably,

|Re(400)−Re(700)|≦7 (I)

|Rth(400)−Rth(700)|≦25 (II),

particularly preferably,

|Re(400)−Re(700)|≦5 (I)

|Rth(400)−Rth(700)|≦15 (II).

### [Cellulose Acylate Starting Cotton]

As the cellulose acylate raw material for use in the invention, there may be included cotton fiber linter, wood pulp (hardwood pulp, softwood pulp), or the like. Cellulose acylates obtained from any cellulose raw materials can be employed and optionally, they may be used as a mixture. Detailed descriptions on these cellulose raw materials are given in Plastic Zairyo Koza (17) Sen-iso kei Jushi (written by Marusawa, Uda, Nikkan Kogyo Shinbun-sha, issued on 1970 and Hatsumei Kyokai Kokai Giho No. 2001-1745, pp. 7-8.

### [Substitution Degree of Cellulose Acylate, Mean Acylation Degree]

The following will describe the cellulose acylate of the invention produced using the above cellulose as a raw material. The cellulose acylate of the invention is one wherein the hydroxyl group of the cellulose is acylated. As the acyl group, any one from the acetyl group having 2 carbon atoms to one having 22 carbon atoms can be used. The substitution degree or mean acylation degree can be obtained by measuring the bonding degree of acetic acid and/or a fatty acid having 3 to 22 carbon atoms with which the hydroxyl group of the cellulose is substituted, followed by calculation. As the measuring method, the measurement can be carried out in accordance with ASTM D-817-91.

The theoretical upper limit of mean substitution degree of a cellulose acylate is 3.00 but the value of the mean substitution degree is desirably a high value which is close to 3.00 as far as possible. By using a cotton having a high substitution degree, it is possible to make optical anisotropy Re zero and Rth close to zero and hence the amount of a compound to be added for suppressing orientation in the in-plane direction of the film and in the film thickness direction can be reduced as before. In the case that the cellulose acylate is cellulose acetate, the acetyl substitution degree of the hydroxyl group in cellulose is desirably from 2.85 to 3.00. When the substitution degree is small, it becomes difficult to obtain preferable Re retardation and Rth retardation. The acetyl substitution degree is further desirably from 2.90 to 3.00, particularly desirably from 2.94 to 3.00. The closer to 3.00 the substitution degree is, the worse the solubility of cellulose acetate in a solvent tends to be. Therefore, the substitution degree of cellulose acetate hitherto widely used is from 2.7 to 2.85.

Among acetic acid and/or fatty acids having 3 to 22 carbon atoms with which the hydroxyl group of the cellulose is substituted, the acyl group having 2 to 22 carbon atoms is not particularly limited and may be an aliphatic acyl group or an aryl acyl group. The substitution mode on a cellulose unit may be an ester with single acyl group or a mixed ester with two or more acyl groups. They may be an alkylcarbonyl ester, an alkenylcarbonyl ester, an aromatic carbonyl ester, an aromatic alkylcarbonyl ester, or the like ester of cellulose, each of them optionally having a further substituted group. Preferred examples of these acyl group include acetyl, propionyl, butanoyl, heptanoyl, hexanoyl, octanoyl, decanoyl, dodecanoyl, tridecanoyl, tetradecanoyl, hexadecanoyl, octadecanoyl, iso-butanoyl, t-butanoyl, cyclohexanecarbonyl, oleoyl, benzoyl, naphthylcarbonyl cinnamoyl, and the like groups. Of these, acetyl, propionyl, butanoyl, dodecanoyl, octadecanoyl, t-butanoyl, oleoyl, benzoyl, naphthylcarbonyl, cinnamoyl, and the like groups are preferred, and acetyl, propionyl and butanoyl are more preferred.

It has been found that the optical anisotropy of the cellulose acylate film can be lowered in the case that the total substitution degree is from 2.70 to 3.00 when the acyl substituents are substantially composed of at least two of acetyl group/propionyl group/butanoyl group among the above acyl substituents with which the hydroxyl group of the cellulose is substitute. More preferred acyl substitution degree is from 2.76 to 3.00, and more desired is from 2.83 to 3.00.

### [Polymerization Degree of Cellulose Acylate]

The cellulose acylate to be preferably used in the invention has a viscosity-average polymerization degree of from 180 to 700. In cellulose acetate, the viscosity-average polymerization degree is preferably from 200 to 550, more preferably from 250 to 400, particularly preferably from 280 to 350. When the polymerization degree is too high, the viscosity of the dope solution of the cellulose acylate increases to a high value and film preparation by casting becomes difficult. When the polymerization degree is too low, the strength of the prepared film decreases. The average polymerization degree can be measured by the intrinsic viscosity method of Uda et al. (Kazuo Uda, Hideo Saito, Sen-i Gakkaishi, vol. 18, No. 1, pp. 105-120, 1962). Detailed descriptions thereon are given in JP-A-9-95538.

### (Viscosity Property of Cellulose Acylate)

The intrinsic viscosity property of the cellulose acylate is represented by “6% viscosity value”. The 6% viscosity value is determined by dissolving a cellulose acylate in an amount of 6% by mass in a mixed solvent of methylene chloride and methanol in a mass ratio of 91:9, measuring a flowing time at 25° C. using an Ostwald viscometer, and calculating 6% viscosity according to the following equation.

6% Viscosity(mPa·s)=Flowing Time(second)×Viscometer Coefficient

The “viscometer coefficient” is determined by measuring flowing time (second) in the same manner as in the case of the above solution using a standard solution for viscometer calibration.

Here, “Viscometer Coefficient=Absolute Viscosity of Standard Solution (cps)×Density of Solution (1.235 g/cm³)/Density of Standard Solution (g/cm³)/Flowing Time of Standard Solution (second)”.

A preferred 6% viscosity value in the invention is from 260 to 700. When the 6% viscosity value is 260 or more, inner pressure of pressurizing die can be set at a sufficiently high value at film preparation and homogeneous extrusion can be achieved in a width direction, so that the case is preferred. When the 6% viscosity value is 700 or less, the cellulose acylate solution can be filtrated under a suitable over-pressure at filtration thereof, so that the case is preferred. The 6% viscosity value is more preferably from 300 to 500, particularly preferably from 350 to 470.

### [Solubility of Cellulose Acylate and Viscoelastic Properties of Solution)

In the invention, there exists a problem that a highly substituted cellulose acylate is poor in solubility in a solvent. Such a problem can be overcome to some extent by devising how to dissolve it, e.g., by dissolving it under high pressure and high temperature. Furthermore, for the purpose of effecting cooling gelation film preparation, preparation of a high concentration solution is advantageous and hence a cellulose acylate capable of high concentration dissolution has been investigated.

As a result of extensive investigations, the present inventors have further found the following. In a general synthetic polymer, it is known that viscosity of a solution obtained by dissolving the polymer in a poorly soluble solvent decreases. However, it has been found that, in the case of highly substituted cellulose acylates, a cellulose acylate having poorer solubility contrarily results in higher viscosity as compared with more highly soluble one when dissolved at the same concentration and at the same temperature even when the molecular mass s are the same. Moreover, when the cellulose acylate is more efficiently dissolved by raising dissolution temperature, the solution viscosity decreases. Upon analysis of constituents of the viscosity, it has been found that the value of storage elastic modulus term largely varies depending on the kind of the cellulose acylate and dissolution temperature. In highly substituted cellulose acylates having a similar molecular mass, the poorer the solubility is, the larger the difference in storage elastic modulus (Pa) of a low-temperature-dissolved solution is, as compared with an acylate exhibiting good solubility. However, the storage elastic modulus in the case of dissolution at high temperature is not so different from that of the acylate exhibiting good solubility. Namely, it has been found that a cellulose acylate even having a high substitution degree is excellent in solubility and thus a film containing little luminous foreign matter can be prepared by selecting a cellulose acylate having a ratio E′ (70)/E′ (25) of from 0.45 to 1.0 wherein E′ (70) is storage elastic modulus of a solution dissolved at 70° C. and E′ (25) is storage elastic modulus of a solution dissolved at 25° C. when a solution of 17% by mass of a cellulose acylate is prepared by dissolving it in a mixed solvent of methylene chloride and methanol in a mass ratio of 87:13. The smaller the ratio is, the poorer the solubility is. Also, the closer to 1.0 the ratio is, the better the solubility is. In most of the cellulose acylates having a substitution degree of 2.85 or less which have been hitherto widely used, this ratio on storage elastic modulus is almost 1.0. However, since cellulose acylates having a high substitution degree are poor in solubility, those having a ratio E′ (70)/E′ (25) of 1.0 have not yet been found. Thus, practically preferred ratio on storage elastic modulus is from 0.55 to 0.88.

Similarly, a parameter obtained by dividing the 6% viscosity value (mPa·s) of a cellulose acylate by the value of storage elastic modulus E′ (25) of a solution dissolved at 25° C. is preferably from 2.5 to 14.0, more preferably from 4.5 to 10.0. From the practical viewpoint, those having the parameter value of from 5.0 to 7.5 are particularly preferred. When the value falls within the range, solubility of cellulose acylates is good.

### [Average Molecular Mass]

Moreover, the molecular mass distribution of the cellulose acylates preferably used in the invention is evaluated by gel permeation chromatography. Preferred range of number-average molecular mass Mn is from 50,000 to 150,000 and more preferred is from 70,000 to 120,000. Preferred range of mass-average molecular mass Mw is from 130,000 to 360,000 and more preferred is from 200,000 to 310,000. It is preferred that polydispersity index Mw/Mn (w means mass-average molecular mass and Mn means number-average molecular mass) thereof is small and molecular mass distribution is narrow. Specifically, the value of Mw/Mn is preferably from 2.0 to 4.0, more preferably from 2.3 to 3.4. When Mw/Mn is too small, the viscosity of a cellulose acylate solution decreases and when Mw/Mn is too large, low-molecular-mass components are apt to be eluted and solution viscosity tends to increase, so that both cases are not preferred. Preferred range of Z-average molecular mass Mz is from 190,000 to 800,000 and more preferred is from 400,000 to 650,000.

When low-molecular-mass components are removed, average molecular mass (polymerization degree) increases. However, when cellulose acylates having the same average molecular mass are compared each other, one from which low-molecular-mass components are removed is more useful since viscosity when converted into a solution is lower than that of the usual cellulose acylate. A cellulose acylate containing lesser low-molecular-mass components can be obtained by removing low-molecular-mass components from a cellulose acylate synthesized by a usual method. The removal of the low-molecular-mass components can be carried out by washing the cellulose acylate with a suitable organic solvent.

### [Water Content]

Upon use for production of the cellulose acylate of the invention, it has a water content of preferably 2% by mass or less, more preferably 1% by mass or less, in particular 0.7% by mass or less. In general, a cellulose acylate contains water, and the content is known to be 2.5 to 5% by mass. In order to reduce the water content to the above level, the cellulose acylate must be dried. The drying method is not particularly limited as long as the water content can be adjusted to the intended level. As to the raw cotton and the synthesizing process of the cellulose acylate of the invention, detailed descriptions are given in Hatsumei Kyokai Kokai Giho (Kogi No. 2001-1745, issued on Mar. 15, 2001 by Hatsumei Kyokai), pp. 7-12.

### (Form)

The powder properties of the cellulose acylate to be used in the invention are not particularly limited as far as they are within ordinary ranges. Preferred response angle is from 20° to 50°, and more preferred is from 25° to 45°. Preferred bulk density is from 0.3 g/cm³ to 0.75 g/cm³ and more preferred is from 0.4 g/cm³ to 0.65 g/cm³. Particle size is preferably from 0.01 to 10 mm, more preferably from 0.1 to 4 mm. When the acylate is the powder having properties within such ranges, there arise no problems in handling of the cellulose acylate and automatic charging such as delivering with air or automatic weighing can be applied.

### (Contained Elements)

Usually, sulfuric acid, acetic acid, calcium hydroxide, magnesium hydroxide, and the like used in the synthetic process of the cellulose acylate remain as they are or in the form reacted with the cellulose acylate. In addition, contamination of iron ions as impurities is also known. In the invention, preferred ranges of the contents of the above various substances remaining in the cellulose acylate are from 30 to 150 ppm for the amount of sulfuric acid, from 10 to 120 ppm for calcium, from 0.1 to 20 ppm for magnesium, and 3 ppm or less for iron. Moreover, the content of free acetic acid is from 0.01 to 0.2%.

The cellulose acylate for use in the invention may be used singly or two or more of them can be used as a mixture as far as it has a substituent, a substitution degree, a polymerization degree, a molecular mass distribution which fall within the above ranges.

### [Additives for Cellulose Acylate]

In the invention, various additives (e.g., an optical anisotropy-decreasing compound, a wavelength dispersion regulator, an ultraviolet-preventing agent, a plasticizer, a deterioration inhibitor, fine particles, an optical property regulator, and the like) can be added to the cellulose acylate solution in respective preparing steps, depending upon the end use thereof. They will be described in the following. Moreover, the timing of the addition thereof may be at any time during the dope preparation step and the addition may be carried out with incorporating a step of adding additive(s) and preparing a dope at the final stage of the dope preparation step.

### [Rth-Decreasing Compound]

The cellulose acylate film of the invention desirably contains at least one kind of compounds which decreases retardation in a thickness-direction Rth (hereinafter also referred to as Rth decreasing agent) in an amount of 0.01 to 30% by mass relative to the raw material polymer of the cellulose acylate film.

More desirably, it contains Rth decreasing agent in the range satisfying the following numerical formulae (3) and (4).

(Rth_{A}−Rth₀)/A≦−1.0 Numerical formula (3)

0.01≦A≦30 Numerical formula (4)

In the above numerical formulae (3) and (4), still desirable are as follows:

(Rth_{A}−Rth₀)/A≦−2.0 Numerical formula (3-1)

0.05≦A≦25 Numerical formula (4-1)

and particularly preferred are as follows:

(Rth_{A}−Rth₀)/A≦−3.0 Numerical formula (3-2)

0.1≦A≦20 Numerical formula (4-2).

Here, Rth_{A} is Rth (nm) of a film containing A % of a Rth-decreasing compound, Rth₀ is Rth (nm) of a film containing no Rth-decreasing compound, and A is a mass (%) of the compound when the mass of the raw material polymer of the film is regarded as 100.

### (Structural Characteristics of Rth Decreasing Agent)

The following will describe the Rth decreasing agent of the cellulose acylate film.

In order to sufficiently decrease optical anisotropy to make both Re and Rth close to zero, it is preferred to use a compound which inhibits orientation of the cellulose acylate in the film in in-plane and thickness directions. Moreover, it is advantageous that the optical anisotropy-decreasing compound is sufficiently compatible with the cellulose acylate and the compound itself does not have a rod-like structure or a planar structure. Specifically, when it has plurality of planar functional groups such as aromatic groups, a structure wherein these functional groups are present not in the same plane but in non-plane is advantageous.

### (Log P Value)

In the preparation of the cellulose acylate film of the invention, as described above, it is preferred to select a compound having an octanol-water partition coefficient (log P value) of from 0 to 7 among the Rth decreasing agents which inhibit orientation of the cellulose acylate in the film in the in-plane and thickness directions. A compound having a log P value of 7 or less is excellent in compatibility with the cellulose acylate and inconveniences such as white turbidity and powdering of the film are not generated. Moreover, a compound having a log P value of 0 or more is preferred since hydrophilicity is not too high and problems such as deterioration of water resistance of the cellulose acetate film are not generated. Further preferred range of the lop P value is from 1 to 6 and particularly preferred range is from 1.5 to 5.

The measurement of the octanol-water partition coefficient (log P value) can be carried out by a flask-shaking method described in JIS Z-7260-107 (2000). Moreover, it is also possible to estimate the octanol-water partition coefficient (log P value) by a computing chemical method or an empirical method instead of the actual measurement. As the computing method, Crippen's fragmentation method {“J. Chem. Inf. comput. Sci.”, Vol. 27, p. 21 (1987)}, Viswanadhan's fragmentation method {“J. Chem. Inf. comput. Sci.”, Vol. 29, p. 163 (1989)}, Broto's fragmentation method {“Eur. J. Med. Chem.-Chim. Theor.”, Vol. 19, p. 71 (1984)}, and the like are preferably employed but Crippen's fragmentation method is more preferred. In the case that the log P value of a compound is different between the measuring method and the computing method, whether the compound falls within the above range or not is judged by Crippen's fragmentation method.

### (Physical Properties of Rth Decreasing Agent)

The Rth decreasing agent may or may not contain an aromatic group. Moreover, the Rth decreasing agent has a molecular mass of preferably from 150 to 3,000, more preferably from 170 to 2,000, particularly preferably from 200 to 1,000. As far as the molecular mass falls within these ranges, it may have a specific monomer structure or an oligomer structure or polymer structure wherein plurality of the monomer units are combined.

The Rth decreasing agent is preferably liquid at 25° C. or a solid having a melting point of from 25° C. to 250° C., more preferably liquid at 25° C. or a solid having a melting point of from 25° C. to 200° C. Moreover, the Rth decreasing agent is preferably not evaporated in the process of dope casting and drying in the preparation of the cellulose acylate film.

The amount of the Rth decreasing agent to be added is preferably from 0.01 to 30% by mass, more preferably from 1 to 25% by mass, particularly preferably from 5 to 20% by mass relative to the cellulose acylate.

The Rth decreasing agent may be used singly or may be used as a mixture of two or more compounds at any ratio. The timing of the addition of the Rth decreasing agent may be at any time during the dope preparation step and may be at the final stage of the dope preparation step.

As such an Rth decreasing agent, a compound represented by the following formula (1) is preferred.

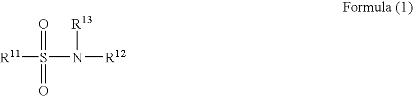

In the above formula (1), R¹¹ represents an alkyl group or an aryl group, R¹² and R¹³ each independently represents a hydrogen atom, an alkyl group, or an aryl group. Moreover, sum of the carbon atoms of R¹¹, R¹², and R¹³ is particularly preferably 10 or more, and these alkyl group and aryl group may have a substituent.

As the substituent, a fluorine atom, an alkyl group, an aryl group, an alkoxy group, a sulfone group, and a sulfonamide group are preferred, and an alkyl group, an aryl group, an alkoxy group, a sulfone group, and a sulfonamide group are particularly preferred.

The alkyl group may be linear, branched, or cyclic and those having 1 to 25 are preferred, those having 6 to 25 carbon atoms are more preferred, and those having 6 to 20 carbon atoms, e.g., methyl, ethyl, propyl, isopropyl, butyl, isobutyl, t-butyl, amyl, isoamyl, t-amyl, hexyl, cyclohexyl, heptyl, octyl, bicyclooctyl, nonyl, adamantyl, decyl, t-octyl, undecyl, dodecyl, tridecyl, tetradecyl, pentadecyl, hexadecyl, heptadecyl, octadecyl, nonadecyl, didecyl, and the like are particularly preferred.

As the aryl group, those having 6 to 30 carbon atoms are preferred and those having 6 to 24 carbon atoms, e.g., phenyl, biphenyl, terphenyl, naphthyl, binaphthyl, triphenylphenyl, and the like are particularly preferred. Preferred examples of the compound represented by the formula (1) are shown in the following but the invention is not limited to these specific examples.

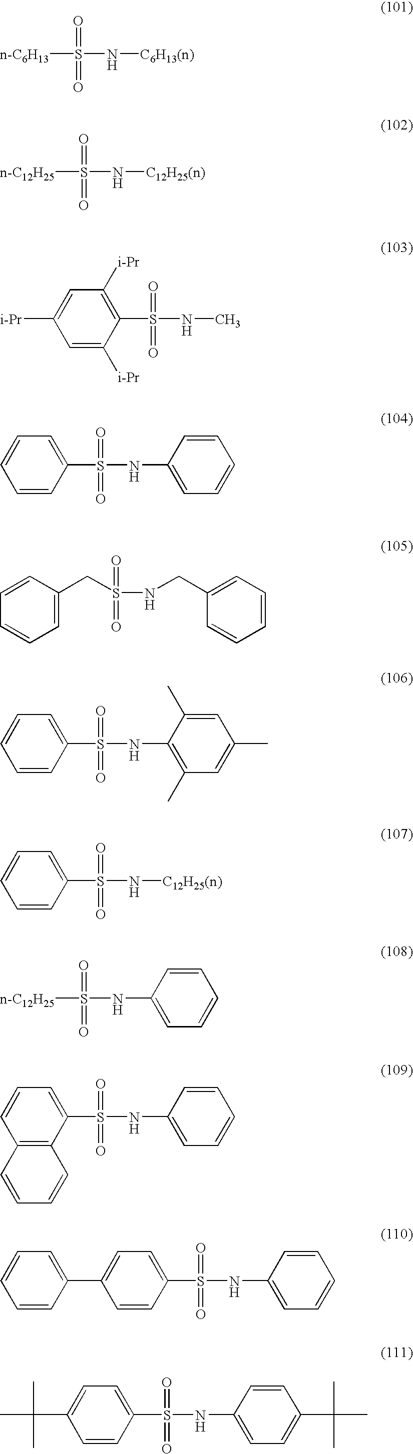

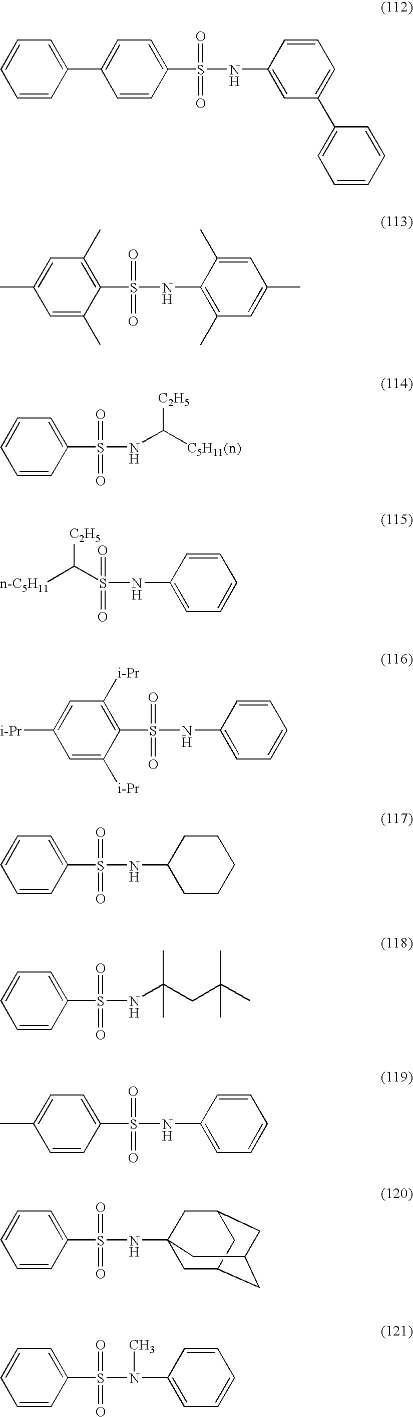

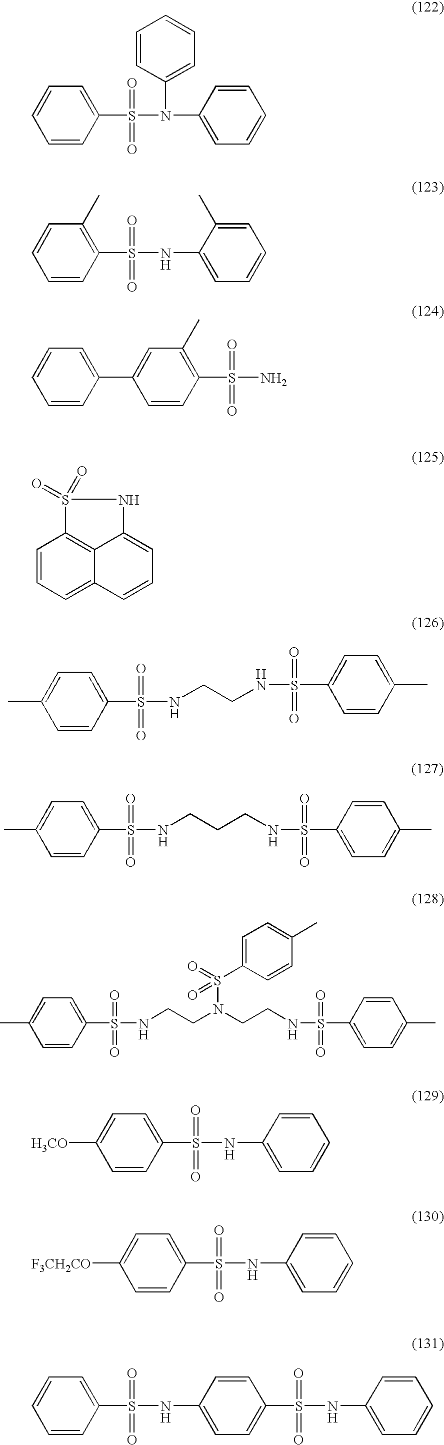

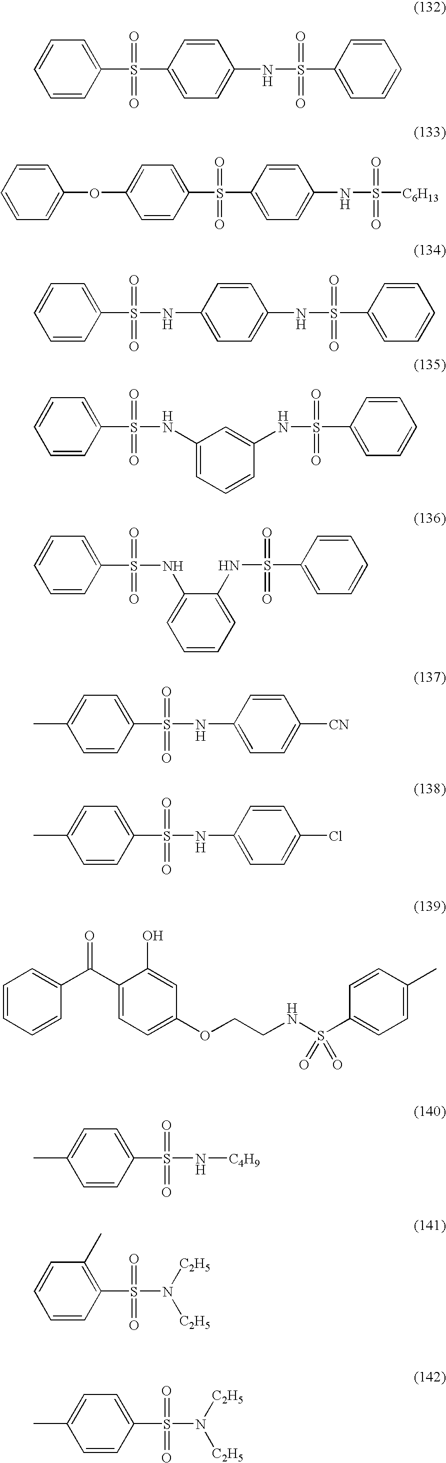

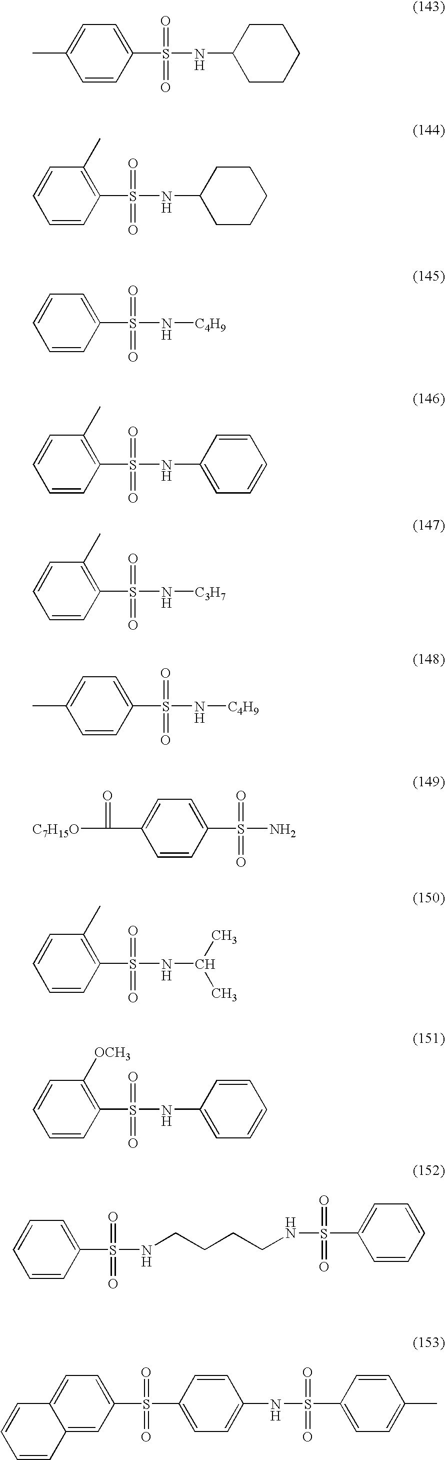

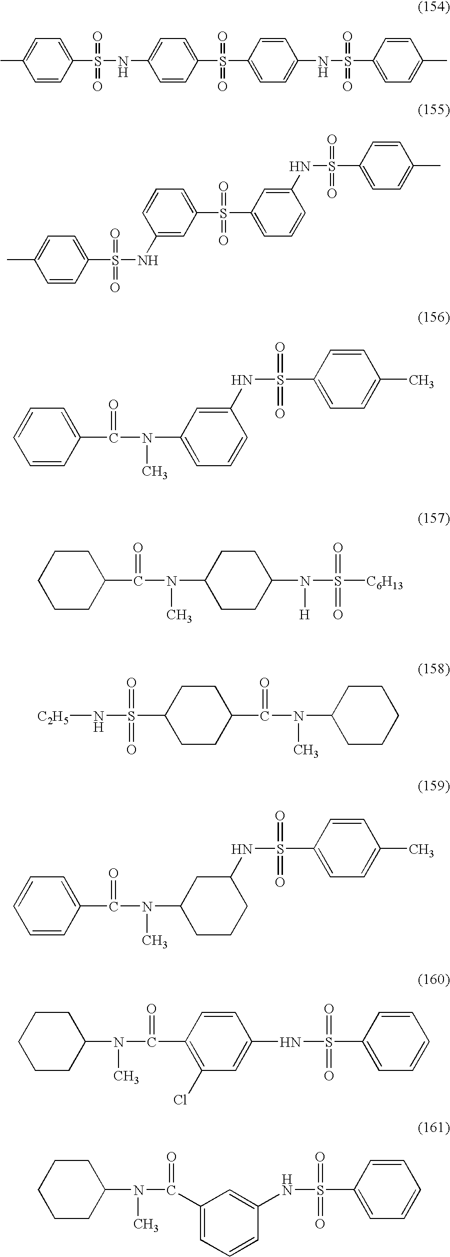

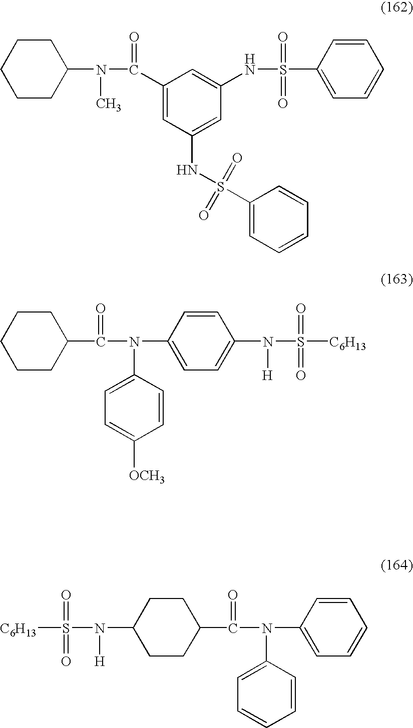

As the Rth decreasing agent, a compound represented by the following formula (2) can be exemplified.

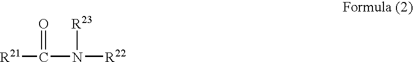

In the above formula (2), R²¹ represents an alkyl group or an aryl group, R²² and R²³ each independently represents a hydrogen atom, an alkyl group, or an aryl group. Here, the alkyl group may be linear, branched, or cyclic and those having 1 to 20 carbon atoms are preferred, those having 1 to 15 carbon atoms are more preferred, and those having 1 to 12 carbon atoms are most preferred. As a cyclic alkyl group, a cyclohexyl group is particularly preferred. As the aryl group, those having 6 to 36 carbon atoms are preferred and those having 6 to 24 carbon atoms are more preferred. Furthermore, sum of the carbon atoms of R²¹ and R²² is preferably 10 or more, and the alkyl group and aryl group may have a substituent.

The above alkyl group and aryl group may have a substituent. As the substituent, halogen atoms (e.g., chlorine, bromine, fluorine, and iodine, etc.), an alkyl group, an aryl group, an alkoxy group, an aryloxy group, an acyl group, an alkoxycarbonyl group, an aryloxycarbonyl group, an acyloxy group, a sulfonylamino group, a hydroxyl group, a cyano group, an amino group, and an acylamino group are preferred, and halogen atoms, an alkyl group, an aryl group, an alkoxy group, an aryloxy group, a sulfonylamino group, and an acylamino group are particularly preferred.

Preferred examples of the compound represented by the formula (2) are shown in the following but the invention is not limited to these specific examples.

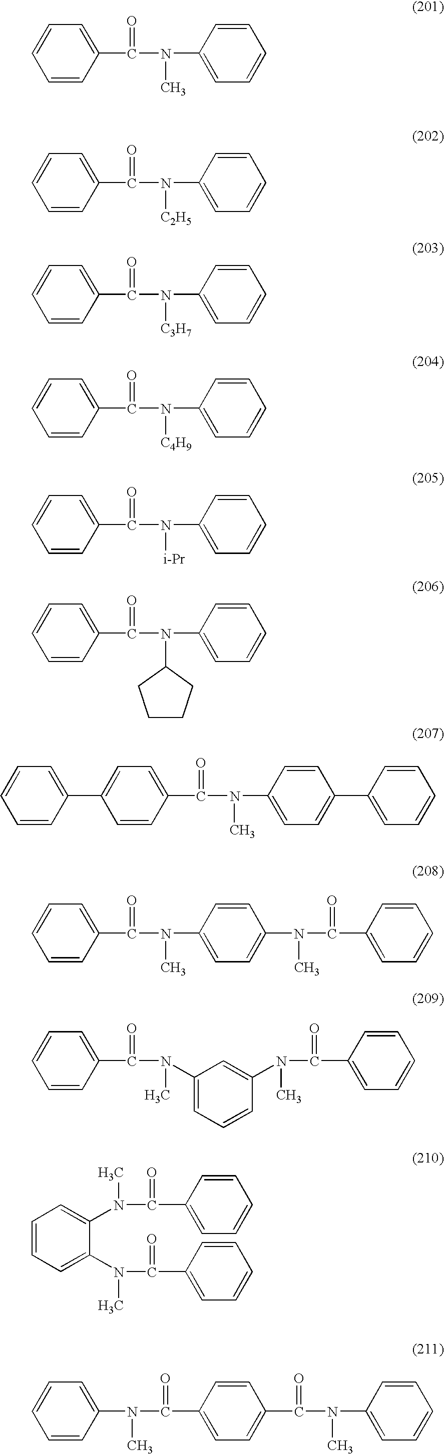

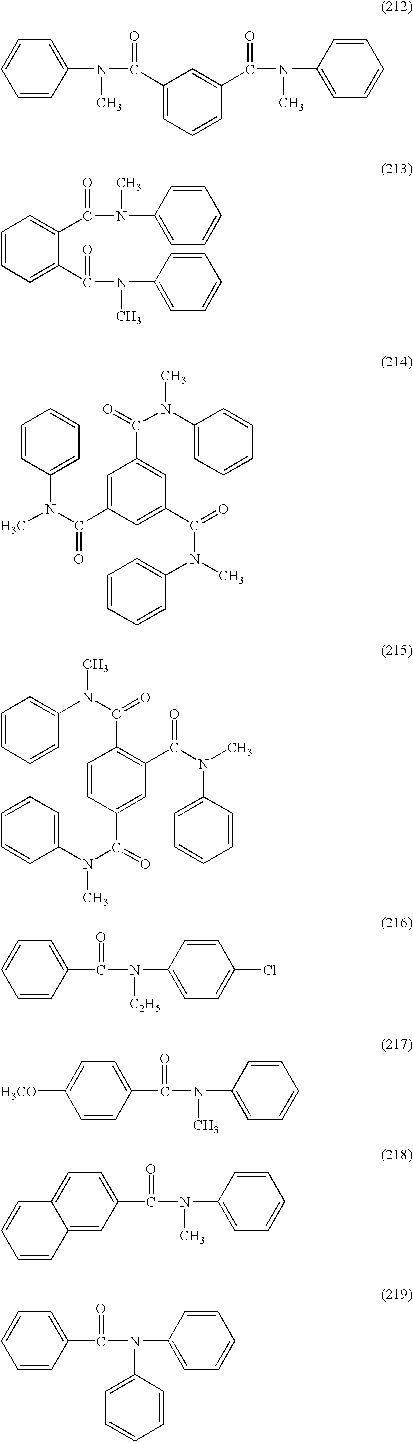

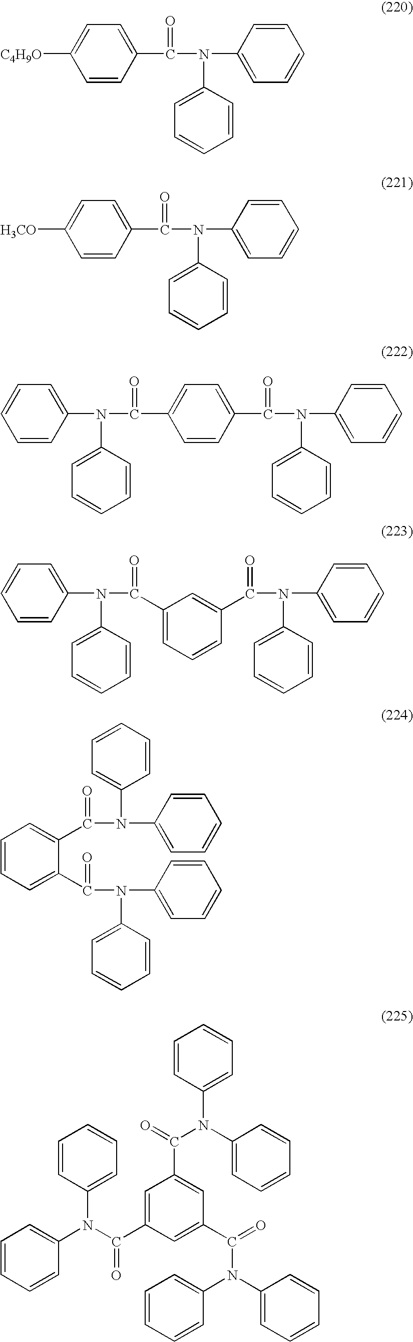

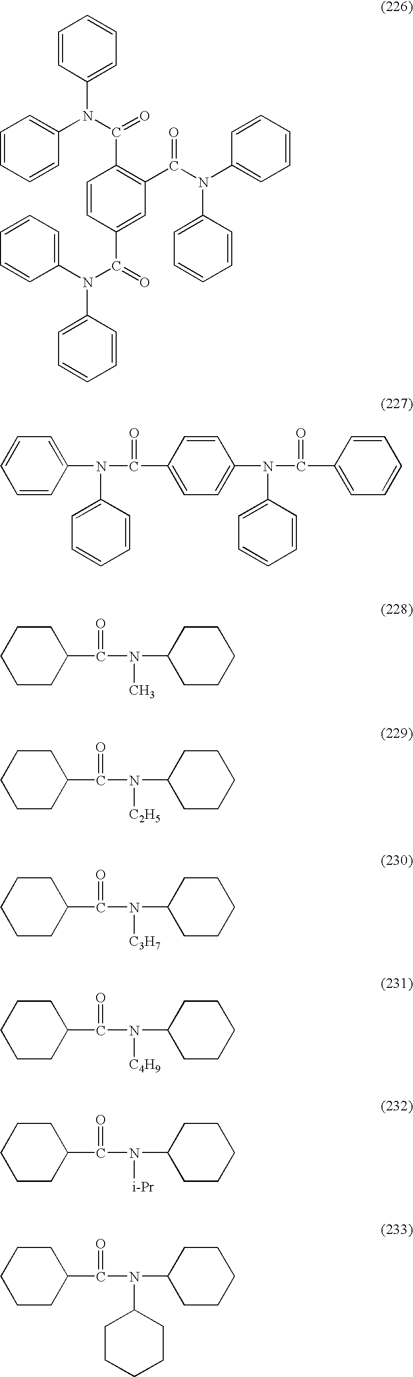

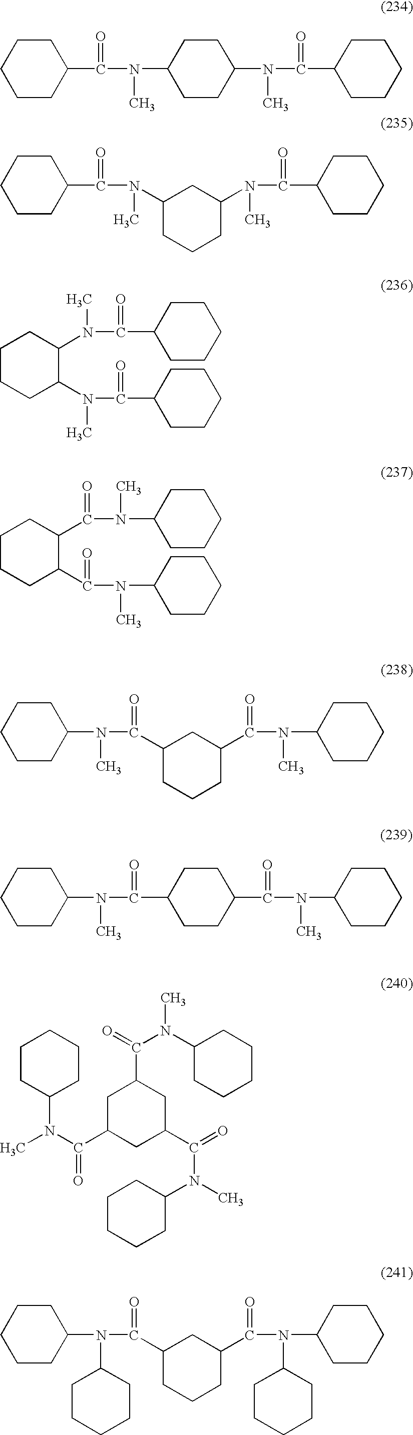

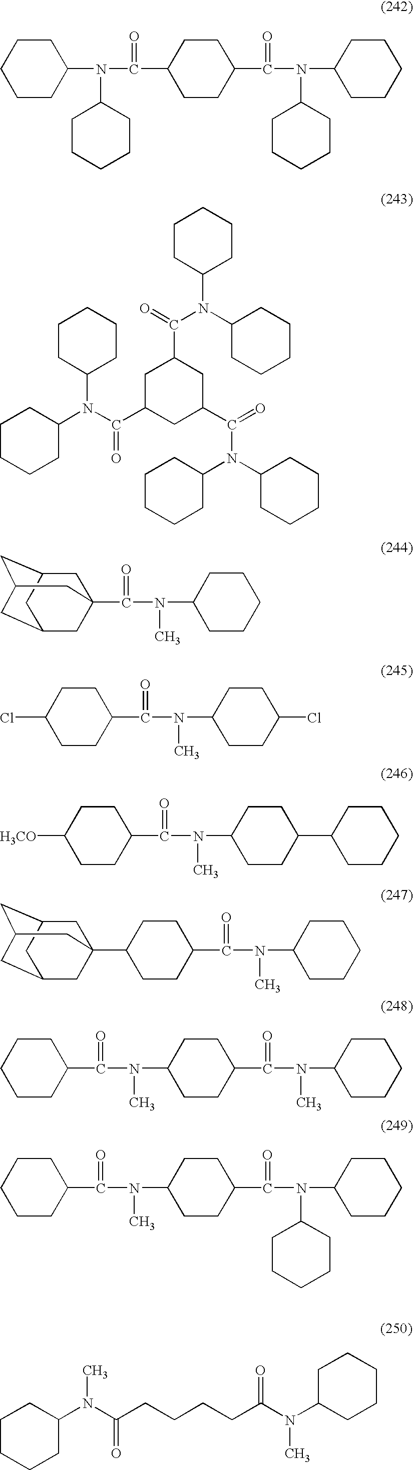

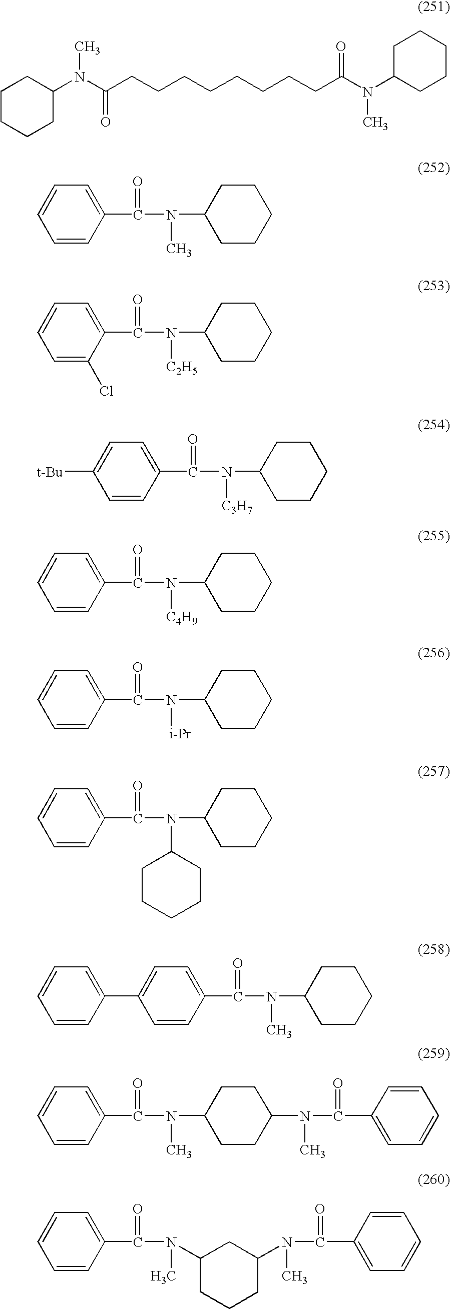

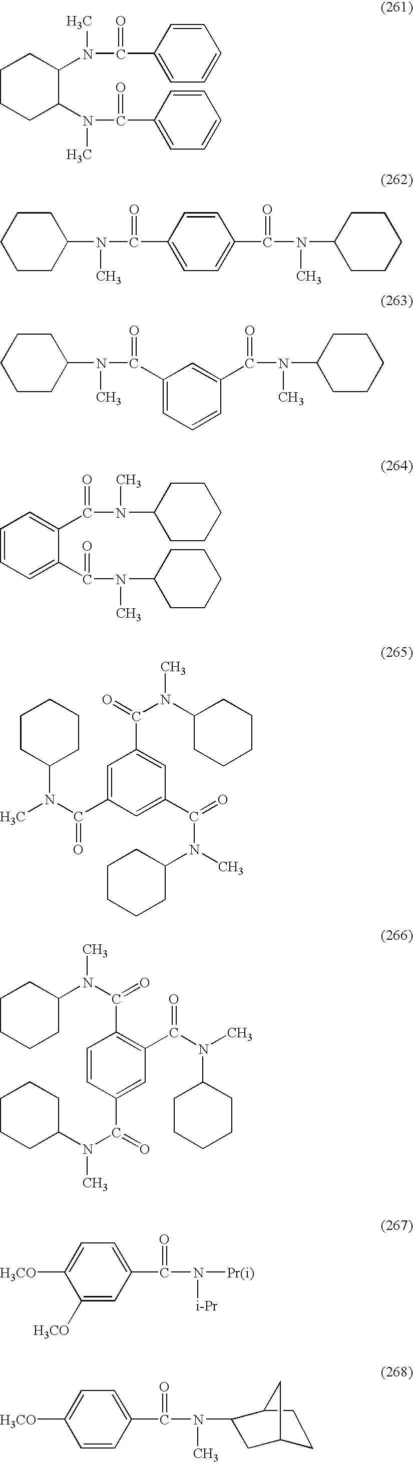

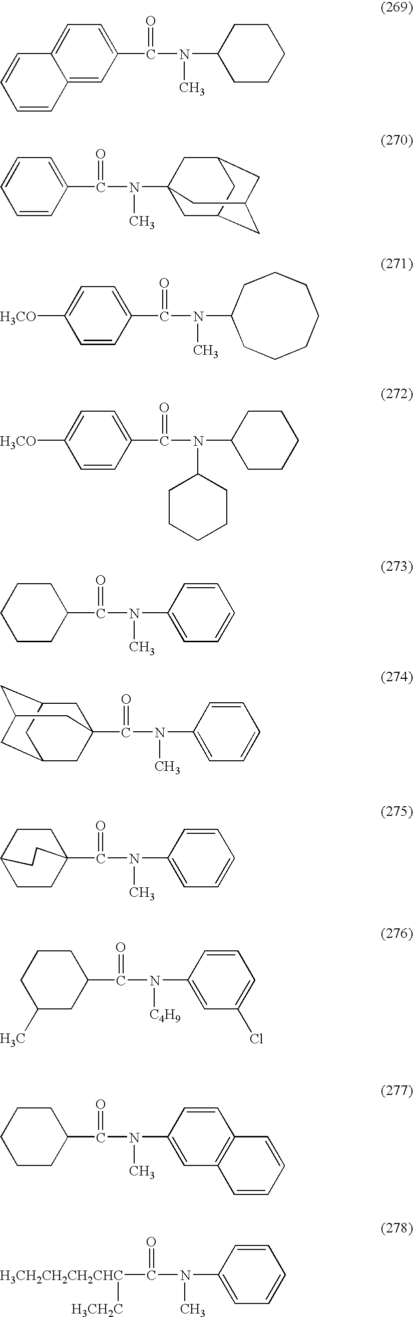

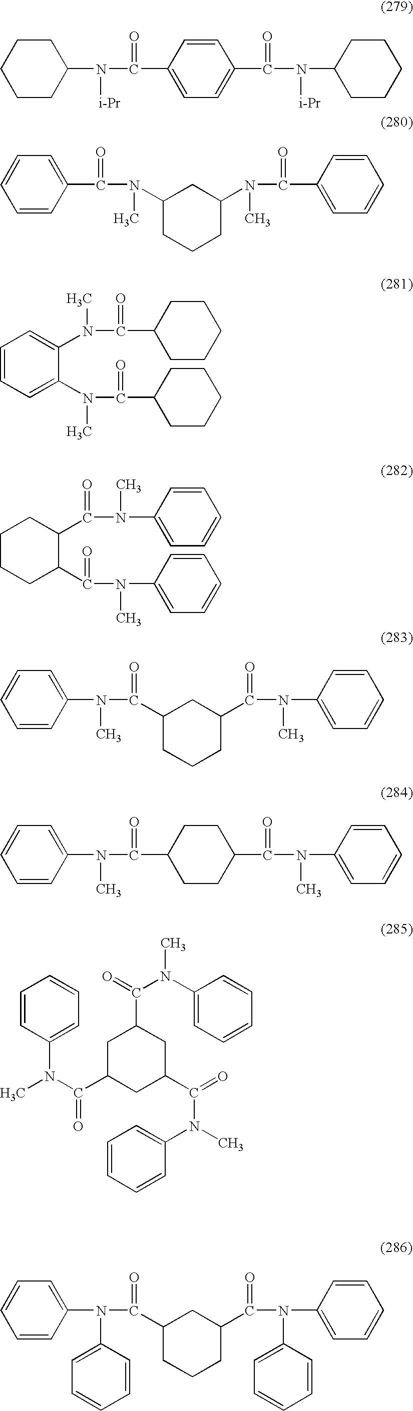

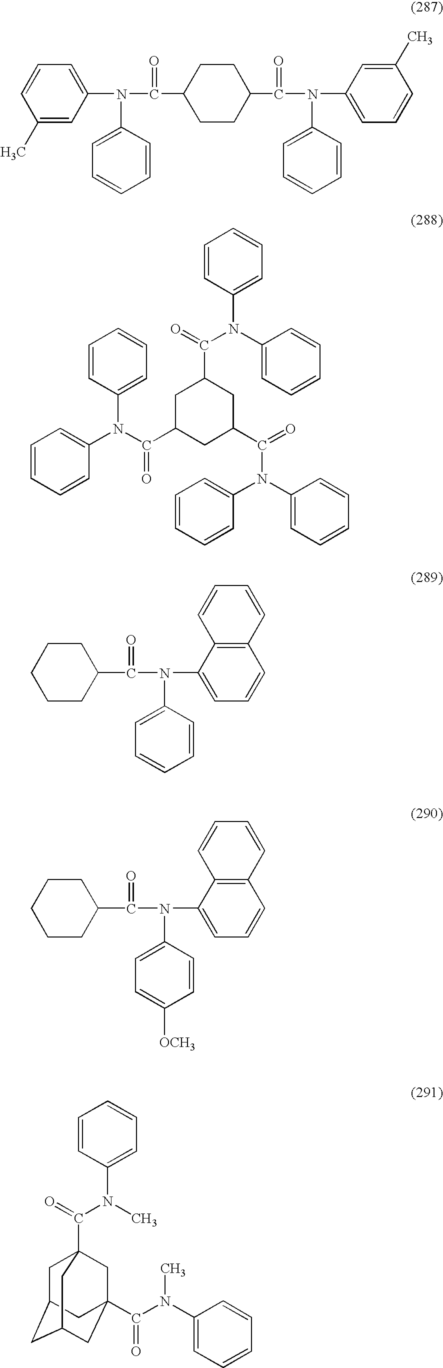

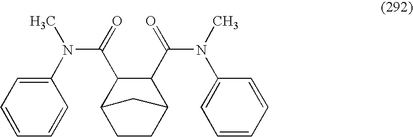

### [Wavelength Dispersion Regulator]

The cellulose acylate film of the invention preferably contains at least one kind of a compound which decreases |Re₄₀₀−Re₇₀₀| and |Rth₄₀₀−Rth₇₀₀|, i.e., a compound which decreases wavelength dispersion of retardation (hereinafter referred to as wavelength dispersion regulator) in an amount of from 0.01 to 30% by mass relative to the solid mass of the raw material polymer of the cellulose acylate film. The following will describe the wavelength dispersion regulator.

In order to improve the wavelength dispersion of Rth of the cellulose acylate film of the invention, it is desirable to incorporate at least one kind of a compound which decreases wavelength dispersion ΔRth represented by the following numerical formula (6) (wavelength dispersion regulator) in the range satisfying the following numerical formulae (7) and (8).

ΔRth=|Rth₄₀₀−Rth₇₀₀| Numerical formula (6)

(ΔRth_{B}−ΔRth₀)/B≦−2.0 Numerical formula (7)

0.01≦B≦30 Numerical formula (8)

In the above numerical formulae (7) and (8), more preferred are as follows:

(ΔRth_{B}−ΔRth₀)/B≦−3.0 Numerical formula (7-2)

0.05≦B≦25, Numerical formula (8-2)

and further preferred are as follows:

(ΔRth_{B}−ΔRth₀)/B≦−4.0 Numerical formula (7-3)

0.1B≦20. Numerical formula (8-3)

Here, ΔRth_{B} is ΔRth (nm) of a film containing B % by mass of the wavelength dispersion regulator and ΔRth₀ is ΔRth (nm) of a film containing no wavelength dispersion regulator, wherein B is a mass (%) of the wavelength dispersion regulator when the mass of the raw material polymer of the film is regarded as 100.

### (Adding Method of Wavelength Dispersion Regulator)

These wavelength dispersion regulators may be used singly or may be used as a mixture of two or more compounds at any ratio. Moreover, the timing of the addition of the wavelength dispersion regulator may be at any time during the dope preparation step and may be at the final stage of the dope preparation step.

Specific examples of the wavelength dispersion regulator to be preferably used in the invention include benzotriazole-based compounds, benzophenone-based compounds, cyano group-containing compounds, oxybenzophenone-based compounds, salicylic ester-based compounds, nickel complex salt-based compounds, and the like but the invention is not limited to these compounds.

As the benzotriazole-based compound, a compound represented by the following formula (3) is preferably used as the wavelength dispersion regulator in the invention.

Q³¹-Q³²-OH Formula (3)

wherein Q³¹ represents a nitrogen-containing aromatic heterocycle and Q³² represents an aromatic ring.

Q³¹ represents a nitrogen-containing aromatic heterocycle and is preferably a 5- to 7-membered nitrogen-containing aromatic heterocycle, more preferably a 5- or 6-membered nitrogen-containing aromatic heterocycle. Examples thereof include imidazole, pyrazole, triazole, tetrazole, thiazole, oxazole, selenazole, benzotriazole, benzothiazole, benzoxazole, benzoselenazole, thiadiazole, oxadiazole, naphthothiazole, naphthoxazole, azabenzimidazole, purine, pyridine, pyrazine, pyrimidine, pyridazine, triazine, triazaindene, tetrazaindene, and the like. More preferably, it is a 5-membered nitrogen-containing aromatic heterocycle and specifically, imidazole, pyrazole, triazole, tetrazole, thiazole, oxazole, benzotriazole, benzothiazole, benzoxazole, thiadiazole, or oxadiazole is preferred. Particularly preferred is benztriazole.

The nitrogen-containing aromatic heterocycle represented by Q³¹ may further have a substituent and the following substituent T can be applied as the substituent. Moreover, when plurality of substituents are present, they may be condensed to form further a ring.

The nitrogen-containing aromatic heterocycle represented by Q³² may be an aromatic hydrocarbon ring or an aromatic heterocycle. Moreover, they may be a single ring or may further form a condensed ring together with another ring.

The aromatic hydrocarbon ring is preferably a monocyclic or bicyclic aromatic hydrocarbon ring (e.g., benzene ring, naphthalene ring, or the like), more preferably an aromatic hydrocarbon ring having 6 to 20 carbon atoms, still more preferably an aromatic hydrocarbon ring having 6 to 12 carbon atoms. The most preferred is a benzene ring.

The aromatic heterocycle is preferably an aromatic heterocycle containing a nitrogen atom or a sulfur atom. Specific examples of the heterocyle include thiophene, imidazole, pyrazole, pyridine, pyrazine, pyridazine, triazole, triazine, indole, indazole, purine, thiazoline, thiazole, thiadiazole, oxazoline, oxazole, oxadiazole, quinoline, isoquinoline, phthalazine, naphthylidine, quinoxaline, quinazoline, cinnoline, pteridine, aquridine, phenanthroline, phenazine, tetrazole, benzimidazole, benzoxazole, benzothiazole, benzotriazole, tetrazaindene, and the like. As the aromatic heterocycle, preferred are pyridine, triazine, and quinoline.

The aromatic ring represented by Q32 is preferably an aromatic hydrocarbon ring, more preferably a naphthalene ring, particularly preferably a benzene ring. Q32 may further have a substituent and the following substituent T is preferred.

Examples of the substituent T include alkyl groups (preferably, 1 to 20 carbon atoms, more preferably 1 to 12 carbon atoms, particularly preferably 1 to 8 carbon atoms, e.g., including methyl, ethyl, i-propyl, t-butyl, n-octyl, n-decyl, n-hexadecyl, cyclopropyl, cyclopentyl, cyclohexyl, and the like), alkenyl groups (preferably, 2 to 20 carbon atoms, more preferably 2 to 12 carbon atoms, particularly preferably 2 to 8 carbon atoms, e.g., including vinyl, allyl, 2-butenyl, 3-pentenyl, and the like), alkynyl groups (preferably, 2 to 20 carbon atoms, more preferably 2 to 12 carbon atoms, particularly preferably 2 to 8 carbon atoms, e.g., including propargyl, 3-pentynyl, and the like), aryl groups (preferably, 6 to 30 carbon atoms, more preferably 6 to 20 carbon atoms, particularly preferably 6 to 12 carbon atoms, e.g., including phenyl, p-methylphenyl, naphthyl, and the like), substituted or unsubstituted amino groups (preferably, 0 to 20 carbon atoms, more preferably 0 to 10 carbon atoms, particularly preferably 0 to 6 carbon atoms, e.g., including amino, methylamino, dimethylamino, diethylamino, dibenzylamino, and the like), alkoxy groups (preferably, 1 to 20 carbon atoms, more preferably 1 to 12 carbon atoms, particularly preferably 1 to 8 carbon atoms, e.g., including methoxy, ethoxy, butoxy, and the like), aryloxy groups (preferably, 6 to 20 carbon atoms, more preferably 6 to 16 carbon atoms, particularly preferably 6 to 12 carbon atoms, e.g., including phenyloxy, 2-naphthyloxy, and the like), acyl groups (preferably, 1 to 20 carbon atoms, more preferably 1 to 16 carbon atoms, particularly preferably 1 to 12 carbon atoms, e.g., including acetyl, benzoyl, formyl, pivaloyl, and the like), alkoxycarbonyl groups (preferably, 2 to 20 carbon atoms, more preferably 2 to 16 carbon atoms, particularly preferably 2 to 12 carbon atoms, e.g., including methoxycarbonyl, ethoxycarbonyl, and the like), aryloxycarbonyl groups (preferably, 7 to 20 carbon atoms, more preferably 7 to 16 carbon atoms, particularly preferably 7 to 10 carbon atoms, e.g., including phenyloxycarbonyl, and the like), acyloxy groups (preferably, 2 to 20 carbon atoms, more preferably 2 to 16 carbon atoms, particularly preferably 2 to 10 carbon atoms, e.g., including acetoxy, benzoyloxy, and the like), acylamino groups (preferably, 2 to 20 carbon atoms, more preferably 2 to 16 carbon atoms, particularly preferably 2 to 10 carbon atoms, e.g., including acetylamino, benzoylamino, and the like), alkoxycarbonylamino groups (preferably, 2 to 20 carbon atoms, more preferably 2 to 16 carbon atoms, particularly preferably 2 to 12 carbon atoms, e.g., including methoxycarbonylamino, and the like), aryloxycarbonylamino groups (preferably, 7 to 20 carbon atoms, more preferably 7 to 16 carbon atoms, particularly preferably 7 to 12 carbon atoms, e.g., including phenyloxycarbonylamino, and the like), sulfonylamino groups (preferably, 1 to 20 carbon atoms, more preferably 1 to 16 carbon atoms, particularly preferably 1 to 12 carbon atoms, e.g., including methanesulfonylamino, benzenesulfonylamino, and the like), sulfamoyl groups (preferably, 0 to 20 carbon atoms, more preferably 0 to 16 carbon atoms, particularly preferably 0 to 12 carbon atoms, e.g., including sulfamoyl, methylsulfamoyl, dimethylsulfamoyl, phenylsulfamoyl, and the like), carbamoyl groups (preferably, 1 to 20 carbon atoms, more preferably 1 to 16 carbon atoms, particularly preferably 1 to 12 carbon atoms, e.g., including carbamoyl, methylcarbamoyl, diethylcarbamoyl, phenylcarbamoyl, and the like), alkylthio groups (preferably, 1 to 20 carbon atoms, more preferably 1 to 16 carbon atoms, particularly preferably 1 to 12 carbon atoms, e.g., including methylthio, ethylthio, and the like), arylthio groups (preferably, 6 to 20 carbon atoms, more preferably 6 to 16 carbon atoms, particularly preferably 6 to 12 carbon atoms, e.g., including phenylthio, and the like), sulfonyl groups (preferably, 1 to 20 carbon atoms, more preferably 1 to 16 carbon atoms, particularly preferably 1 to 12 carbon atoms, e.g., including mesyl, tosyl, and the like), sulfinyl groups (preferably, 1 to 20 carbon atoms, more preferably 1 to 16 carbon atoms, particularly preferably 1 to 12 carbon atoms, e.g., including methanesulfinyl, benzenesulfinyl, and the like), ureido groups (preferably, 1 to 20 carbon atoms, more preferably 1 to 16 carbon atoms, particularly preferably 1 to 12 carbon atoms, e.g., including ureido, methylureido, phenylureido, and the like), phosphoramido groups (preferably, 1 to 20 carbon atoms, more preferably 1 to 16 carbon atoms, particularly preferably 1 to 12 carbon atoms, e.g., including diethyl phosphoramido, phenyl phosphoramido, and the like), a hydroxyl group, a mercapto group, halogen atoms (e.g., fluorine, chlorine, bromine, iodine atoms), a cyano group, a sulfo group, a carboxyl group, a nitro group, a hydroxamic acid group, a sulfino group, a hydrazino group, an imino group, heterocyclic groups (preferably, 1 to 30 carbon atoms, more preferably 1 to 12 carbon atoms, and heteroatoms are, for example, a nitrogen atom, an oxygen atom, and a sulfur atom, specifically, e.g., including imidazolyl, piridyl, quinolyl, furyl, piperidyl, morpholino, benzoxazolyl, benzimidazolyl, benzothiazolyl, and the like), silyl groups (preferably, 3 to 40 carbon atoms, more preferably 3 to 30 carbon atoms, particularly preferably 3 to 24 carbon atoms, e.g., including trimethylsilyl, triphenylsilyl, and the like), and the like. These substituents may be further substituted. Moreover, in the case that two or more substituents are present, they may be the same or different from each other. Furthermore, if possible, they may be combined each other to form a ring.

As the formula (3), preferred is a compound represented by the following formula (3-1).

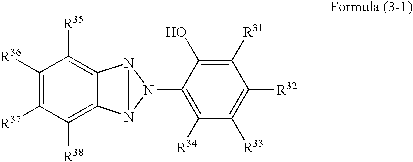

In the above formula (3-1), R³¹, R³², R³³, R³⁴, R³⁵, R³⁶, R³⁷ and R³⁸ each independently represent a hydrogen atom or a substituent and the above substituent T can be applied as a substituent. Moreover, these substituents may be further substituted by another substituent and the substituents may be condensed each other to form a ring structure.

As R³¹ and R³³, preferred is a hydrogen atom, an alkyl group, an alkenyl group, an alkynyl group, an aryl group, a substituted or unsubstituted amino group, an alkoxy group, an aryloxy group, a hydroxyl group, or a halogen atom, more preferred is a hydrogen atom, an alkyl group, an aryl group, an alkyloxy group, an aryloxy group, or a halogen atom, still preferred is a hydrogen atom or an alkyl group having 1 to 12 carbon atoms, and particularly preferred is an alkyl group having 1 to 12 carbon atoms (preferably 4 to 12 carbon atoms).

As R³² and R³⁴, preferred is a hydrogen atom, an alkyl group, an alkenyl group, an alkynyl group, an aryl group, a substituted or unsubstituted amino group, an alkoxy group, an aryloxy group, a hydroxyl group, or a halogen atom, more preferred is a hydrogen atom, an alkyl group, an aryl group, an alkyloxy group, an aryloxy group, or a halogen atom, still preferred is a hydrogen atom or an alkyl group having 1 to 12 carbon atoms, particularly preferred is a hydrogen atom or a methyl group, and the most preferred is a hydrogen atom.

As R³⁵ and R³⁸, preferred is a hydrogen atom, an alkyl group, an alkenyl group, an alkynyl group, an aryl group, a substituted or unsubstituted amino group, an alkoxy group, an aryloxy group, a hydroxyl group, or a halogen atom, more preferred is a hydrogen atom, an alkyl group, an aryl group, an alkyloxy group, an aryloxy group, or a halogen atom, still preferred is a hydrogen atom or an alkyl group having 1 to 12 carbon atoms, particularly preferred is a hydrogen atom or a methyl group, and the most preferred is a hydrogen atom.

As R³⁶ and R³⁷, preferred is a hydrogen atom, an alkyl group, an alkenyl group, an alkynyl group, an aryl group, a substituted or unsubstituted amino group, an alkoxy group, an aryloxy group, a hydroxyl group, or a halogen atom, more preferred is a hydrogen atom, an alkyl group, an aryl group, an alkyloxy group, an aryloxy group, or a halogen atom, still preferred is a hydrogen atom or a halogen atom, and particularly preferred is a hydrogen atom or a chlorine atom.

As the formula (3), more preferred is a compound represented by the following formula (3-2).

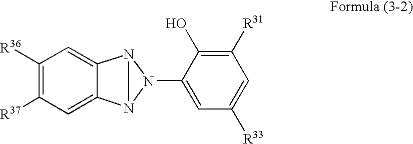

In the formula, R³¹, R³³, R³⁶, and R³⁷ each has the same meaning as in the above formula (3-1) and preferred scope is the same.

The following will show specific examples of the compound represented by the formula (3) but the invention is not limited to the following specific examples.

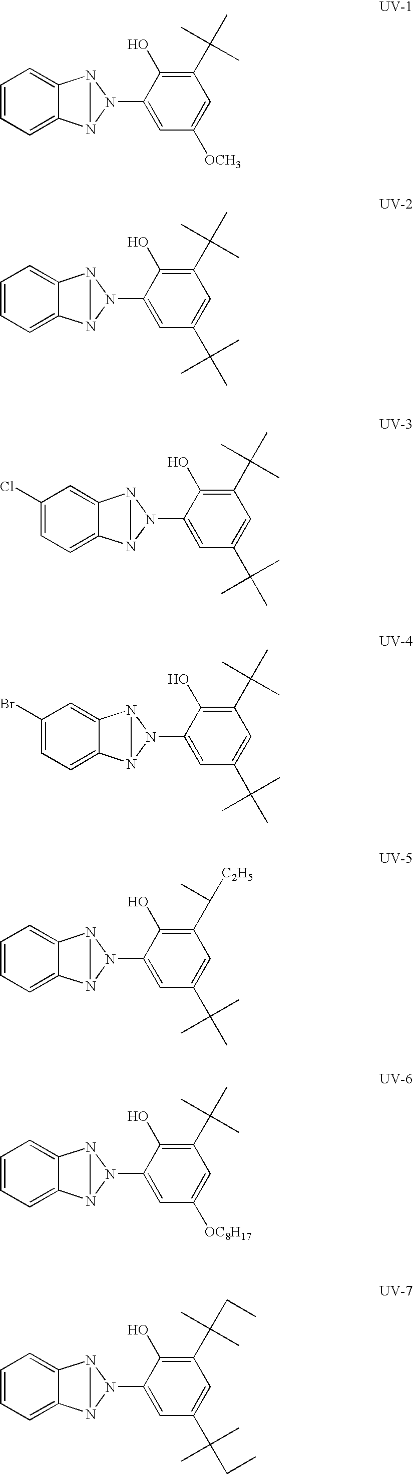

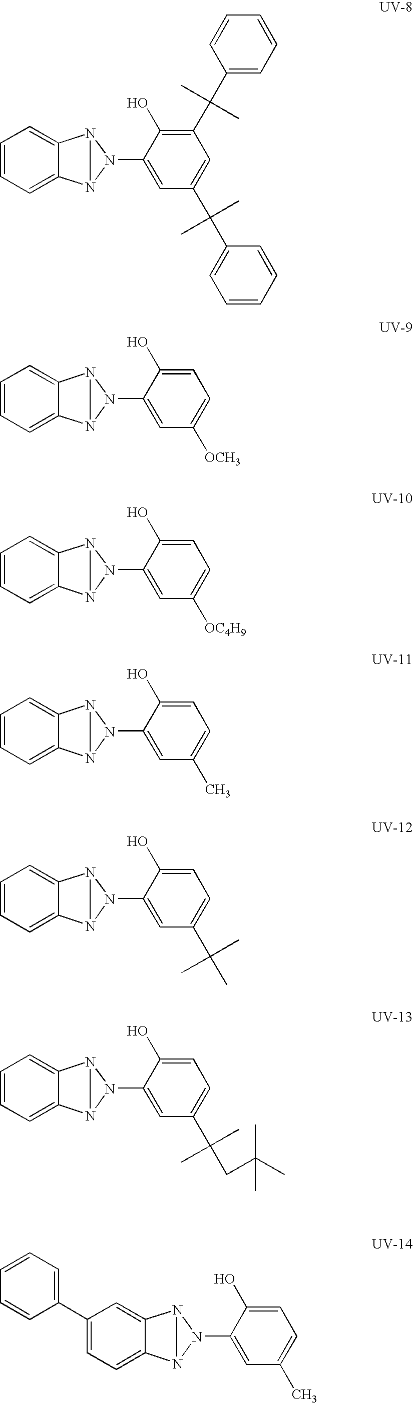

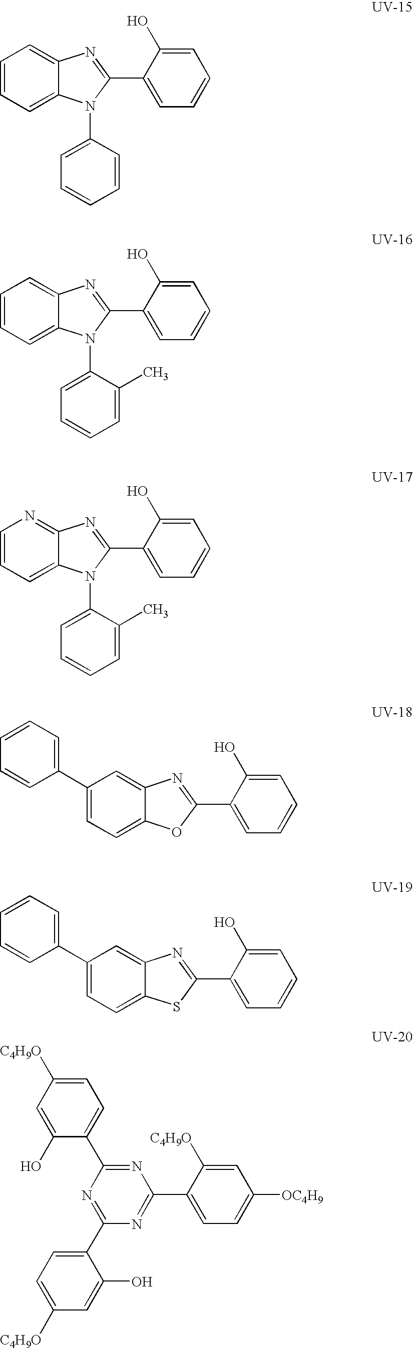

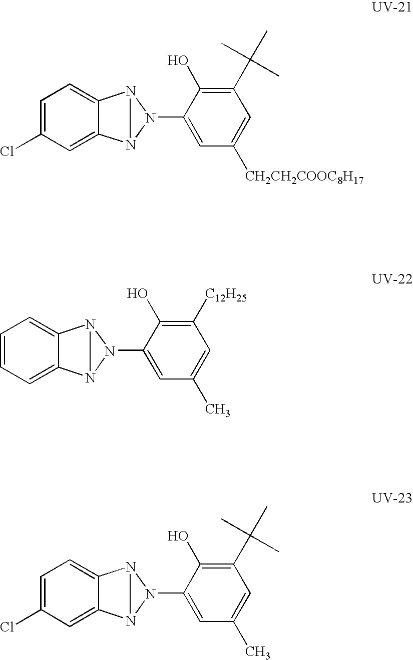

Among the benzotriazole-based compounds exemplified in the above, it has been confirmed that those having a molecular mass of 320 or more are advantageous in view of retaining ability when the cellulose acylate film of the invention is prepared.

Moreover, as the benzophenone-based compound which is one of the wavelength dispersion-regulator to be used in the invention, a compound represented by the formula (4) is preferably used.

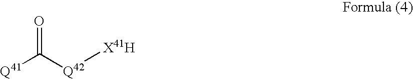

In the formula, Q⁴¹ and Q⁴² each independently represents an aromatic ring. X⁴¹ represents NR⁴¹ (wherein R⁴¹ represents a hydrogen atom or a substituent), an oxygen atom, or a sulfur atom.

The aromatic ring represented by Q⁴¹ and Q⁴² may be an aromatic hydrocarbon ring or an aromatic heterocycle. Moreover, they may be a single ring or may form a condensed ring together with another ring.

The aromatic hydrocarbon ring represented by Q⁴¹ and Q⁴² is preferably a monocyclic or bicyclic aromatic hydrocarbon ring having 6 to 30 carbon atoms (e.g., benzene ring, naphthalene ring), more preferably an aromatic hydrocarbon ring having 6 to 20 carbon atoms, still more preferably an aromatic hydrocarbon ring having 6 to 12 carbon atoms. Still preferred is a benzene ring.

The aromatic heterocyle represented by Q⁴¹ and Q⁴² is preferably an aromatic heterocycle containing at least one of an oxygen atom, a nitrogen atom, and a sulfur atom. Specific examples of the aromatic heterocycle include furan, pyrrole, thiophene, imidazole, pyrazole, pyridine, pyrazine, pyridazine, triazole, triazine, indole, indazole, purine, thiazoline, thiazole, thiadiazole, oxazoline, oxazole, oxadiazole, quinoline, isoquinoline, phtharazine, naphthylidine, quinoxaline, quinazoline, cinnoline, pteridine, acridine, phenanthroline, phenazine, tetrazole, benzimidazole, benzoxazole, benzothiazole, benzotriazole, tetrazaindene. As the aromatic heterocycle, preferred are pyridine, triazine, and quinoline.

The aromatic ring represented by Q⁴¹ and Q⁴² is preferably an aromatic hydrocarbon ring, more preferably an aromatic hydrocarbon ring having 6 to 10 carbon atoms, still more preferably a substituted or unsubstituted benzene ring.

Q⁴¹ and Q⁴² may further have a substituent and the above substituent T is preferred as the substituent but the substituent does not contain a carboxylic acid, sulfonic acid, or quaternary ammonium salt group. Moreover, if possible, the substituents may be combined each other to form a ring structure.

X⁴¹ represents NR⁴² (wherein R⁴² represents a hydrogen atom or a substituent and the above substituent T can be applied as the substituent), an oxygen atom, or a sulfur atom. Preferred as X⁴¹ is NR⁴² (wherein R⁴² is preferably an acyl group or a sulfonyl group and these substituents may be further substituted) or an oxygen atom, and particularly preferred is an oxygen atom.

As the formula (4), preferred is a compound represented by the following formula (4-1).

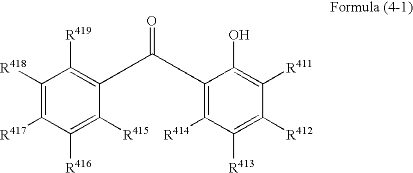

In the formula, R⁴¹¹, R⁴¹², R⁴¹³, R⁴¹⁴, R⁴¹⁵, R⁴¹⁶, R⁴¹⁷, R⁴¹⁸, and R⁴¹⁹ each independently represents a hydrogen atom or a substituent and as the substituent, the above substituent T can be applied. Moreover, these substituents may be further substituted with another substituent and the substituents may be condensed each other to form a ring structure.

R⁴¹¹, R⁴¹³, R⁴¹⁴, R⁴¹⁵, R⁴¹⁶, R⁴¹⁸, and R⁴¹⁹ each is preferably a hydrogen atom, an alkyl group, an alkenyl group, an alkynyl group, an aryl group, a substituted or unsubstituted amino group, an alkoxy group, an aryloxy group, a hydroxyl group, or a halogen atom, more preferably a hydrogen atom, an alkyl group, an aryl group, an alkyloxy group, an aryloxy group, or a halogen atom, still more preferably a hydrogen atom or an alkyl group having 1 to 12 carbon atoms, particularly preferably a hydrogen atom or a methyl group, and most preferably a hydrogen atom.

R¹² is preferably a hydrogen atom, an alkyl group, an alkenyl group, an alkynyl group, an aryl group, a substituted or unsubstituted amino group, an alkoxy group, an aryloxy group, a hydroxyl group, or a halogen atom, more preferably a hydrogen atom, an alkyl group having 1 to 20 carbon atoms, an amino group having 0 to 20 carbon atoms, an alkoxy group having 1 to 12 carbon atoms, an aryloxy group having 6 to 12 carbon atoms, or a hydroxyl group, still more preferably an alkoxy group having 1 to 12 carbon atoms, particularly preferably an alkoxy group having 1 to 12 carbon atoms.

R⁴¹⁷ is preferably a hydrogen atom, an alkyl group, an alkenyl group, an alkynyl group, an aryl group, a substituted or unsubstituted amino group, an alkoxy group, an aryloxy group, a hydroxyl group, or a halogen atom, more preferably a hydrogen atom, an alkyl group having 1 to 20 carbon atoms, an amino group having 0 to 20 carbon atoms, an alkoxy group having 1 to 12 carbon atoms, an aryloxy group having 6 to 12 carbon atoms, or a hydroxyl group, still more preferably a hydrogen atom or an alkyl group having 1 to 12 carbon atoms (preferably one having 1 to 12 carbon atoms, more preferably one having 1 to 8 carbon atoms, still more preferably a methyl group), and particularly preferably a methyl group or a hydrogen atom.

As the formula (4), more preferred is a compound represented by the following formula (4-2).

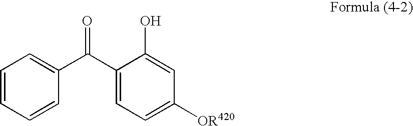

In the formula, R⁴²⁰ represents a hydrogen atom, a substituted or unsubstituted alkyl group, a substituted or unsubstituted alkenyl group, a substituted or unsubstituted alkynyl group, or a substituted or unsubstituted aryl group, and the above substituent T can be applied as the substituent. R⁴²⁰ is preferably a substituted or unsubstituted alkyl group, more preferably a substituted or unsubstituted alkyl group having 5 to 20 carbon atoms, still more preferably a substituted or unsubstituted alkyl group having 5 to 12 carbon atoms (an n-hexyl group, a 2-ethylhexyl group, an n-octyl group, an n-decyl group, an n-dodecyl group, a benzyl group, or the like may be mentioned). Particularly preferred is a substituted or unsubstituted alkyl group having 6 to 12 carbon atoms (a 2-ethylhexyl group, an n-octyl group, an n-decyl group, an n-dodecyl group, or a benzyl group).

The compounds represented by the formulae (4) can be synthesized by the known method described in JP-A-11-12219.

The following will show specific examples of the compound represented by the formula (4) but the invention is not limited to the following specific examples.

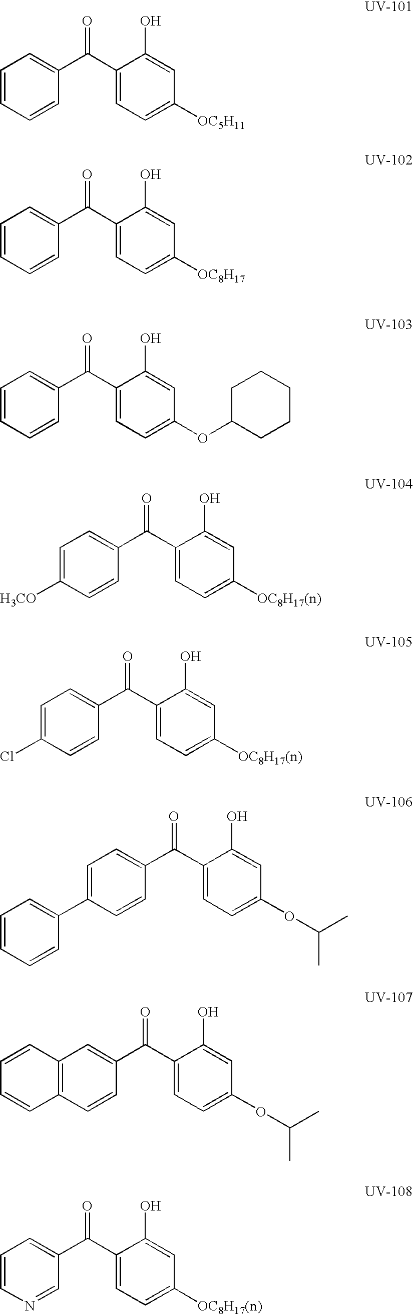

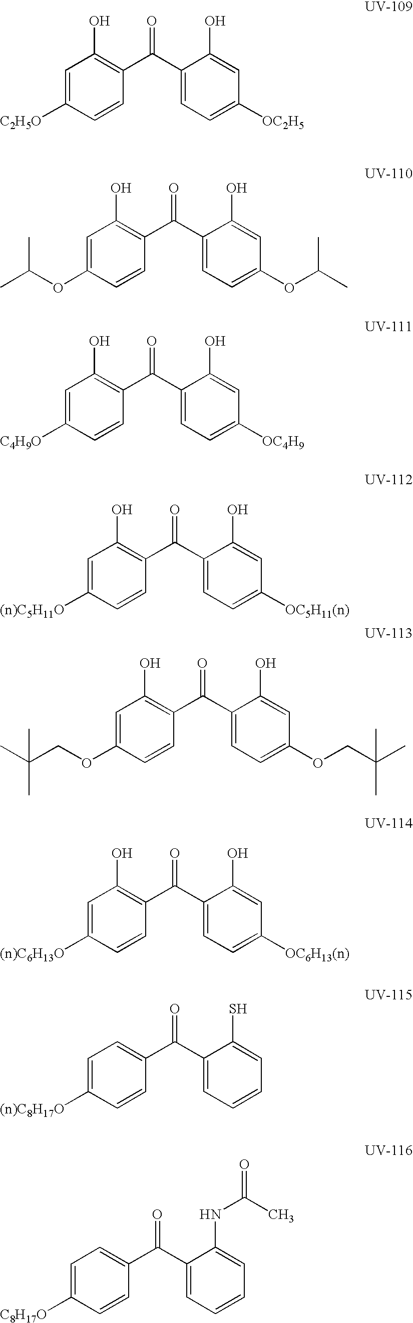

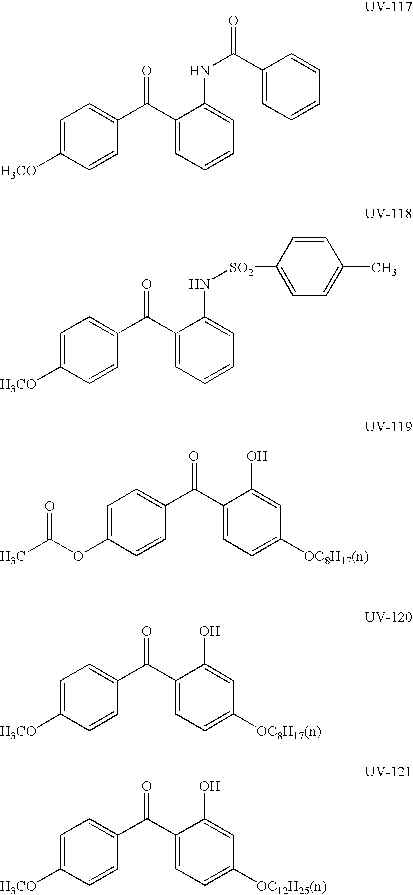

Moreover, as the cyano group-containing compound which is one of the wavelength dispersion-regulator to be used in the invention, a compound represented by the formula (5) is preferably used.

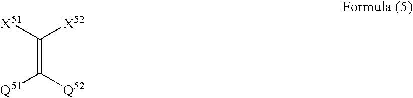

In the formula, Q⁵¹ and Q⁵² each independently represents an aromatic ring. X⁵¹ and X⁵² each represents a hydrogen atom or a substituent and at least one of them represents a cyano group, a carbonyl group, a sulfonyl group, or an aromatic heterocycle. The aromatic ring represented by Q⁵¹ and Q⁵² may be an aromatic hydrocarbon ring or an aromatic heterocycle. Moreover, they may be a single ring or may form a condensed ring together with another ring.

The aromatic hydrocarbon ring is preferably a monocyclic or bicyclic aromatic hydrocarbon ring having 6 to 30 carbon atoms (e.g., benzene ring, naphthalene ring), more preferably an aromatic hydrocarbon ring having 6 to 20 carbon atoms, still more preferably an aromatic hydrocarbon ring having 6 to 12 carbon atoms. Further more preferred is a benzene ring.

The aromatic heterocyle is preferably an aromatic heterocycle containing a nitrogen atom or a sulfur atom. Specific examples of the aromatic heterocycle include thiophene, imidazole, pyrazole, pyridine, pyrazine, pyridazine, triazole, triazine, indole, indazole, purine, thiazoline, thiazole, thiadiazole, oxazoline, oxazole, oxadiazole, quinoline, isoquinoline, phtharazine, naphthylidine, quinoxaline, quinazoline, cinnoline, pteridine, acridine, phenanthroline, phenazine, tetrazole, benzimidazole, benzoxazole, benzothiazole, benzotriazole, tetrazaindene. As the aromatic heterocycle, preferred are pyridine, triazine, and quinoline.

The aromatic ring represented by Q⁵¹ and Q⁵² is preferably an aromatic hydrocarbon ring, more preferably a benzene ring. Q⁵¹ and Q⁵² may further have a substituent and the above substituent T is preferred.

X⁵¹ and X⁵² represents a hydrogen atom or a substituent, at least one of which represents a cyano group, a carbonyl group, a sulfonyl group, or an aromatic heterocycle. As the substituents represented by X⁵¹ and X⁵², the above substituent T can be applied. Moreover, the substituents represented by X⁵¹ and X⁵² may be further substituted with another substituent and X⁵¹ and X⁵² may be condensed each other to form a ring structure.

X⁵¹ and X⁵² is preferably a hydrogen atom, an alkyl group, an aryl group, a cyano group, a nitro group, a carbonyl group, a sulfonyl group, or an aromatic heterocycle, more preferably a cyano group, a carbonyl group, a sulfonyl group, or an aromatic heterocycle, still more preferably a cyano group or a carbonyl group, and particularly preferably a cyano group or an alkoxycarbonyl group {—C(═O)OR⁵¹ (wherein R⁵¹ is an alkyl group having 1 to 20 carbon atoms, an aryl group having 6 to 12 carbon atoms, and a combination thereof)}.

As the formula (5), preferred is a compound represented by the following formula (5-1).

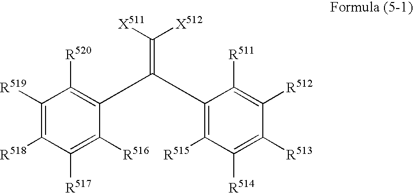

In the formula, R⁵¹¹, R⁵¹², R⁵¹³, R⁵¹⁴, R⁵¹⁵, R⁵¹⁶, R⁵¹⁷, R⁵¹⁸, R⁵¹⁹, and R⁵²⁰ each independently represents a hydrogen atom or a substituent and the above substituent T can be applied as the substituent. Moreover, these substituents may be further substituted with another substituent and the substituents may be condensed each other to form a ring structure. X⁵¹¹ and X⁵¹² have the same meanings as those of X⁵¹ and X⁵² in the above formula (5), respectively.

R⁵¹¹, R⁵¹², R⁵¹⁴, R⁵¹⁵, R⁵¹⁶, R⁵¹⁷, R⁵¹⁹, and R⁵²⁰ each is preferably a hydrogen atom, an alkyl group, an alkenyl group, an alkynyl group, an aryl group, a substituted or unsubstituted amino group, an alkoxy group, an aryloxy group, a hydroxyl group, or a halogen atom, more preferably a hydrogen atom, an alkyl group, an aryl group, an alkyloxy group, an aryloxy group, or a halogen atom, still more preferably a hydrogen atom or an alkyl group having 1 to 12 carbon atoms, particularly preferably a hydrogen atom or a methyl group, and most preferably a hydrogen atom.

R⁵¹³ and R⁵¹⁸ each is preferably a hydrogen atom, an alkyl group, an alkenyl group, an alkynyl group, an aryl group, a substituted or unsubstituted amino group, an alkoxy group, an aryloxy group, a hydroxyl group, or a halogen atom, more preferably a hydrogen atom, an alkyl group having 1 to 20 carbon atoms, an amino group having 0 to 20 carbon atoms, an alkoxy group having 1 to 12 carbon atoms, an aryloxy group having 6 to 12 carbon atoms, or a hydroxyl group, still more preferably a hydrogen atom, an alkyl group having 1 to 12 carbon atoms, an alkoxy group having 1 to 12 carbon atoms, particularly preferably a hydrogen atom.

As the formula (5), more preferred is a compound represented by the following formula (5-2).

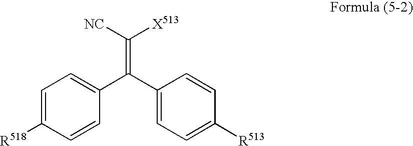

In the formula, R⁵¹³ and R⁵¹⁸ each has the same meaning as in the above formula (5-1) and preferred scope is also the same. X⁵¹³ represents a hydrogen atom or a substituent and the above substituent T can be applied as the substituent. Moreover, if possible, the substituents may be combined each other to form a ring structure.

X⁵¹³ is preferably a hydrogen atom, an alkyl group, an aryl group, a cyano group, a nitro group, a carbonyl group, a sulfonyl group, or an aromatic heterocycle, more preferably a cyano group, a carbonyl group, a sulfonyl group, or an aromatic heterocycle, still more preferably a cyano group or a carbonyl group, and particularly preferably a cyano group or an alkoxycarbonyl group {—C(═O)OR⁵² (wherein R⁵² is an alkyl group having 1 to 20 carbon atoms, an aryl group having 6 to 12 carbon atoms, and a combination thereof)}.

As the formula (5), even more preferred is a compound represented by the following formula (5-3).

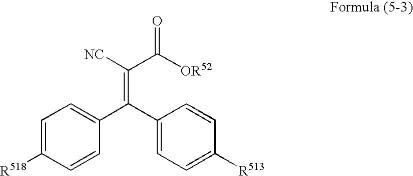

In the formula, R⁵¹³ and R⁵¹⁸ each has the same meaning as in the above formula (5-1) and preferred scope is also the same. R⁵² represents an alkyl group having 1 to 20 carbon atoms. When both of R⁵¹³ and R⁵¹⁸ are hydrogen atoms, R⁵² represents preferably an alkyl group having 2 to 12 carbon atoms, more preferably an alkyl group having 4 to 12 carbon atoms, still more preferably an alkyl group having 6 to 12 carbon atoms, particularly preferably an n-octyl group, a t-octyl group, a 2-ethylhexyl group, an n-decyl group, an n-dodecyl group, and most preferably a 2-ethylhexyl group.

When R⁵¹³ and R⁵¹⁸ are other than a hydrogen atom, it is preferred that R⁵² is a group so that the molecular mass of the compound represented by the formula (5-3) is 300 or more and is an alkyl group having 20 carbon atoms or less.

In the invention, the compounds represented by the formula (5) can be synthesized by the known method described in “J. Am. Chem. Soc.”, Vol. 63, p. 3452 (1941).

The following will show specific examples of the compound represented by the formula (5) but the invention is not limited to the following specific examples.

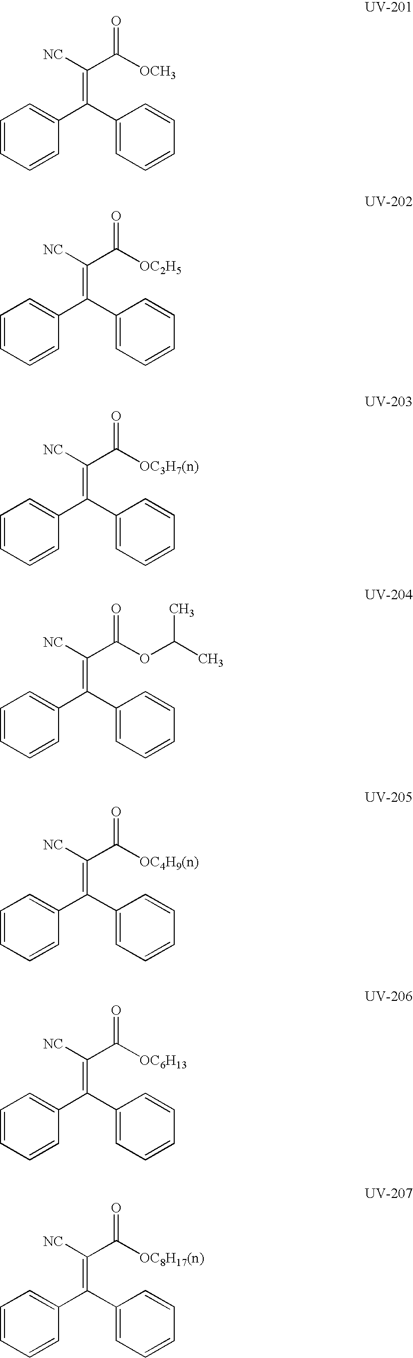

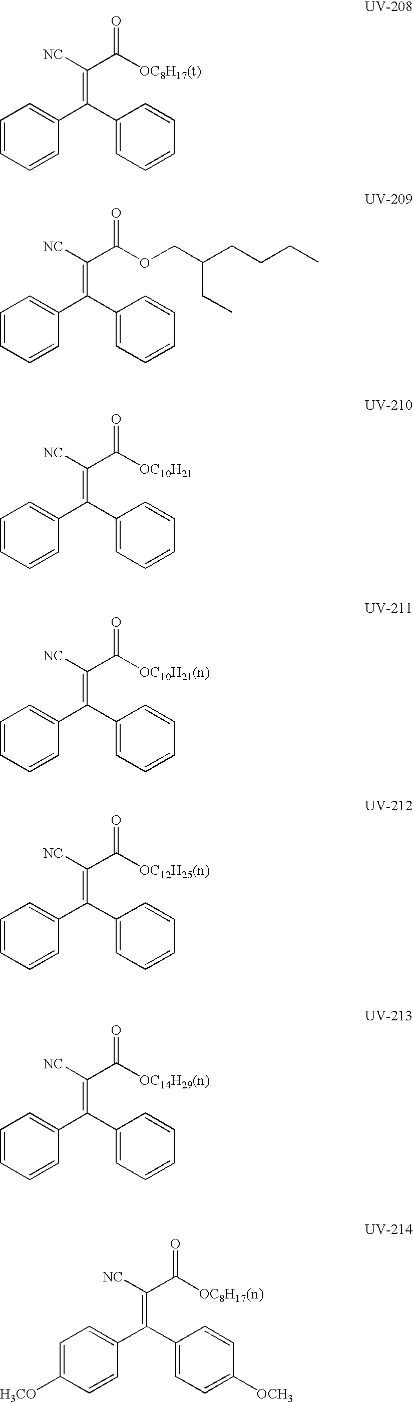

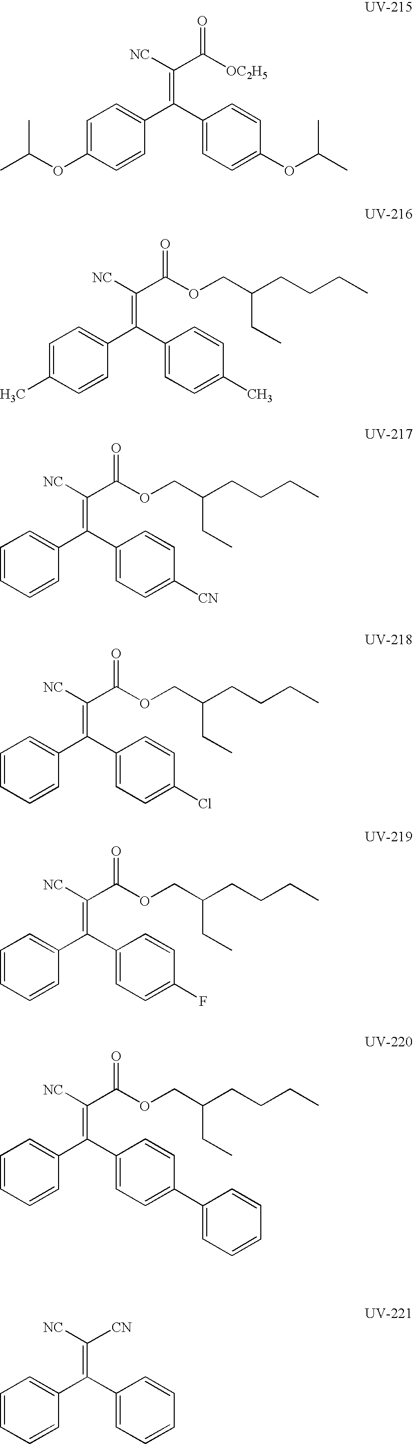

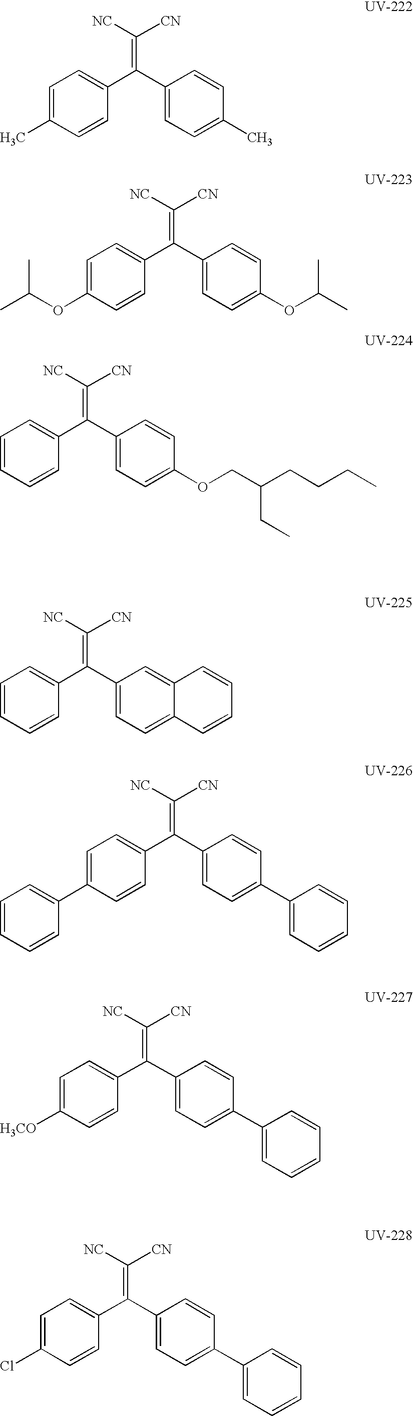

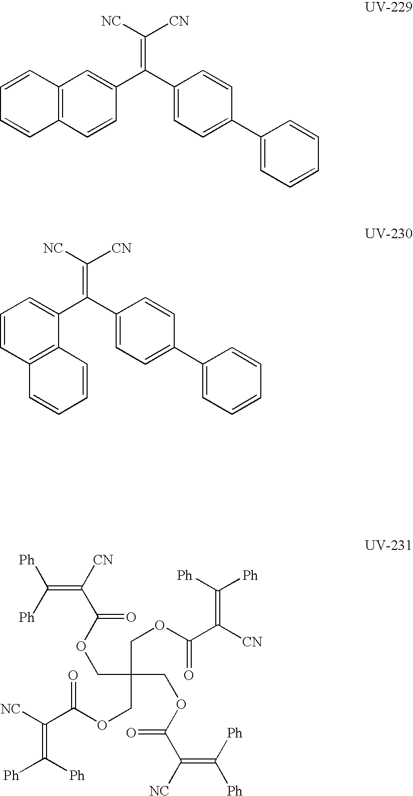

### [Mat Agent Fine Particles]

It is preferred to add fine particles as a mat agent to the cellulose acylate film of the invention. The fine particles to be used in the invention may include silicon dioxide, titanium dioxide, aluminum oxide, zirconium oxide, calcium carbonate, talc, clay, calcined kaolin, calcined calcium silicate, calcium silicate hydrate, aluminum silicate, magnesium silicate, and calcium phosphate. The fine particles containing silicon are preferred in view of low turbidity, and particularly, silicon dioxide is preferred. The fine particles of silicon dioxide preferably have a primary mean particle size of 20 nm or less and an apparent specific gravity of 70 g/l or more. Those having a primary mean particle size of as small as with a solvent is preferably from 5 to 30% by mass, more preferably from 10 to 25% by mass, most preferably from 15 to 20% by mass. A higher dispersion concentration is preferred since liquid turbidity relative to the amount of the particles added decreases and haze and aggregates are improved. The amount of the mat agent added in the final dope solution of the cellulose acylate is preferably from 0.01 to 1.0 g, more preferably from 0.03 to 0.3 g, most preferably from 0.08 to 0.16 g per 1 m².

The solvent to be used may be a lower alcohol, which preferably includes methyl alcohol, ethyl alcohol, propyl alcohol, isopropyl alcohol, butyl alcohol, and the like. The solvent other than the lower alcohols is not particularly limited but it is preferred to use the solvent to be used at the preparation of the cellulose acylate film.

### [Plasticizer, Deterioration Inhibitor, Releasing Agent]

In addition to the above compound which decreases optical anisotropy and wavelength dispersion regulator, various additives (e.g., plasticizer, a UV inhibitor, a deterioration inhibitor, a releasing agent, an IR absorbent, and the like) can be added to the cellulose acylate film of the invention in each preparation step in accordance with the use of the film, and they may be a solid or an oily substance. Namely, they are not particularly specified in melting point and boiling point. Examples thereof include mixing with UV absorbing materials of 20° C. or lower and of 20° C. or higher and also mixing with a plasticizer, which are described in, for example, JP-A-2001-151901 and the like. Furthermore, UV absorbing dyes are described in, for example, JP-A-2001-194522. Moreover, the timing of the addition thereof may be at any time during the dope preparation step and the addition may be carried out with incorporating a step of adding additive(s) and preparing a dope at the final stage of the dope preparation step. Furthermore, the amount of each material to be added is not particularly limited as far as the function is exhibited. In addition, in the case that the cellulose acylate film is formed of multi layers, the kinds and amounts of the additives in each layer may be different from each other. For example, it is described in JP-A-2001-151902 and the like but is a technology hitherto known. Detail thereof are described in detail in Hatsumei Kyokai's Kokai Giho (Kogi No. 2001-1745 issued Mar. 15, 2001, by Hatsumei Kyokai), pp. 16-22 and materials described therein in detail can be preferably employed.

### (Ratio of Compound to be Added)

In the cellulose acylate film of the invention, total amount of the compounds having a molecular mass of 3,000 or less is desirably from 5 to 45% by mass relative to the mass of the cellulose acylate. More desired is from 10 to 40% by mass and even more desired is from 15 to 30% by mass. As mentioned above, the compounds are a compound which decreases optical anisotropy, a wavelength dispersion regulator, a UV inhibitor, a plasticizer, a deterioration inhibitor, fine particles, a releasing agent, an IR absorbent, and the like and the molecular mass thereof is desirably 3,000 or less, more desirably 2,000 or less, even more desirably 1,000 or less. When the total amount of these compounds is at least the lower limit, there arise no such problems that optical performance and physical properties are apt to change with the change of temperature and humidity, for example. Moreover, when the total amount of these compounds does not exceed 45%, there arise no such problems that the compounds may precipitate on the surface of the film to make the film turbid (weeping from the film) as a result of exceeding a compatible limit of the compounds in the film.

### [Organic Solvent for Cellulose Acylate Solution]

In the invention, it is preferred to produce a cellulose acylate film by a solvent casting process, where the film is produced using a solution (dope) wherein a cellulose acylate is dissolved in an organic solvent. As the organic solvent to be preferably used as the main solvent of the invention, a solvent selected from an ester, ketone, or ether having 3 to 12 carbon atoms or a halogenated hydrocarbon having 1 to 7 carbon atoms is preferred. The ester, ketone, and ether may have a cyclic structure. A compound having two or more of any of ester, ketone, and ether functional groups (i.e., —O—, —CO— and —COO—) can be also used as the main solvent and, for example, it may have another functional group such as an alcoholic hydroxyl group. In the case of the main solvent having two or more functional groups, it is sufficient that the number of the carbon atoms falls within the defined range for the compound having any of those functional group.

For the cellulose acylate film of the invention, a chlorine-based halogenated hydrocarbon may be used as the main solvent or a non-chlorine-based solvent may be used as the main solvent as described in Hatsumei Kyokai's Kokai Giho 2001-1745 (pp. 12 to 16). With regard to the cellulose acylate film of the invention, the solvent is not particularly limited.

In addition, the solvents for the cellulose acylate solution and film of the invention are disclosed in the following patents including dissolution methods thereof, and these are preferred embodiments. For example, they are described in JP-A-2000-95876, JP-12-95877, JP-A-10-324774, JP-A-8-152514, JP-A-10-330538, JP-A-9-95538, JP-A-9-95557, JP-A-10-235664, JP-A-12-63534, JP-A-11-21379, JP-A-10-182853, JP-A-10-278056, JP-A-10-279702, JP-A-10-323853, JP-A-10-237186, JP-A-11-60807, JP-A-11-152342, JP-A-11-292988, JP-A-11-60752, JP-A-11-60752, and the like. According to these patents, there are described not only preferred solvents for cellulose acylate of the invention but also the physical properties of their solutions and the substances that may coexist along with them, which are also applicable in the invention.

In order to effectively perform cooling gelation in the film preparation process of the invention, selection of a solvent composition is important. In the selection of the solvent, it is important to select an auxiliary solvent, so-called non-solvent or poor solvent, which is used in addition to the main solvent and does not dissolve cellulose acylate singly. An auxiliary solvent having a high effect on cooling gelation casting is an alcohol. Especially, an alcohol having 1 to 5 carbon atoms is preferred. The ration of the auxiliary solvent in the whole solvent is preferably from 12 to 25% by mass, more preferably from 15 to 20% by mass. It is further preferred to use an auxiliary solvent wherein two or more alcohols are mixed in a ratio of 3 to 30 parts by mass of an alcohol having 3 to 5 carbon atoms relative to 100 parts by mass of an alcohol having 1 to 2 carbon atoms. Among the alcohol having 3 to 5 carbon atoms, butanol is preferred and 1-butanol is particularly preferred.

### [Production Step of Cellulose Acylate Film]

### [Heating and Dissolution Step]

In the invention, the cellulose acylate was brought into contact with a solvent to effect dispersion or dissolution and then the whole is treated at a temperature of 70° C. or higher. The dissolution temperature is preferably from 130 to 250° C., more preferably from 160 to 220° C. When it exceeds 250° C., decomposition of the cellulose acylate occurs and quality of the resulting film is deteriorated.

The solution can be heated using an autoclave method, a multi-tube heat exchanger, a screw extruder, a static mixer with jacket, or the like method. At the heating of the solution, in order to enhance heat-transfer efficiency and maintain the quality of the film, it is preferred to prevent foam generation owing to vapor pressure during heating. Usually, the foam generation can be suppressed by maintaining pressure higher than saturated vapor pressure at a maximum temperature in the solution.

Moreover, the time of maintaining the above cellulose acylate dispersion or its solution at 70° C. or higher is preferably from 20 seconds to 4 hour, more preferably from 2 minutes to 60 minutes. It is also preferred to subject it to cooling treatment at the temperature range of from −100° C. to −10° C. before or after the above heating treatment. In this case, solubility thereof can be enhanced.

In the solution film-preparation process wherein a film is prepared from solution using the dispersion or solution of the cellulose acylate of the invention, it is preferred to make heat-transfer distance of the above dispersion or solution of the cellulose acylate 8 mm or less at the cooling of the above dispersion or solution of the cellulose acylate. In this case, it is also preferred to use a method of cooling by means of a heat exchanging machine equipped with a mechanism of scraping out the above dispersion or solution of the 5 to 16 nm are more preferred since they can lower haze of the film. The apparent specific gravity is preferably from 90 to 200 g/l, more preferably from 100 to 200 g/l. A larger apparent specific gravity is preferred since preparation of a dispersion having a high concentration is possible and haze and aggregates are improved.

These fine particles usually form secondary particles having a mean particle size of from 0.1 to 3.0 μm and these fine particles are present as an aggregate of the primary particles in the film to form unevenness of from 0.1 to 3.0 μm on the film surface. The mean particle size of the secondary particles is preferably from 0.2 μm to 1.5 μm, more preferably from 0.4 μm to 1.2 μm, most preferably from 0.6 μm to 1.1 μm. The sizes of the primary and secondary particles are determined by observing the particles in the film on a scanning electron microscope to measure diameters of circles circumscribing the particles. Moreover, 200 particles are observed with changing the position and an average value thereof is regarded as the mean particle size.

As the fine particles of silicon dioxide, commercially available products such as Aerosil R972, R972V, R974, R812, 200, 200V, 300, R202, OX50, TT600 (all manufactured by Nippon Aerosil Co., Ltd.) can be used. The fine particles of zirconium oxide are commercially available as trade names of Aerosil R976 and R811 (both manufactured by Nippon Aerosil Co., Ltd.) and they can be used.

Among them, Aerosil 200V and Aerosil R972V are fine particles of silicon dioxide having a primary mean particle size of 20 nm or less and an apparent specific gravity of 70 g/l or more and have a large effect of lowering friction coefficient with maintaining turbidity of an optical film at a low level, so that they are particularly preferred.

In the invention, in order to obtain a cellulose acylate film having particles wherein the size of secondary particles is small, several methods are considered at the preparation of a dispersion of fine particles. For example, there is a method of preparing a dispersion of fine particles wherein a solvent and the fine particles are mixed under stirring beforehand, adding the dispersion of the fine particles to a small amount of a separately prepared cellulose acylate solution under stirring to effect dissolution, and further mixing it with a main cellulose acylate dope solution. This method is a preferred preparation method in view of good dispersibility of fine particles of silicon dioxide and little re-aggregation of the fine particles. In addition, there is also a method of adding a small amount of a cellulose ester to a solvent, stirring the mixture to effect dissolution, adding fine particles thereto, dispersing them in a dispersing machine to form a fine particle-added solution, and sufficiently mixing the fine particle-added solution with a dope solution in an in-line mixer. The invention is not limited to these methods but the concentration of silicon dioxide at the time when the fine particles of silicon dioxide were mixed and dispersed cellulose acylate from the wall surface. Furthermore, it is also preferred that the temperature difference between the above dispersion or solution of the cellulose acylate and a coolant present at another side of the wall surface is 100° C. or higher. In addition, it is also preferred to use a method of cooling the above dispersion or solution of the cellulose acylate by flushing it. These cooling methods may be used singly or in combination and further, in the heating treatment during the solution film-preparation mentioned above, the above cooling method may be applied before or after the treatment.

### [Swelling Step]

First, a swelling step is carried out, wherein the above cellulose acylate particles are mixed with a solvent to swell the cellulose acylate particles with the solvent. The temperature at the swelling step is preferably in the range of from −10 to +55° C. Usually, the step is carried out at room temperature. The ratio of the cellulose acylate to the solvent is determined depending on the concentration of the solution finally obtained. In general, the amount of the cellulose acylate in the mixture is preferably from 5 to 30% by mass, more preferably from 8 to 20% by mass, most preferably from 10 to 15% by mass. The mixture of the solvent and the cellulose acylate is preferably stirred until the cellulose acylate is sufficiently swelled. In order to form no ball-like aggregate, it is effective to impart ultrasonic vibration during the swelling step. Detailed use of the ultrasonic vibration is described in JP-A-11-71463. Moreover, in the swelling step, components other than the solvent and the cellulose acylate, e.g., a plasticizer, a retardation decreasing agent, a wavelength dispersion regulator, a deterioration inhibitor, a dye, and a UV absorbent may be added.

### [Heating Step]

Next, a heating step is carried out, where the above dope is heated at 70° C. or higher.

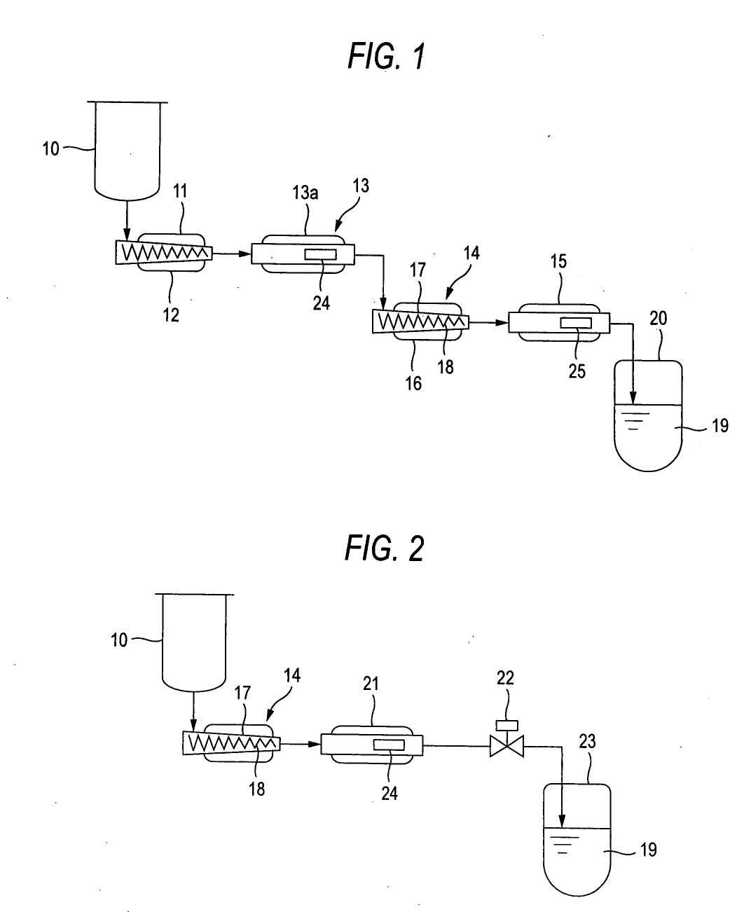

The heating is carried out by means of a dope-preparation line shown in FIG. 1. Into a tank 10 is poured a dope wherein the cellulose acylate is swelled in the solvent. The dope is delivered into a heat exchanger for heating 13 by means of a screw extruder 12. On the screw extruder 12, a jacket 11 is provided and a coolant is fed into the jacket 11 to cool the dope. Then, the dope is delivered into the heat exchanger for heating 13 having a static mixer 24. The heat exchanger for heating 13 possesses a jacket 13a and a heat medium is circulated in the jacket 13a to make the dope a high-temperature and high-pressure state. The heating temperature at the heat exchanger 13 is 70° C. or higher, desirably 130° C. or higher, most desirably 160° C. or higher. However, when the temperature exceeds 250° C., quality of the film is deteriorated owing to decomposition of the cellulose acylate in the dope, so that the case is not preferred. In this case, the heating rate is preferably 1° C./minute or more, more preferably 2° C./minute or more, still more preferably 4° C./minute or more, most preferably 8° C./minute or more. A faster heating rate is preferred but 10,000° C./second is a theoretical upper limit, 1,000° C./second is a technical upper limit, and 100° C./second is a practical upper limit. In this regard, the heating rate is a value obtained by dividing a difference between temperature at the time when heating is started and final heating temperature by the time required from the start of heating until the temperature reaches the final heating temperature. The heating may be carried out by any of an autoclave method and a method using a multi-pipe heat exchanger other than the heat exchanger 13 shown in the figure. It is also preferred to use a heating method wherein a screw extruder and a static mixer are combined, as described in JP-A-2003-181253.

Moreover, the heating time is preferably from 20 seconds to 4 hours. When the heating time is not more than 20 seconds, undissolved substances remain in the dope subjected to dissolution under heating and thus a high-quality film cannot be prepared. Moreover, when the undissolved substances are removed by filtration, the case is disadvantageous owing to extremely short filtration life. The beginning of the heating time is measured from the time when the temperature reaches aimed temperature and the end is regarded at the time when cooling is started from the aimed temperature. In this regard, the cooling of the apparatus may be natural cooling or forced cooling.

As a dope-heating means, it is preferred to use a method of irradiation with a microwave whose frequency is in the range of from 900 to 3,000 MHz. Furthermore, it is also preferred to irradiate the dope with a microwave for a time of from 20 seconds to 4 hours directly or through a wave-guide.

### [Pressurization Step]

In the above heating step, it is preferred to heat the dope at a temperature higher than the boiling point of the solvent under atmospheric pressure under a pressure regulated so that the solution is not boiled. For example, the dope is made a high-temperature and high-pressure state by a static mixer (not shown in the figure) provided on the heat exchanger 13 shown in FIG. 1. By pressurization, it is possible to inhibit foaming of the dope to obtain a homogeneous dope. On this occasion, pressurizing pressure is determined depending on the relation between the heating temperature and the boiling point of the solvent.

### [Cooling Step]

It is effective for obtaining a film having good optical properties to perform a cooling step of cooling the above dope at −100 to −10° C. prior to the heating step. In a system where easy dissolution at ordinary temperature is difficult to achieve or in a system where a large amount of undissolved substances results, a good dope can be prepared using a cooling or heating step or a combination of the both steps. By cooling, the solvent can be rapidly and effectively permeated into the cellulose acylate, whereby the dissolution is accelerated. An effective temperature condition is from −100 to −10° C. In the cooling step, in order to avoid moisture contamination by dew condensation at cooling, it is desired to use a closed vessel. Moreover, when the pressure is reduced at the time of cooling, the cooling time can be shortened. For achieving reduced pressure, it is desired to use a pressure tight vessel. Furthermore, it is also effective in the invention to carry out the cooling step after the above heating step. In this regard, in the case that the dissolution is insufficient, steps of cooling to heating may be repeatedly carried out. Sufficiency of the dissolution can be judged visually by observing the appearance of the solution.

As a specific cooling means in the above cooling step, various methods and apparatus can be adopted. In the dope preparation line shown in FIG. 1, the dope delivered from the heat exchanger 13 is delivered into a heat exchanger 15 under cooling by means of a screw extruder 14. The screw extruder 14 has a jacket 16, a flight 17, and a screw 18, and a coolant is circulated in the jacket 16 for cooling the dope. In the heat exchanger 15, the dope is further cooled and the dope 19 is stored in a stock tank 20.

In this regard, in the dope preparation line shown in FIG. 1, the heating step is carried out prior to the cooling step, but the invention is not limited to the embodiment. In FIG. 2, a dope preparation line of another embodiment is shown and the same members as in FIG. 1 have the same signs. In the dope preparation line shown in FIG. 2, a dope 19 cooled by the screw extruder 14 is introduced into a heat exchanger for heating 21 on which a static mixer 24 is provided and then, heating at a high temperature is carried out under high pressure. The heated dope 19 is flushed into a flushing tank 23 set at a pressure near to atmospheric pressure through a flush valve 22, whereby the temperature of the dope 19 itself is lowered due to the heat of vaporization and the dope 19 can be stored in the flush tank 23. Moreover, at the cooling of the dope, the distance between the flight 17 and the screw 18 is preferably 8 mm or less. In the heat exchanger for cooling, it is preferred to provide a scraping machine 25 for scraping the dope in a solid state. As the scraping machine 25, a monoaxial screw, a biaxial kneader, or the like may be used. Furthermore, in order to enhance the efficiency of the screw extruders 12 and 14, a coolant may be circulated also in a screw shaft. In addition, in the screw extruder 14 ad the heat exchanger 14, the dope is cooled with the coolant, and a temperature difference between the dope and the coolant is preferably 100° C. or lower. In the case that the temperature difference exceeds 100° C., the dope is rapidly cooled to lose flowability, so that a heat transfer rate from the liquid surface remarkably decreases.

[Treatment after Solution Preparation]

The dope prepared by the above heating step can be subjected to treatments such as concentration adjustment (concentration or dilution), filtration, temperature adjustment, and component addition, if necessary. The components to be added are determined depending on the uses of the cellulose acylate film to be prepared. Representative additives include a plasticizer, an Rth decreasing agent, a wavelength dispersion regulator, a release promoter, a deterioration inhibitor (e.g., a peroxide decomposing agent, a radical inhibitor, a metal deactivator, an acid scavenger), a dye, and a UV absorbent.

For charging, not only cellulose acylate flakes but also film scraps of the invention may be added after cutting. The film scraps mean trimmings and films inadequate for products owing to bad surface, which are generated at the preparation of the film of the invention. Moreover, it is possible to add film scraps of a cellulose acylate which is out of the invention. In the latter case, there arises a limitation depending on the kind of film to be added. For example, the acyl groups of the cellulose acylates should be the same kind. The substitution degrees of the cellulose acylates may be different from each other but the adding ratio of the film is sometimes limited. Moreover, in the case that the kinds of the plasticizer, UV absorbent, and Rth decreasing agent are different, the adding ratio is limited. The adding ratio of the film scraps of the invention is not limited relative to the amount of the cellulose acylate flakes used. On the other hand, the adding ratio of the scraps of the film which is out of the invention is limited to about 25% by mass or less although it depends on the kind of the film.

In the invention, a completely dissolved solution may be concentrated. The concentration of the cellulose acylate in the solution after concentration is preferably from 18 to 24% by mass. Particularly preferably, the concentration of the cellulose acylate is from 19.0 to 22.5% by mass. In the concentration range, since the solution is most excellent in both of cooling gelation properties and casting suitability, rapid film preparation can be achieved by the cooling gelation casting. In the invention, the concentration method is not particularly limited. One example of the specific concentration method is a flush concentration method. As described in U.S. Pat. No. 4,504,355, it is a method of obtaining a concentrated solution by evaporating the solvent instantaneously by injecting a heated cellulose acylate solution from a fine nozzle into a pressure-reduced vessel.

### [Foaming Prevention]

The dope is a highly viscous liquid and the dope may come into contact with air in some cases among various tanks of the liquid delivering system. In that case, air may be included in the dope at the injection of the dope into the tank. In JP-UM-B-2-19808, there is proposed a method of dropping a dope onto a liquid surface after once dropping the dope on a plate-like one placed on the liquid surface without dropping the inflow liquid directly onto the liquid surface in a tank. In JP-A-7-84381, impact onto the liquid surface is alleviated and foaming is prevented by feeding a dope slowly through a gutter-like pathway spirally placed in a tank. In JP-A-2003-292635, it is described that entrainment of foam can be prevented by lowering the temperature of the liquid stayed in a tank as compared with the temperature of the inflow liquid into the tank. Also in the invention, these foaming-preventing processes can be effectively employed.

### [Dope Filtration Step]

Prior to casting, the solution is preferably subjected to a removal of undissolved substances, dusts and impurities by filtration with a suitable filtering material such as a metal mesh or a filtering cloth. For filtering the cellulose acylate solution, there is employed a filter of an absolute filtering precision of 1 to 100 μm. The filtration may be carried out sequentially through from a filter having a large filtering precision to a fine filter over multi-stages. The filtering precision of a preferred final stage filter is from 1 to 50 μm. A filter having a filtering precision of 3 to 20 μm is more preferred. The filtering pressure is preferably 1.6 MPa or less, more preferably 1.2 MPa or less, and particularly preferably 1 MPa or less. A low filtering pressure results no problem but too high filtering pressure is not preferred owing to high risk of filter breakage and large possibility of leakage of impurities and undissolved substances.

In order to improve filtering efficiency, it is preferred to execute multi-stage filtration using from a coarse filter to a fine filter sequentially. For example, filtration is executed first through a filter having a pore size of about 30 μm, then through a filter having a pore size of about 15 μm, and finally through a filter having a pore size of from 5 to 10 μm. As another example, filtration is executed first through a filter having a pore size of about 20 μm and, after flush concentration of the dope, it is again filtrated through the same filter having a pore size of about 20 μm and subsequently through a filter having a pore size of about 10 μm. When such multi-stage filtration is executed, clogging of the final-stage filter can be prevented. As the multi-stage filtration, two- to four-stage one is efficient and thus preferred. In the case that a pipe from the filtration step to a casting die is long, there is a possibility that foreign substances in the pipe may be incorporated during the delivery of the dope, so that passage through a filter having a pore size of 50 μm or more or a strainer is also preferably carried out.

The cellulose acylate solution is preferably a solution with which a filter is hardly clogged upon filtration. The clogging upon filtration depends on not only liquid properties but also filter properties, especially mean pore size. It is preferred to adjust a filtration blockage coefficient to 900/m³ or less, more preferably to 500/m³ or less. In the selection of the filter, it is particularly important to select a first-stage filter. The pore size of the filter is selected so that most of the foreign substances to be trapped can be removed on the first filter and, if necessary, by increasing an area of the filter as compared with the latter-stage filter, clogging is prevented. Moreover, as the first-stage filter, a filter having a large capacity of trapping foreign substances rather than filtering precision, so-called a depth filter is preferred. In general, a depth filter has a wide pore size distribution and thus cut-off performance is inferior but foreign substances which pass through surface pores can be probabilistically trapped in pores inside the filter since the filter is made thick. Since fine foreign substances hardly deposit on the surface, the filter has characteristics that much foreign substances can be trapped and clogging is retarded. As the final-stage filter, a surface filter having a relatively narrow pore distribution and excellent in filtering precision is preferred.

### (Transparency of Dope Solution)

The dope transparency of the cellulose acylate solution of the invention is preferably 85% or more, more preferably 88% or more, still more preferably 90% or more.

The present inventors have confirmed that various additives well dissolve in the cellulose acylate dope solution of the invention. A specific method for determining the dope transparency is described. A dope solution is put into a glass cell having a size of 1 cm², and its absorbance at 550 nm is measured with a spectrophotometer (UV-3150 by Shimadzu Corp.). The solvent alone is measured as a blank, and the transparency of the cellulose acylate solution is calculated from the ratio of the solution absorbance to the blank absorbance.

### (Mixing of Additives)

A process for producing a film using the cellulose acylate solution is described. As the process and apparatus for producing the cellulose acylate film of the invention, a solution-casting film-preparation process and a solution-casting film-preparation apparatus for conventional production of cellulose triacetate film are employed. A dope (cellulose acylate solution) prepared from a dissolution machine (tank) is once stored in a storage tank and bubbles contained in the dope are removed, whereby the dope is finally prepared. The dope is delivered from a dope discharging outlet through a pressurized fixed deliver gear pump capable of quantitative feeding with a high degree of accuracy, and a mat agent solution, a UV absorbent solution, a retardation regulator solution, a releasing agent solution, a plasticizer solution, or the like solution is in-line mixed therewith prior to a casting die. These additive solutions may be mixed sequentially or may be mixed with the cellulose acylate solution after a part or all of them are mixed beforehand.

The cellulose acylate solution (dope) with which additive(s) are mixed is cast uniformly onto a metal support traveling endlessly from a slit of a pressure die.

### (Casting)

As a method of casting the solution, there are a method of uniformly extruding the previously prepared dope through a pressure die onto a metal support, a method of using a doctor blade wherein the thickness of the dope once cast onto the metal support is adjusted by means of a blade, and a method of using a reverse roll coater wherein the thickness is adjusted by means of a reversely rotating roll, with the pressure die-using method being preferred. The pressure die includes a coat hunger die type and a T die type, with either of them being preferably usable. Also, the cellulose acetate film can be prepared by various conventionally known cast-filming processes using the cellulose triacetate solution other than are illustrated hereinbefore. The same effects as are described in respective patent documents can be obtained by selecting the conditions in consideration of the difference in boiling point of the solvent used. As the endlessly delivering metal support to be used for producing the cellulose acylate film of the invention, a stainless steel belt or a drum having a surface mirror-finished by chromium plating or having a surface finished by polishing to be a surface roughness of 0.05 μm or less may be used. The surface temperature of the metal support is generally from 10 to 35° C. In the cooling gelation casting process of the invention, the temperature is from −50° to 0° C., preferably from −35 to −3° C., still more preferably from −25 to −5° C. As the pressure die to be used for producing the cellulose acylate film of the invention, one, two or more dies may be provided in the upstream region of the metal support, with one or two dies being preferably provided.

In the case of providing two or more dies, the dope to be cast may be divided with various proportions for respective dies, and the dope may be delivered to respective dies in respective proportions using a plurality of a precise fixed deliver gear pumps. The temperature of the cellulose acylate solution to be used for casting is preferably from −10 to 55° C., more preferably from 25 to 50° C. A temperature which is 5 to 15° C. lower than the boiling point of a solvent to be used. The temperature may be the same over all parts of the step, or may be different in respective part of the step. In the case where the temperature varies in respective parts, it suffices that the temperature is in the above range immediately before casting.

An endless metal support having a width of from 0.8 to 2.5 m, a length of from 5 to 120 cm, and a thickness of from 0.8 to 3.5 mm can be preferably used. The casting width is from 40 cm to 2.3 m and the moving rate of the metal support depends on the solid mass concentration of the dope, final film thickness, length of the endless metal support, temperature of the support, and the like but there is used from 0.5 to 300 m/minute as the rate.

Furthermore, the technologies described in each patent documents of JP-A-2001-129838, JP-A-2000-317960, JP-A-2000-301555, JP-A-2000-301558, JP-A-11-221833, JP-A-07-032391, JP-A-05-185445, JP-A-05-086212, JP-A-03-193316, JP-A-02-276607, JP-A-02-111511, JP-A-02-208650, JP-A-62-037113, JP-A-62-115035, JP-A-55-014201, and JP-A-52-10362 can be applied to the invention.

### (Multi-Layer Casting)

The cellulose acylate solution may be cast onto a metal support of smooth band or drum as a single layer solution, or two or more cellulose acylate solutions may be cast. In the case of casting a plurality of cellulose acylate solutions, the solutions may be cast through respective plural slits provided at intervals in the direction of travel of the metal support to form a film as a laminate. For example, processes described in JP-A-61-158414, JP-A-1-122419 and JP-A-11-198285 may be applied. Also, filming may be conducted by casting the cellulose acylate solution through two casting slits, which can be conducted by the processes described in, for example, JP-B-60-27562, JP-A-61-94724, JP-A-61-947245, JP-A-61-104813, JP-A-61-158413, and JP-A-6-134933. Also, a cellulose acylate film-casting process of enveloping a flow of a highly viscous cellulose acylate solution by a lowly viscous cellulose acylate solution, and co-extruding the highly viscous solution and the lowly viscous solution in such state, described in JP-A-56-162617, may be employed. Particularly, this process is a preferred casting process in cooling gelation casting process using a highly viscous solution. Further, it is also a preferred embodiment to incorporate a poor solvent of alcohol component in the outer solution in more amount than in the inner solution as described in JP-A-61-94724 and JP-A-61-94725. Or, it is also possible to use two casting slits, peel off a film formed on a metal support by casting through the first casting slit, then conduct second casting through the second slit onto the side which has been in contact with the metal support surface. This process is described in, for example, JP-B-44-20235. The solutions to be cast are not particularly limited and may be the same solution or may be different cellulose acylate solutions. In order to impart different functions to a plurality of cellulose acylate layers, it suffices to cast cellulose acylate solutions for respective functions through respective casting slits. By such a process, it is possible to reduce drying load and lower peeling resistance at peeling of the film from the metal support and also, it is possible to enhance production speed of the film.

In the case of co-casting, the thickness of the inside film and the thickness of the outside film are not particularly limited, but the thickness of the outside film is preferably from 1 to 50%, more preferably from 2 to 30%, based on the whole thickness. In the case of co-casting three or more layers, the thickness of the outside film is defined as sum of the thickness of the layer in contact with the metal support and the thickness of the layer in contact with the air. In the case of co-casting, a cellulose acylate film of a laminated structure can be formed by co-casting cellulose acylate solutions different from each other in the concentrations of the aforementioned additives such as a retardation decreasing agent, a plasticizer, an UV absorbent, a mat agent, and a release agent. Namely, it is possible to separate functions in respective layers. For example, a cellulose acylate film having a structure of skin layer/core layer/skin layer can be prepared. For example, the mat agent can be incorporated in a more amount in the skin layer or in only the skin layer. The plasticizer and the UV absorbent can be incorporated in more amounts in the core layer than in the skin layer, or may be incorporated only in the core layer. It is also possible to change the kind of the plasticizer and the UV absorbent between the core layer and the skin layer. For example, it is possible to incorporate an additive hardly bleed out in the skin layer and to add an additive easy to bleed out but excellent in retardation decreasing property or a UV absorbent easy to bleed out but excellent in UV ray-absorbing ability to the core layer. It is also a preferred embodiment to incorporate a release agent only in a skin layer on the metal support side. In order to gel the solution by cooling the metal support according to the cooling gelation casting process, it is also preferred to add a poor solvent of an alcohol to the skin layer in a more amount than to the core layer. The skin layer and the core layer may be different from each other in Tg, and it is preferred that Tg of the core layer is lower than Tg of the skin layer.

### (Cooling Gelation)

The use of the cooling gelation casting process as described in JP-A-62-115035 is preferred owing to rapid drying and excellent productivity. In the process, the metal support is cooled to 15° C. or lower and it is preferred to dry it by applying dry air for 2 seconds or more at such a temperature and amount that the surface temperature of the support is not raised. In this process, since a self-holding property is imparted to the film through viscosity increase mainly induced by cooling or by gelation under cooling, peeling of the film is facilitated even at a high residual volatile matter content. Preferred residual volatile matter content at peeling is from 150 to 330% and more preferred is from 190 to 310%. Here, the residual volatile matter content means a proportion of volatile matter in the film when the solid content (components which remain as a film after completion of drying) is regarded as 100%. Preferred film temperature at peeling is from 5 to −50° C., more preferably from 0 to −35° C., particularly preferably from −5 to −25° C. In this process, since the film is peeled off from the support in a state that a large amount of the solvent remains, subsequent drying is carried out from both surfaces, which therefore results in rapid drying. It is presumed that such a rapid drying reduces retardation in a thickness direction Rth. Moreover, since time for one surface drying can be shortened, total drying time can be remarkably shortened and hence a large reducing effect on cost and environmental load is achieved.

In the cooling gelation casting, it is advantageous to use a drum as the metal support. By enclosing a coolant in the drum, a casting liquid film can be effectively gelled under cooling. Preferred peripheral length of the drum is from 2 to 20 m. Preferred casting rate is from 0.5 to 300 m per minute. More preferred casting rate per 1 m of the peripheral length of the drum is from 2 to 20 m, particularly preferably from 5 to 15 m per minute.

### (Tenter Drying)

When the film is peeled off from the metal support at a high volatile matter content, the film is apt to shrink in the subsequent drying process and thus surface condition are deteriorated in the shrinking process. In order to prevent the deterioration of the surface conditions, drying is carried out with stretching or suppressing shrinkage in the invention by the method as described below.

In the invention, when the film is peeled off from the support, the film is drawn at a speed 1.01 to 1.4 times larger than the speed of the support to prevent deterioration of surface conditions. A larger ratio of the drawing speeds can result in a larger elastic modulus in the casting direction of the film. The peeled film is held at both ends of the film by means of a width-regulating apparatus (e.g., a tenter apparatus) as described in JP-A-62-115035 and JP-A-62-46625 and dried with regulating the shrinkage of the film or with stretching it in the width direction. The ratio of the film width between inlet and outlet of the width-regulating apparatus is preferably from 0.75 to 1.4. The stretching in the width direction can increase elastic modulus in the width direction and hence is preferred. Drying is carried out by passing a hot air of from 50 to 100° C. therethrough. It is preferred to divide the width-regulating apparatus into 2 to 5 stages and the temperature of the drying air is sequentially changed from a low temperature to a high temperature. When the temperature is too high, the film tends to foam. At the final stage, it is preferred to use an air of from 130 to 150° C., more preferably from 135 to 145° C. When the temperature exceeds 150° C., elasticity of the film remarkably decreases and a rapid traveling becomes difficult.

With regard to the drying speed in the width-regulating apparatus, since decrease in Rth is expected, within the range where the film does not foam, the faster the speed is, the more preferred. The time required for the reduction of the residual volatile matter content in the film from the state of 200% to the state of 5% is preferably from 1.5 to 5 minutes, more preferably from 1.5 to 4 minutes. The most preferred is from 1.5 to 3 minutes. In order to prevent the foaming of the film, it is preferred that the hot air is applied only to the central part of the film and the part held by a clip, which part does not constitute a product, is contrarily cooled.

### (Winding)

After the residual solvent content in the film has reached 20% or lower, the film is removed from the width-regulating apparatus and further dried at a temperature of 100 to 150° C. Both trimming parts which have been deformed by the width-regulating apparatus are cut off and the film is wound up with imparting knurling to both edges. The width of the knurling is from 3 mm to 50 mm, more preferably from 5 mm to 30 mm and the height thereof is from 0.5 to 500 μm, more preferably from 1 to 200 μm. It may be single-side pressing or double-side pressing. The winding length is preferably from 100 to 10,000 m, more preferably from 500 to 6,000 m, still more preferably from 1,000 to 4,000 m per roll.

### (Film Thickness)

The thickness of the finished (dried) cellulose acylate film of the invention is preferably in the range of from 30 to 180 μm, more preferably in the range of from 38 to 100 μm, particularly preferably in the range of from 38 to 82 μm.

For regulating the film thickness, the solid matter content in the dope, slit gap of mouthpiece of the die, extrusion pressure from the die, speed of the metal support, and the like may be controlled so as to achieve a desired thickness.

### (Number of Luminous Foreign Matter on Film)

When the cellulose acylate film is placed between two sheets of polarizing plates overlaid so that their retardation axes are orthogonal each other and then the film is observed, light is leaked as white spots in some cases. In the case that the raw material cellulose acylate contains a large amount of components hardly dissolved in the solvent or in the case that the dissolving conditions are not adequate, such light-leaking foreign matter (luminous foreign matter) is present in a large amount. In the invention, the amount of the luminous foreign matter can be reduced by selection of a cellulose acylate having a good solubility, selection of suitable solvent composition, and suitable dissolving conditions, especially dissolving temperature. Furthermore, as mentioned above, the amount of the luminous foreign matter is effectively reduced by filtration of the cellulose acylate solution prior to the casting. Upon film observation, a range of 2.16 mm×1.72 mm is magnified 50 times and luminous points having a size of 1 mm or more are counted. Such a measurement is carried out for 60 viewing fields per 1 sample. When all the luminous points are summed, preferred number of luminous points is 80 or less, and more preferred is 40 or less and most preferred is 20 or less.

### (Water Vapor Permeability of Film)

The water vapor permeability is determined by measuring water amount (g) vaporized during 24 hours per m² in accordance with the method described in JIS Z-0208 and the water vapor permeability of each sample is calculated.

In the case of the cellulose acylate film prepared without using the cooling gelation casting process, the water vapor permeability is from 480 to 550 g/m² at 40° C. and 90% RH for 24 hours when the film thickness is 80 μm. However, in the case of the invention wherein the cooling gelation casting process is adopted, the water vapor permeability becomes so low as from 350 to 400 g/m² at the same thickness of 80 μm. The water vapor permeability of the cellulose acylate film is preferably small and more preferred water vapor permeability of the 80 μm film of the invention is from 350 to 400 g/m².

### (Elastic Modulus of Film)

Preferred elastic modulus of the cellulose acylate film of the invention prepared by the cooling gelation casting process is from 4.2 GPa to 6 GPa. It has been found that elastic modulus of 4 GPa or more in both of the casting and width directions is obtained when the film is not shrunk in the width direction. Particularly, it has been found that a film having elastic modulus of 4.2 GPa or more in both of the casting and width directions is obtained by stretching the film by 5% or more in the width direction. On the other hand, the elastic modulus of the cellulose acylate film obtained without using cooling gelation casting process is about 4 GPa in both of the casting and width directions. In order to use the film in a liquid-crystal display device, the elastic modulus is preferably large. By increasing the elastic modulus of the cellulose acylate film, a large effect of suppressing shrinkage of the polyvinyl alcohol film of a polarizing plate to be used in a liquid-crystal display device and, as a result, light leakage at peripheral part of the liquid-crystal display device can be reduced. More preferred elastic modulus of the cellulose acylate film of the invention is from 4.3 GPa to 5.5 GPa, particularly preferred elastic modulus is from 4.4 G to 5.2 GPa.

### (Dimensional Change of Film)

The dimensional change of the cellulose acylate film is preferably small. Both of the dimensional change in the case that the film is allowed to stand under conditions of 60° C. and 90% RH for 24 hours and the dimensional change in the case that the film is allowed to stand under conditions of 90° C. and 3% RH for 24 hours are desirably within ±0.2%. When the dimensional change is large, a stress occurs in the film when it is mounted on a liquid-crystal display device and, as a result, retardation owing to the stress generates, which causes light leakage of the liquid-crystal display device. Moreover, when the dimensional change is large, there is a high possibility of generation of warp and hence the case is not preferred.

### (Polarizing Plate)

The polarizing plate comprises a polarizer and two sheets of transparent protective films, wherein the polarizing plate is placed between the two transparent protective films. The cellulose acylate film of the invention can be used as the protective films. The cellulose acylate film of the invention can be used at both sides of the polarizer or may be used only one side thereof. The polarizer includes an iodine-containing polarizer, a dye-containing polarizer using a dichroic dye, and a polyene-based polarizer. The iodine-containing polarizer and the dye-containing polarizer are generally produced using a polyvinyl alcohol-based film. In the case of using the cellulose acylate film of the invention as a protective film for the polarizing plate, the method for preparing the polarizing plate is not particularly limited, and the polarizing plate may be prepared by a general method. There is a method of subjecting the resultant cellulose acylate film to an alkali treatment and superposing the film on both sides of a polarizer having been prepared by stretching a polyvinyl alcohol film while it is immersed in an iodine solution, using an aqueous solution of a completely saponified polyvinyl alcohol. In place of the alkali treatment, an easily adhesive processing as described in JP-A-6-94915 and JP-A-6-118232 may be employed. Examples of the adhesive to be used for adhering the treated surface of the protective film to the polarizer include polyvinyl alcohol-based adhesives such as a polyvinyl alcohol-based adhesive and a polyvinylbutyral-based adhesive and vinyl-based latexes such as a butyl acrylate-based latex. The polarizing plate is constituted by the polarizer and the protective films for protecting both sides of the polarizer and, further, is constituted by a protection film attached on one side of the polarizing plate and a separable film attached on the other side thereof. The protection film and the separable film are used for the purpose of protecting the polarizing plate upon shipping or checking the product. In this case, the protection film is superposed for the purpose of protecting the surface of the polarizing plate and is used on the side opposite to the side which is to be stacked onto a liquid-crystal plate. Also, the separable film is used for the purpose of covering the adhesive layer to be laminated onto the liquid-crystal plate and is used on the side which is to be stacked onto the liquid-crystal plate.

With regard to the method of stacking the cellulose acylate film of the invention to the polarizer, the stacking angle to the light axis of the polarizer is not particularly limited. The slow axis of the cellulose acylate film and the transmission axis of the polarizer may be parallel or orthogonal, or may form an intermediary adequate angle.

In the polarizing plate according to the invention, it is preferable that a single plate transmittance TT, a parallel transmittance PT, a cross transmittance CT, and a polarization degree P at 25° C. and 60% RH satisfy at least one of the following formulae (a) to (d):

40.0≦TT≦45.0 (a)

30.0≦PT≦40.0 (b)

CT≦2.0 (c)

95.0≦P (d).

The single plate transmittance TT, the parallel transmittance PT, and the cross transmittance CT are more preferably 40.5≦TT≦45, 32≦PT≦39.5, and CT≦1.5, still more preferably 41.0≦TT≦44.5, 34≦PT≦39.0, and CT≦1.3, respectively. The degree of polarization P is preferably 95.0% or more, more preferably 96.0% or more and still more preferably 97.0% or more.

In the polarizing plate according to the invention, when a cross transmittance at a wavelength λ is represented by CT_{(λ)}, it is preferable that CT₍₃₈₀₎, CT₍₄₁₀₎, and CT₍₇₀₀₎ satisfy at least one of the following formulae (e) to (g):

CT₍₃₈₀₎≦2.0 (e)

CT₍₄₁₀₎≦1.0 (f)

CT₍₇₀₀₎≦0.5 (g).

More preferably, CT₍₃₈₀₎≦1.95, CT₍₄₁₀₎≦0.9, and CT₍₇₀₀₎≦0.49, and still more preferably, CT₍₃₈₀₎≦1.90, CT₍₄₁₀₎≦0.8, and CT₍₇₀₀₎≦0.48.

In the polarizing plate according to the invention, it is preferable that a change in cross transmittance ΔCT and polarization degree ΔP when the polarizing plate is allowed to stand under conditions of 60° C. and 95% RH for 500 hours satisfy at least one of the following formulae (j) and (k):

−6.0≦ΔCT≦6.0 (j)

−10.0≦ΔP≦0.0 (k)

wherein the change means a value obtained by subtracting a measurement value before the test from a measurement value after the test.

More preferably, −5.8≦ΔCT≦5.8 and −9.5≦ΔP≦0.0, and still more preferably, −5.6≦ΔCT≦5.6 and −9.0≦ΔP≦0.0.

In the polarizing plate according to the invention, it is preferable that a change in cross transmittance ΔCT and polarization degree ΔP when the polarizing plate is allowed to stand under conditions of 60° C. and 90% RH for 500 hours satisfy at least one of the following formulae (h) and (i):

−3.0≦ΔCT≦3.0 (h)

−5.0≦ΔP≦0.0 (i)

In the polarizing plate according to the invention, it is preferable that a change in cross transmittance ΔCT and polarization degree ΔP when the polarizing plate is allowed to stand under conditions of 80° C. for 500 hours satisfy at least one of the following formulae (l) and (m):

−3.0≦ΔCT≦3.0 (l)

−2.0≦ΔP≦0.0 (m)

The single plate transmittance TT, the parallel transmittance PT, and the cross transmittance CT of the polarizing plate are measured using UV3100PC (manufactured by Shimadzu Corp.) within the range of 380 nm to 780 nm. In each of TT, PT, and CT, the mean of values measured 10 times (mean within the range of 400 nm to 700 nm) is adopted. The polarization degree ΔP can be determined according to the following equation: Polarization degree (%)=100×{(parallel transmittance−cross transmittance)/(parallel transmittance+cross transmittance)}½. The polarizing plate durability test is carried out in two modes including (1) the polarizing plate alone and (2) the polarizing plate bonded to a glass plate via a pressure-sensitive adhesive. To measure the polarizing plate alone, two samples each having the cellulose acylate film of the invention inserted between two polarizers located orthogonally are prepared. In the mode of bonding the polarizing plate to a glass plate, two samples (about 5 cm×5 cm) each having the polarizing plate bonded to the glass plate in such a manner that the cellulose acylate film of the invention is at the glass plate side are prepared. The single plate transmittance is measured by setting the film side of the samples toward a light source. Two samples are measured respectively and the mean is regarded as the transmittance of single plate.

[Usage (Optically-Compensatory Film)]

The cellulose acylate film of the invention may be used for various uses but is particularly effective when it is used as an optically-compensatory film of a liquid-crystal display device. Incidentally, the optically-compensatory film is used in a liquid-crystal display device and indicates an optical material of compensating the phase difference, and this film has the same meaning as the retardation plate, optically-compensatory sheet, or the like. The optically-compensatory film has birefringence and is used for the purpose of eliminating the coloration on the display screen of a liquid-crystal display device or improving the viewing angle property. The cellulose acylate film of the invention is low in optical anisotropy and small in wavelength dispersion, so that excessive anisotropy does not occur and when an optically anisotropic layer having birefringence is used in combination, only the optical performance of the optically anisotropic layer can be exhibited.

Therefore, in the case that the cellulose acylate film of the invention is used as an optically-compensatory film of a liquid-crystal display device, Re and Rth of the optically-anisotropic layer to be used in combination fall preferably within the following ranges: Re is from 0 to 200 nm and |Rth| is from 0 to 400 nm. Any optically-anisotropic layer may be usable so far as the values fall within the ranges. The optical performance and driving mode of the liquid-crystal cell of the liquid-crystal display device in which the cellulose acylate film of the invention is used are not particularly limited and any optically-anisotropic layer required as an optically-compensatory film may be used in combination. The optically-anisotropic layer to be used in combination may be formed of a composition containing a liquid-crystal compound or may be formed of a polymer film having birefringence.

As the above liquid-crystal compound, a discotic liquid-crystal compound or a rod-shaped liquid-crystal compound is preferred.

### (Discotic Liquid-Crystal Compound)

Examples of the discotic liquid-crystal compound usable in the invention include compounds described in various references (C. Destrade et al., Mol. Cryst. Liq. Cryst., Vol. 71, p. 111 (1981); Quarterly Journal of Outline of Chemistry, by the Chemical Society of Japan, No. 22, Chemistry of Liquid Crystal, Chap. 10, Sec. 2 (1994); B. Kohne et al., Angew. Chem. Soc. Chem. Comm., p. 1794 (1985); J. Zhang et al., J. Am. Chem. Soc., Vol. 116, p. 2655 (1994)).

Preferably, the discotic liquid-crystal molecules are fixed as aligned in the optically-anisotropic layer, most preferably fixed therein through polymerization. The polymerization of discotic liquid-crystal molecules is described in JP-A-8-27284. For fixing discotic liquid-crystal molecules through polymerization, a polymerizable group must be bonded to the disc core of each discotic liquid-crystal molecule as a substituent thereto. However, if such a polymerizable group is directly bonded to the disc core, then the molecules could hardly keep their orientation during polymerization. Accordingly, a linking group is introduced between the disc core and the polymerizable group to be bonded thereto. Such polymerizable group-having discotic liquid-crystal molecules are disclosed in JP-A-2001-4387.

### (Rod-Shaped Liquid-Crystal Compound)

Examples of the rod-shaped liquid-crystal compound usable in the invention include azomethines, azoxy compounds, cyanobiphenyls, cyanophenyl esters, benzoates, phenyl cyclohexanecarboxylates, cyanophenylcyclohexanes, cyano-substituted phenylpyrimidines, alkoxy-substituted phenylpyrimidines, phenyldioxanes, tolans, and alkenylcyclohexylbenzonitriles. Not only such low-molecular liquid-crystal compounds, but also high-molecular liquid-crystal compounds may also be usable herein.

In the optically-anisotropic layer, it is desirable that the rod-shaped liquid-crystal molecules are fixed in an aligned state, most preferably they are fixed through polymerization. Examples of the polymerizable rod-shaped liquid-crystal compound usable in the invention include compounds described in Macromol. Chem., Vol. 190, p. 2255 (1989); Advanced Materials, Vol. 5, p. 107 (1993); U.S. Pat. Nos. 4,683,327, 5,622,648, 5,770,107; International (WO) Laid-Open Nos. 95/22586, 95/24455, 97/00600, 98/23580, 98/52905; JP-A-1-272551, JP-A-6-16616, JP-A-7-110469, JP-A-11-80081, and JP-A-2001-328973.

### (Optically Anisotropic Layer Comprising Polymer Film)

The optically anisotropic layer may also be formed from a polymer film. The polymer film is formed of a polymer capable of expressing optical anisotropy. Examples of such a polymer include polyolefin (e.g., polyethylene, polypropylene, norbornene-based polymer), polycarbonate, polyarylate, polysulfone, polyvinyl alcohol, polymethacrylic acid ester, polyacrylic acid ester, and cellulose ester (e.g., cellulose triacetate, cellulose diacetate). Also, a copolymer of such a polymer or a mixture of these polymers may be used.

The optical anisotropy of the polymer film is preferably obtained by stretching. The stretching is preferably uniaxial stretching or biaxial stretching. More specifically, longitudinal uniaxial stretching utilizing peripheral velocity difference of two or more rolls, tenter stretching of stretching the polymer film in the width direction by nipping both sides, or biaxial stretching using these in combination is preferred. It is also possible that two or more polymer films are used and the optical property of two or more films as the whole satisfies the above-described conditions. The polymer film is preferably produced by a solvent casting process so as to lessen unevenness of birefringence. The thickness of the polymer film is preferably from 20 to 500 mm, most preferably from 40 to 100 mm.

### (Constitution Example of Liquid-Crystal Display Device)

When the cellulose acylate film of the invention is used as an optically-compensatory film, the transmission axis of the polarizer element for it may be at any angle to the slow axis of the optically-compensatory film of the cellulose acylate film. A liquid-crystal display device comprises a liquid-crystal cell that carries a liquid crystal between two electrode substrates, two polarizing elements disposed on both sides of the cell, and at least one optically-compensatory film disposed between the liquid-crystal cell and the polarizing element.

The liquid-crystal layer of the liquid-crystal cell is generally formed by introducing a liquid crystal into the space formed by two substrates via a spacer put therebetween, and sealed up in it. A transparent electrode layer is formed on a substrate as a transparent film that contains a conductive substance. The liquid-crystal cell may further have a gas barrier layer, a hard coat layer, or an undercoat layer (for adhesion to transparent electrode layer). These layers are generally formed on a substrate. The substrate of the liquid-crystal cell generally has a thickness of from 50 μm to 2 mm.

### (Type of Liquid-Crystal Display Device)

The cellulose acylate film of the invention may be used in various liquid-crystal cells of various display modes. Various display modes such as TN (twisted nematic), IPS (in-plane switching), FLC (ferroelectric liquid crystal), AFLC (anti-ferroelectric liquid-crystal), OCB (optically-compensatory bend), STN (super-twisted nematic), VA (vertically aligned), ECB (electrically-controlled birefringence), and HAN (hybrid aligned nematic) modes have been proposed. Also proposed are other display modes with any of the above-mentioned display modes aligned and divided. The cellulose acylate film of the invention is effective in liquid-crystal display devices of any display mode. Furthermore, it is also effective in any of transmission-type, reflection-type and semitransmission-type liquid-crystal display devices.

### (TN-Mode Liquid-Crystal Display Device)

The cellulose acylate film of the invention may be used as a support of the optically-compensatory sheet in TN-mode liquid-crystal cell-having TN-mode liquid-crystal display devices. TN-mode liquid-crystal cells and TN-mode liquid-crystal display devices are well known from the past. The optically-compensatory sheet to be used in TN-mode liquid-crystal display devices is described in JP-A-3-9325, JP-A-6-148429, JP-A-8-50206, JP-A-9-26572. In addition, it is also described in Mori et al's reports (Jpn. J. Appl. Phys., Vol. 36 (1997), p. 143; Jpn. J. Appl. Phys., Vol. 36 (1997), p. 1068).

### (STN-Mode Liquid-Crystal Display Device)

The cellulose acylate film of the invention may be used as a support of the optically-compensatory sheet or as a protective film of the polarizing plate in STN-mode liquid-crystal cell-having STN-mode liquid-crystal display devices. In general, in an STN-mode liquid-crystal display device, the rod-shaped liquid-crystal molecules in the liquid-crystal cell are twisted at an angle within a range of from 90 to 360 degrees, and the product of the refractivity anisotropy (Δn) of the rod-shaped liquid-crystal molecules and the cell gap (d), And falls between 300 and 1500 nm. The optically-compensatory sheet to be used in STN-mode liquid-crystal display device is described in JP-A-2000-105316.

### (VA-Mode Liquid-Crystal Display Device)

The cellulose acylate film of the invention is especially preferably used as a support of the optically-compensatory sheet or as a protective film of the polarizing plate in VA-mode liquid-crystal cell-having VA-mode liquid-crystal display devices. Preferably, the optically-compensatory sheet for use in VA-mode liquid-crystal display devices has a retardation Re of from 0 to 150 nm and a retardation Rth of from 70 to 400 nm. More preferably, the retardation Re of the sheet is from 20 to 70 nm. When two optically anisotropic polymer films are used in a VA-mode liquid-crystal display device, then the retardation Rth of the films preferably falls between 70 and 250 nm. When one optically-anisotropic polymer film is used in a VA-mode liquid-crystal display device, then the retardation Rth of the film preferably falls between 150 and 400 nm. The VA-mode liquid-crystal display devices for the invention may have an orientation-divided system, for example, as described in JP-A-10-123576.

### (IPS-Mode Liquid-Crystal Display Device, and ECB-Mode Liquid-Crystal Display Device)

The cellulose acylate film of the invention is also especially preferably used as a support of the optically-compensatory sheet or as a protective film of the polarizing plate in IPS-mode or ECB-mode liquid-crystal cell-having IPS-mode liquid-crystal display devices and ECB-mode liquid-crystal display devices. In these modes, the liquid-crystal material is aligned nearly in parallel to the film face in black display, and the liquid-crystal molecules are aligned in parallel to the surface of the substrate when no voltage is applied to the device for black display. In these embodiments, the polarizing plate that comprises the cellulose acylate film of the invention contributes to enlarging the viewing angle and to improving the image contrast. In these embodiments, the retardation value of the optically-anisotropic layer disposed between the protective film of the polarizing plate and the liquid-crystal cell is preferably at most 2 times the value of Δn·d (difference of refractive index×thickness) of the liquid-crystal layer. Also preferably, the absolute value of Rth, |Rth| is 25 nm or less, more preferably 20 nm or less, still more preferably 15 nm or less. Accordingly, the cellulose acylate film of the invention is preferably used.

### (OCB-Mode Liquid-Crystal Display Device, and HAN-Mode Liquid-Crystal Display Device)

The cellulose acylate film of the invention is also advantageously used as a support of the optically-compensatory sheet or as a protective film of the polarizing plate in OCB-mode liquid-crystal cell-having OCB-mode liquid-crystal display devices or HAN-mode liquid-crystal cell-having HAN-mode liquid-crystal display devices. Preferably, the optically-compensatory sheet for use in OCB-mode liquid-crystal display devices or HAN-mode liquid-crystal display devices is so designed that the direction in which the absolute value of the retardation of the sheet is the smallest does not exist both in the in-plane direction and in the normal line direction of the optically-compensatory sheet. The optical properties of the optically-compensatory sheet for use in OCB-mode liquid-crystal display devices or HAN-mode liquid-crystal display devices are determined, depending on the optical properties of the optically-anisotropic layer, the optical properties of the support and the positional relationship between the optically-anisotropic layer and the support. The optically-compensatory sheet fro use in OCB-mode liquid-crystal display devices or HA-mode liquid-crystal display devices is described in JP-A-9-197397. It is described also in Mori et al's reports (Jpn. J. App. Phys., Vol. 38 (1999), p. 2837).

### (Reflection-Mode Liquid-Crystal Display Device)

The cellulose acylate film of the invention is also advantageously used as a support of the optically-compensatory sheet or as a protective film of the polarizing plate in TN-mode, STN-mode, HAN-mode or GH (guest-host)-mode reflection-type liquid-crystal display devices. These display modes are well known from the past. TN-mode reflection-type liquid-crystal display devices are described in JP-A-10-123478, WO 98/48320, and Japanese Patent No. 3022477. The optically-compensatory film for use in reflection-type liquid-crystal display devices is described in WO 00/65384.

### (Other Liquid-Crystal Display Devices)

The cellulose acylate film of the invention is also advantageously used as a support of the optically-compensatory sheet or as a protective film of the polarizing plate in ASM (axially symmetric aligned microcell)-mode liquid-crystal cell-having ASM-mode liquid-crystal display devices. The liquid-crystal cell in ASM-mode devices is characterized in that it is supported by a resin spacer capable of controlling and varying the thickness of the cell. The other properties of the cell are the same as those of the liquid-crystal cell in TN-mode devices. ASM-mode liquid-crystal cells and ASM-mode liquid-crystal display devices are described in Kume et al's report (Kume et al., SID 98 Digest 1089 (1998)).

### (Hard Coat Film, Antiglare Film, Antireflection Film)

The cellulose acylate film of the invention is preferably applied to hard coat films, antiglare films, and antireflection films. For the purpose of improving the visibility of flat panel displays such as LCD, PDP, CRT, EL, any or all of a hard coat layer, antiglare layer, and antireflection layer may be fitted to one or both faces of the cellulose acylate film of the invention. Preferred embodiments of such antiglare films and antireflection films are described in detail in Hatumei Kyokai's Kokai Giho (Kogi No. 2001-1745 issued Mar. 15, 2001, by Hatsumei Kyokai), pp. 54-57, and the cellulose acylate film of the invention may be preferably used therein.

### EXAMPLES

First, measuring methods used in Examples of the invention will be described.

### <Measuring Method of Average Molecular Mass s Mn, Mw of Cellulose Acylate>

They were measured by a liquid chromatography under the following conditions.

| | |
|---|---|
| Solvent: | methylene chloride |
| Column: | Tosoh TSKgel GMH (two columns of |
| | products of Tosoh Corp. were used in series) |
| Column temperature: | 29° C. |
| Sample concentration: | 0.2 mass/volume % |
| Flow rate: | 0.8 ml/1 min |

(For Calibration, a Calibration Curve Obtained from 6 Samples of Standard Sample Mw=772,000 to 6,900 was Used)

### <Measuring Method of 6% Viscosity of Cellulose Acylate>

A cellulose acylate was dissolved in an amount of 6% by mass in a mixed solvent of methylene chloride and methanol in a mass ratio of 91:9. The flowing time at 25° C. was measured using an Ostwald viscometer and 6% viscosity was calculated according to the following expression.

6% Viscosity(mPa·s)=Flowing Time(second)×Viscometer Coefficient

The viscometer coefficient is determined by measuring flowing time (second) in the same manner as in the case of the above solution using a standard solution for viscometer calibration.

Incidentally, Viscometer Coefficient=Absolute Viscosity of Standard Solution (cps)×Density of Solution (1.235 g/cm³)/Density of Standard Solution (g/cm³)/Flowing Time (second) of Standard Solution

### <Measuring Method of Storage Modulus of Cellulose Acylate>

A sample solution having the following composition was prepared at room temperature of 25° C. At that time, the solution was stirred for 2 hours using a rotation blade of 150 rpm. On about 1 mL of the sample solution, viscoelasticity was measured using a stress-rheometer (CVO 120) manufactured by Bohlin Instruments. Storage modulus E′ (25) (unit: Pa) was measured at a dope temperature of 25° C. and a frequency of 1 Hz under a condition of loading 1% displacement. Thereafter, 120 ml of the sample solution was introduced into a 150 ml-volume pressure-tight stainless steel vessel and the whole was placed in an air constant-temperature chamber of 70° C. for 3 hours. After taken out of the air constant-temperature chamber, the vessel was cooled overnight and then the storage modulus E′ (70) of the sample solution was again measured by the above method.

### <Measuring Method of Filtration Blockage Coefficient>

A cellulose acylate solution kept at 36° C. was filtrated in a flow rate of 7 ml/minute through a filter (pore size: 47 μm, thickness: 1.32 mm, density: 0.32 g/m³) supported by a porous plate wherein 61 pores having a size of 3.8 mm were provided within a circular disc having an effective area of 12.5 cm². Then, pressure increase was observed for 3.5 to 4 hours from the time when filtering pressure was temporarily stabilized. A graph was prepared with plotting P0/P^{0.64} to the ordinate axis while the abscissa axis showed filtering time, and a linear approximate expression for the plots was determined. P and P0 represent filtering pressure and initial filtering pressure, respectively.

A filtration blockage coefficient Ks was calculated by substituting the determined slope of the straight line into a filtration blockage coefficient expression [−Ks=3.5×slope]. Incidentally, the pore size of the filter to be used is a value calculated from the bubble point value of the filter. Moreover, a gear pump (KA1 manufactured by Kawasaki Heavy Industries, Ltd.) was employed for liquid delivering.

### <Measuring Method of Number of Luminous Points of Cellulose Acylate Film>

A sample film was placed between two polarizing plates of a polarization microscope and the slow axes of the two polarizing plates were orthogonal each other. A picture plane observing a range of 2.16 mm×1.72 mm of the sample film at a magnification of 50 times was recorded as a JPG compression mode at a recording density of 1280×1024 dots. Thus, 60 areas of electrophotographs per film sample were taken in the same manner. The photographs were adjusted on a screen of a personal computer so as to be an image of a magnification of 50 times the actual size, and the number of luminous points which glistened white on the screen and had a length of major axis of from 1 mm to 10 mm was counted. The numbers of the luminous points of every 60 areas of each film sample were summed and the total was regarded as the number of luminous points of each film samples.

The following will describe Examples of the invention but the invention is not limited thereto. The substituent and substitution degree, 6% viscosity, number-average molecular mass Mn, mass-average molecular mass Mw, and starting raw material of each of the cellulose acylates (CA1) to (CA8) were as shown in Table 1. Incidentally, residual amount of sulfuric acid in the cellulose acylates was found to be 53 ppm and the content of alkaline earth metals was found to be 82 ppm. Furthermore, the storage modulus and filtration blockage coefficient of each of the cellulose acylate solutions dissolved under heating, and the number of luminous points of each of the resultant films were also shown in Table 1.

### Example 1

### Preparation of Cellulose Acylate Solution

The following composition was charged into a mixing tank and stirred to dissolve individual components. The solution was delivered to a heat exchanger (a static mixer with a jacket) by means of a gear pump and the temperature was kept at 90 to 95° C. for 10 minutes. Then, the solution was cooled to 30° C. in a cooling heat exchanger (a static mixer with a jacket). The solution was filtrated through a filter having a mean pore size of 47 μm. The blockage coefficient at this time was so small as 222/m³ and the progress of clogging was slow. Furthermore, the solution was filtrated through a metal mesh filter having a pore size of 10 μm to prepare a cellulose acetate solution (LA1). The solution (LA1) was again delivered to a heat exchanger (a static mixer with a jacket) by means of a gear pump. After the temperature was raised to 84° C., the solution was introduced into a flush concentration apparatus and concentrated. The solid matter concentration of the resultant cellulose acylate solution (LB1) was found to be 23.4% by mass. Thus, the concentration of the cellulose acylate was calculated to be 20.9% by mass.

### <Composition of Cellulose Acylate Solution (LA1)>

| | |
|---|---|
| Cellulose acylate (CA1) | 100 parts by mass |
| Methylene chloride | 433 parts by mass |
| Ethanol | 75 parts by mass |
| 1-Butanol | 5 parts by mass |
| Compound which decreases | 12 parts by mass |
| optical anisotropy (119) | |

### (Preparation of Mat Agent Solution)

Twenty parts by mass of silica particles dispersion having a mean particle size of 16 nm (AEROSIL R972, manufactured by Japan Aerosil K.K.) and 80 parts by mass of methanol were thoroughly stirred and mixed to form a silica particle dispersion. The dispersion was charged into a dispersing machine together with the following composition, the whole was further stirred to dissolve individual components and filtrated through a nonwoven fabric filter having a mean pore size of 20 μm, whereby a mat agent solution (LC1) was prepared.

### <Composition of Mat Agent Solution (LC1)>

| | |
|---|---|
| Silica particle dispersion having | 12.0 parts by mass |
| a mean particle size of 16 nm | |
| Methylene chloride | 68.5 parts by mass |
| Ethanol | 11.8 parts by mass |
| 1-Butanol | 0.7 parts by mass |
| Cellulose acylate solution (LA1) | 11.3 parts by mass |

### (Preparation of Additive Solution)

The following composition was prepared and filtrated through a filter having a mean pore size of 47 μm, whereby an additive solution (LD1) was prepared.

### <Composition of Additive Solution (LD1)>

| | |
|---|---|
| Wavelength dispersion regulator (UV-102) | 7.3 parts by mass |
| Methylene chloride | 55.3 parts by mass |
| Ethanol | 9.5 parts by mass |
| 1-Butanol | 0.6 parts by mass |
| Cellulose acylate solution (LA1) | 12.8 parts by mass |

### [Manufacture of Cellulose Ester Film (F1) of the Invention]

In a static mixer, 76.2 parts by mass of the above cellulose acylate solution (LB1), 1.8 parts by mass of the mat agent solution (LC1), and 2.6 parts by mass of the additive solution (LD1) were mixed. Then, the mixture was cast onto a stainless steel drum cooled to −15° C. After cooled until the liquid temperature reached about −10° C., a film was peeled off from the drum and it was fixed on a tenter apparatus. On this occasion, the traveling speed of the tenter was 1.06 times larger than the drum speed. The drying temperature in the tenter apparatus was changed from 70° C. to 130° C. stepwise. The film width at the outlet of the tenter apparatus was made 1.05 times the film width at the inlet. After discharged from the tenter apparatus, the film was further dried at 130 to 140° C. and then wound. Thus, a cellulose ester film (F1) of the invention having a film thickness of 82 μm was obtained. The residual amount of the solvent at winding was found to be 0.4%. The appearance of the film was so smooth as mirror surface and foreign matter was hardly observed. Re retardation was found to be 1.5 nm or less and Rth retardation was found to be between −5 nm and +5 nm. The elastic modulus was found to be 4.6 GPa in the casting direction and 4.4 GPa in the width direction. The number of luminous foreign matter was so small as 40 or less.

### Example 2

### Preparation of Cellulose Acylate Solution

When a cellulose acylate solution was prepared in the same manner as in Example 1 using the following composition, the composition was dissolved, filtrated, and concentrated without trouble. The solid matter concentration of the resultant cellulose acylate solution (LB2) was found to be 22.4% by mass. Thus, the concentration of the cellulose acylate was calculated to be 20.0% by mass.

### <Composition of Cellulose Acylate Solution (LA2)>

| | |
|---|---|
| Cellulose acylate (CA2) | 100 parts by mass |
| Methylene chloride | 438 parts by mass |
| Methanol | 70 parts by mass |
| 1-Butanol | 4 parts by mass |
| Compound which decreases | 12 parts by mass |
| optical anisotropy (119) | |

### (Preparation of Mat Agent Solution)

A mat agent solution (LC2) was prepared in the same manner as in Example 1 except that the dispersion composition was changed as follows.

### <Composition of Mat Agent Solution (LC2)>

| | |
|---|---|
| Silica particle dispersion having | 12.0 parts by mass |
| a mean particle size of 16 nm | |
| Methylene chloride | 76.6 parts by mass |
| Methanol | 3.7 parts by mass |
| 1-Butanol | 0.8 parts by mass |
| Cellulose acylate solution (LA2) | 11.3 parts by mass |

### (Preparation of Additive Solution)

The following composition was prepared and filtrated through a filter having a mean pore size of 47 μm, whereby an additive solution (LD2) was prepared.

### <Composition of Additive Solution (LD2)>

| | |
|---|---|
| Wavelength dispersion regulator (UV-102) | 7.3 parts by mass |
| Methylene chloride | 55.2 parts by mass |
| Methanol | 9.6 parts by mass |
| 1-Butanol | 0.6 parts by mass |
| Cellulose acylate solution (LA2) | 12.8 parts by mass |

### [Manufacture of Cellulose Ester Film (F2) of the Invention]

A cellulose ester film (F2) of the invention was obtained in the same manner as in Example 1 from the cellulose acylate solution (LB2), the mat agent solution (LC2), and the additive solution (LD2). The film thickness was found to be 39 μm and the residual amount of the solvent at winding was found to be 0.2%. The appearance of the film was so smooth as mirror surface and foreign matter was hardly observed. Re retardation was found to be 1.5 nm or less and Rth retardation was found to be between −5 nm and +5 nm. The elastic modulus was found to be 4.9 GPa in the casting direction and 4.5 GPa in the width direction. The number of luminous foreign matter was so small as 40 or less.

### Example 3

### Preparation of Cellulose Acylate Solution

When a cellulose acylate solution was prepared in the same manner as in Example 1 using the following composition, the composition was dissolved, filtrated, and concentrated without trouble. The solid matter concentration of the resultant cellulose acylate solution (LB3) was found to be 23.2% by mass. Thus, the concentration of the cellulose acylate was calculated to be 20.7% by mass.

### <Composition of Cellulose Acylate Solution (LA3)>

| | |
|---|---|
| Cellulose acylate (CA3) | 100 parts by mass |
| Methylene chloride | 391 parts by mass |
| Methanol | 70 parts by mass |
| 1-Butanol | 15 parts by mass |
| Compound which decreases | 12 parts by mass |
| optical anisotropy (119) | |

### (Preparation of Mat Agent Solution)

A mat agent solution (LC3) was prepared in the same manner as in Example 1 except that the dispersion composition was changed as follows.

### <Composition of Mat Agent Solution (LC3)>

| | |
|---|---|
| Silica particle dispersion having | 12.0 parts by mass |
| a mean particle size of 16 nm | |
| Methylene chloride | 67.3 parts by mass |
| Methanol | 12.0 parts by mass |
| 1-Butanol | 2.4 parts by mass |
| Cellulose acylate solution (LA3) | 11.3 parts by mass |

### (Preparation of Additive Solution)

The following composition was prepared and filtrated through a filter having a mean pore size of 47 μm, whereby an additive solution (LD3) was prepared.

### <Composition of Additive Solution (LD3)>

| | |
|---|---|
| Wavelength dispersion regulator (UV-102) | 7.3 parts by mass |
| Methylene chloride | 53.8 parts by mass |
| Methanol | 9.7 parts by mass |
| 1-Butanol | 2.0 parts by mass |
| Cellulose acylate solution (LA3) | 12.8 parts by mass |

### [Manufacture of Cellulose Ester Film (F3) of the Invention]

A cellulose ester film (F3) of the invention was obtained from the cellulose acylate solution (LB3), the mat agent solution (LC3), and the additive solution (LD3). The film thickness was found to be 80 μm and the residual amount of the solvent at winding was found to be 0.4%. The appearance of the film was so smooth as mirror surface and foreign matter was hardly observed. Re retardation was found to be 1.5 nm or less and Rth retardation was found to be between −5 nm and +5 nm. The elastic modulus was found to be 4.6 GPa in the casting direction and 4.3 GPa in the width direction. The number of luminous foreign matter was so small as 40 or less.

### Example 4

### Preparation of Cellulose Acylate Solution

A cellulose acylate solution was prepared in the same manner as in Example 1 using the following composition, and the composition was dissolved under heating and was filtrated through a filter. The filtration blockage coefficient was so small as 353/m³ and the progress of clogging was slow. Thereafter, the solution was concentrated in the same manner as in Example 1 and again filtrated through sintered metal filters having a mean pore size of 15 μm and a mean pore size of 10 μm sequentially. The solid matter concentration of the resultant cellulose acylate solution (LB4) was found to be 24.1% by mass. Thus, the concentration of the cellulose acylate was calculated to be 21.5% by mass.

### <Composition of Cellulose Acylate Solution (LA4)>

| | |
|---|---|
| Cellulose acylate (CA4) | 100 parts by mass |
| Methylene chloride | 391 parts by mass |
| Methanol | 70 parts by mass |
| 1-Butanol | 15 parts by mass |
| Compound which decreases | 12 parts by mass |
| optical anisotropy (119) | |

### (Preparation of Mat Agent Solution)

A mat agent solution (LC4) was prepared in the same manner as in Example 1 except that the dispersion composition was changed as follows.

### <Composition of Mat Agent Solution (LC4)>

| | |
|---|---|
| Silica particle dispersion having | 12.0 parts by mass |
| a mean particle size of 16 nm | |
| Methylene chloride | 67.3 parts by mass |
| Methanol | 12.0 parts by mass |
| 1-Butanol | 2.4 parts by mass |
| Cellulose acylate solution (LA4) | 11.3 parts by mass |

### (Preparation of Additive Solution)

The following composition was prepared and filtrated through a filter having a mean pore size of 47 μm, whereby an additive solution (LD4) was prepared.

### <Composition of Additive Solution (LD4)>

| | |
|---|---|
| Wavelength dispersion regulator (UV-102) | 7.3 parts by mass |
| Methylene chloride | 53.8 parts by mass |
| Methanol | 9.7 parts by mass |
| 1-Butanol | 2.0 parts by mass |
| Cellulose acylate solution (LA4) | 12.8 parts by mass |

### (Preparation of Mixed Solvent Solution for Dilution)

The following composition was prepared and filtrated through a filter having a mean pore size of 14 μm, whereby an mixed solvent solution for dilution (LE4) was prepared.

### <Composition of Additive Solution (LE4)>

| | |
|---|---|
| Methylene chloride | 82 parts by mass |
| Methanol | 15 parts by mass |
| 1-Butanol | 3 parts by mass |

### [Manufacture of Cellulose Ester Film (F4) of the Invention]

Eighty parts by mass of the cellulose acylate solution (LB4) and 2.6 parts by mass of the additive solution (LD4) were delivered in that ratio and mixed in a static mixer. The mixed solution was delivered into a slit in the central part of a pressure die for three-layer lamination casting so that film thickness after drying became 74 μm. On the other hand, 80 parts by mass of the cellulose acylate solution (LB4), 2.4 parts by mass of the mat agent solution (LC4), 2.6 parts by mass of the additive solution (LD4), and 5 parts by mass of the mixed solvent solution for dilution (LE4) were delivered in that ratio and mixed in a static mixer. The mixed solution was delivered into slits in the both end parts of a pressure die for three-layer lamination casting so that film thickness after drying became 3 μm. Thus, the solutions were laminated into three layers and cast onto a stainless steel drum cooled to −15° C. After cooled until the liquid temperature reached about −10° C., a film was peeled off from the drum and it was fixed on a tenter apparatus. On this occasion, the traveling speed of the tenter was 1.1 times larger than the drum speed. The drying temperature in the tenter apparatus was changed from 70° C. to 130° C. stepwise. The film width at the outlet of the tenter apparatus was made 1.05 times the film width at the inlet. After discharged from the tenter apparatus, the film was further dried at 130 to 140° C. and then wound. Thus, a cellulose ester film (F4) of the invention was obtained. The film thickness was found to be 80.2 μm and the residual amount of the solvent at winding was found to be 0.4%. The appearance of the film was so smooth as mirror surface and foreign matter was hardly observed. Re retardation was found to be 1.5 nm or less and Rth retardation was found to be between −5 nm and +5 nm. The elastic modulus was found to be 4.8 GPa in the casting direction and 4.3 GPa in the width direction. The number of luminous foreign matter was so small as 52 or less.

### Example 5

The film (F5) of the invention was manufactured in the same manner as in Example 3 except that the cellulose acylate (CA5) was used instead of the cellulose acylate (CA3) of Example 3. The film (F5) has Re retardation of 1.5 nm or less and Rth retardation of a value between −5 nm and +5 nm. The elastic modulus was found to be 4.6 GPa in the casting direction and 4.4 GPa in the width direction. Also, the water vapor permeability was so excellent as 400 or less but streak-like unevenness was formed.

### Example 6

The film (F6) of the invention was manufactured in the same manner as in Example 3 except that the cellulose acylate (CA6) was used instead of the cellulose acylate (CA3) of Example 3. The film (F5) has Re retardation of 1.5 nm or less and Rth retardation of a value between −5 nm and +5 nm. The elastic modulus was found to be 4.6 GPa in the casting direction and 4.4 GPa in the width direction. Also, the water vapor permeability was so excellent as 400 or less. However, when the cellulose acylate solution (LA6) prepared here was filtrated through a filter having a mean pore size of 47 μm, the blockage coefficient at that time was so large as 1230 and the clogging occurred shortly. Moreover, the film (F6) showed number of luminous foreign matter of 200 or more.

### Example 7

The film (F7) of the invention was manufactured in the same manner as in Example 3 except that the cellulose acylate (CA7) was used instead of the cellulose acylate (CA3) of Example 3. The film (F5) has Re retardation of 1.5 nm or less and Rth retardation of a value between −5 nm and +5 nm. The elastic modulus was found to be 4.6 GPa in the casting direction and 4.4 GPa in the width direction. Also, the water vapor permeability was so excellent as 400 or less. However, when the cellulose acylate solution (LA7) prepared here was filtrated through a filter having a mean pore size of 14 μm, the blockage coefficient at that time was so large as 1370 and the clogging occurred shortly. Moreover, the film (F7) showed number of luminous foreign matter of 200 or more.

### Example 8

### Preparation of Cellulose Acylate Solution

The composition of the formulation the same as in Example 2 (composition of the cellulose acetate solution LA2) was charged into a mixing tank and stirred to dissolve individual components. The solution was delivered to a heat exchanger (a static mixer with a jacket) by means of a gear pump and the temperature was kept at a temperature of from 130 to 160° C. for 10 minutes. Then, the solution was cooled to 30° C. in a cooling heat exchanger (a static mixer with a jacket). The solution was filtrated through a filter having a mean pore size of 34 μm. The blockage coefficient at this time was so small as 195/m³ and the progress of clogging was slow. The resultant cellulose acylate solution was again delivered to a heat exchanger (a static mixer with a jacket) by means of a gear pump. After the temperature of the solution was raised to 86° C., the solution was introduced into a flush concentration apparatus and concentrated and then again filtrated through a metal mesh filter having a pore size of 10 μm. The solid matter concentration of the resultant cellulose acylate solution (LB2-2) was found to be 22.4% by mass. Thus, the concentration of the cellulose acylate was calculated to be 20.0% by mass.

[Manufacture of Cellulose Ester Film (F8) of the Invention]

A cellulose ester film (F8) of the invention was obtained from the cellulose acylate solution (LB2-2), the mat agent solution (LC2), and the additive solution (LD2). The film thickness was found to be 40 μm and the residual amount of the solvent at winding was found to be 0.2%. The appearance of the film was so smooth as mirror surface and foreign matter was hardly observed. Re retardation was found to be 1.5 nm or less and Rth retardation was found to be between −5 nm and +5 nm. The elastic modulus was found to be 4.6 GPa in the casting direction and 4.3 GPa in the width direction. The number of luminous foreign matter was so small as 40 or less.

### Example 9

### Preparation of Cellulose Acylate Solution

The composition of the formulation the same as in Example 3 (composition of the cellulose acetate solution LA3) was placed in a glass pressure vessel and the whole was irradiated for 20 minutes by means of a microwave generating apparatus of 2450 MHz under stirring and thereby heated to 140° C. After kept at the temperature for 2 minutes, the composition was cooled to 30° C. using cold water and filtrated through a filter having a mean pore size of 34 μm to obtain a cellulose acylate solution (LB3-2). The solid matter concentration of LB3-2 was found to be 23.2% by mass. Thus, the concentration of the cellulose acylate was calculated to be 20.7% by mass.

[Manufacture of Cellulose Ester Film (F9) of the Invention]

A cellulose ester film (F9) of the invention was obtained in the same manner as in Example 1 except that 76.2 parts by mass of the cellulose acylate solution (LB3-2), 1.8 parts by mass of the mat agent solution (LC3), and 2.6 parts by mass of the additive solution (LD3) were charged into the mixer tank and mixed. The film thickness was found to be 80 μm and the residual amount of the solvent at winding was found to be 0.4%. The appearance of the film was so smooth as mirror surface and foreign matter was hardly observed. Re retardation was found to be 1.5 nm or less and Rth retardation was found to be between −5 nm and +5 nm. The elastic modulus was found to be 4.9 GPa in the casting direction and 4.5 GPa in the width direction. The number of luminous foreign matter was so small as 40 or less.

### Comparative Example 1

A cellulose acylate solution (LA8) of Comparative Example was prepared in the same manner as in Example 3 except that the cellulose acylate (CA8) was used instead of the cellulose acylate (CA3) of Example 3.

### <Composition of Cellulose Acylate Solution (LA8)>

| | |
|---|---|
| Cellulose acylate (CA8) | 100 parts by mass |
| Methylene chloride | 391 parts by mass |
| Methanol | 70 parts by mass |
| 1-Butanol | 15 parts by mass |
| Compound which decreases | 12 parts by mass |
| optical anisotropy (119) | |

When the solution (LA8) was filtrated through a filter having a mean pore size of 47 μm, filtration pressure was too high to filtrate the solution.

### Comparative Example 2

In a static mixer, 76.2 parts by mass of the cellulose acylate solution (LA1) prepared in Example 1, 1.6 parts by mass of the mat agent solution (LC1), and 2.3 parts by mass of the additive solution (LD1) were mixed each other and the mixture was homogeneously cast onto a stainless steel band whose surface temperature was 20° C. After dried until the residual solvent content reached a value of from 60 to 80%, a film was peeled off from the stainless steel band and it was fixed on a tenter apparatus. On this occasion, the traveling speed of the tenter was 1.02 times larger than the band speed. The drying temperature in the tenter apparatus was changed from 70° C. to 130° C. stepwise. The film width at the outlet of the tenter apparatus was made 1.01 times the film width at the inlet. After discharged from the tenter apparatus, the film was further dried at 130 to 140° C. and then wound. Thus, a cellulose ester film (F10) of Comparative Example having a film thickness of 81 μm was obtained. The residual amount of the solvent at winding was found to be 0.4%. The appearance of the film was so smooth as mirror surface and foreign matter was hardly observed. Re retardation was found to be 1.5 nm or less and Rth retardation was found to be between −5 nm and +5 nm. The elastic modulus was found to be 4.0 GPa in the casting direction and 3.9 GPa in the width direction, which were smaller than those of the cooling gelation cast films of Examples. Moreover, the water vapor permeability exceeded 500 and was large. The number of luminous foreign matter was so small as 40 or less.

### Comparative Example 3

A cellulose ester film (F11) of Comparative Example was obtained in the same manner as Comparative Example 2 except that the cellulose acylate solution (LA2) prepared in Example 2, the mat agent solution (LC2), and the additive solution (LD2) were used. The residual amount of the solvent at winding was found to be 0.4%. The appearance of the film was so smooth as mirror surface and foreign matter was hardly observed. Re retardation was found to be 1.5 nm or less and Rth retardation was found to be between −5 nm and +5 nm. The elastic modulus was found to be 4.1 GPa in the casting direction and 3.9 GPa in the width direction, which were smaller than those of the cooling gelation cast films of Examples. Moreover, the water vapor permeability exceeded 500 and was large. The number of luminous foreign matter was so small as 40 or less.

TABLE 1

| | | | Properties of cellulose acylate used | | | | | | Properties of cellulose acylate solution | | | | |
|---|---|---|---|---|---|---|---|---|---|---|---|---|---|
| | | | | | | Average molecular mass | | | | | | Ratio | |
| | | | | | | and molecular mass | | | | | | of 6% | Blockage |
| | Cellulose | Original | Substitution | | | distribution | | | | | | viscosity | co- |
| | acylate | raw | degree | | 6% viscosity | | | Mw/ | E′(25) | E′(70) | E′(70)/ | to | efficient |
| | No. | material | Acetyl | Propionyl | (mPa · s) | Mn | Mw | Mn | (Pa) | (Pa) | E′(25) | E′(25) | (m⁻³) |
| Example 1 | CA1 | Linter | 2.95 | 0.00 | 382 | 104000 | 274000 | 2.6 | 57.3 | 45.9 | 0.80 | 6.7 | 222 |
| Example 2 | CA2 | Linter | 2.95 | 0.00 | 429 | 108000 | 281000 | 2.6 | 72.6 | 52.3 | 0.72 | 5.9 | 203 |
| Example 3 | CA3 | Pulp | 2.39 | 0.56 | 361 | 86000 | 275000 | 3.2 | 58.2 | 39.6 | 0.68 | 6.2 | 246 |
| Example 4 | CA4 | Pulp | 2.97 | 0.00 | 324 | 72000 | 219000 | 3.0 | 57.9 | 37.6 | 0.65 | 5.6 | 353 |
| Example 5 | CA5 | Pulp | 2.93 | 0.00 | 95 | 78000 | 151000 | 1.9 | 44.7 | 23.8 | 0.53 | 2.1 | 946 |
| Example 6 | CA6 | Linter | 2.96 | 0.00 | 515 | 84000 | 291000 | 3.5 | 259 | 103 | 0.40 | 2.0 | 1230 |
| Example 7 | CA7 | Linter | 2.91 | 0.00 | 759 | 116000 | 324000 | 2.8 | 330 | 142 | 0.43 | 2.3 | 1370 |
| Example 8 | Same as Example 2 | | | | | | | | | | | | 195 |
| Example 9 | Same as Example 3 | | | | | | | | | | | | 227 |
| Comparative | CA8 | Pulp | 2.96 | 0.00 | 865 | 88000 | 358000 | 4.2 | 360 | 159 | 0.44 | 2.4 | — |
| Example 1 | | | | | | | | | | | | | |

| | |
|---|---|
| Comparative | Same as Example 1 |
| Example 2 | |
| Comparative | Same as Example 2 |
| Example 3 | |

Film properties

| | | Number of | |
|---|---|---|---|
| | | luminous foreign | Water vapor permeability |
| | Film No. | matter | g/m²/day |
| Example 1 | F1 | 30 | 395 |
| Example 2 | F2 | 22 | 815 |
| Example 3 | F3 | 18 | 405 |
| Example 4 | F4 | 52 | 390 |
| Example 5 | F5 | 163 | 395 |
| Example 6 | F6 | 470 | 390 |
| Example 7 | F7 | 372 | 400 |
| Example 8 | F8 | 25 | 806 |
| Example 9 | F9 | 31 | 395 |
| Comparative | — | — | — |
| Example 1 | | | |
| Comparative | F10 | 28 | 520 |
| Example 2 | | | |
| Comparative | F11 | 17 | 501 |
| Example 3 | | | |

### Example 9

### Manufacture of Polarizing Plate

The cellulose acylate film (F1) obtained in Example 1 was immersed in 1.5; N sodium hydroxide aqueous solution at 55° C. for 2 minutes. The film was washed in a water-washing bath at room temperature and then neutralized with 0.1; N sulfuric acid. The film was again washed in a water-washing bath at room temperature and further dried with warm air of 100° C. Thus, a surface-saponified cellulose acylate film (F101) was obtained. A commercially available cellulose acetate film TD80UF (manufactured by Fuji Photo Film Co., Ltd.) was also subjected to the surface saponification treatment in the same manner to prepare a film (F100).

Subsequently, a rolled polyvinyl alcohol film having a thickness of 80 μm was continuously stretched 5 times in an aqueous iodine solution and dried to obtain a polarization film. Using a 3% polyvinyl alcohol (PVA-117H manufactured by Kurarey Co., Ltd.) aqueous solution as an adhesive, the film (F101) was attached on one side of the polarization film and the film (F100) on the opposite side to obtain a polarizing plate (P1). On this occasion, the attachment was performed so that the slow axes of the films (F101) and (F100) became parallel to the transmission axis of the polarization film.

Similarly, from the cellulose acylate films (F2) to (F4), (F8), and (F9), polarizing plates (P2) to (P4), (P8), and (P9) were manufactured, respectively. All the cellulose acylate films of the invention had a sufficient attaching ability and an excellent processing suitability for polarizing plate.

### Example 10

### Mounting on Liquid-Crystal Display Device

### <Manufacture of Facing Polarizing Plate>

A polarizing plate (P0) was manufactured in the same manner as in Example 5 except that the film (F100) (a saponified commercially available cellulose acetate film) was used as the both films to be attached to the both sides of the polarization film.

### <Manufacture of IPS-mode Liquid-Crystal Cell 1>

On one glass substrate, electrodes were provided so that distance between neighboring electrodes became 20 μm. A polyimide film was provided thereon as an orientation film, followed by rubbing treatment. A polyimide film was provided on one glass substrate separately prepared and then subjected to rubbing treatment to form an orientation film. The two glass substrates were superposed and attached with facing the orientation films each other so that the distance between the substrates (gap; d) was 3.9 μm and the rubbing directions of the two glass substrates were parallel to each other. Then, a nematic liquid-crystal composition having a refractive index anisotropy (Δn) of 0.0769 and a dielectric constant anisotropy (Δε) of +4.5 was included. The value d·Δn of the liquid crystal layer was found to be 300 nm.

Each of the polarizing plates (P1) to (P9) manufactured in Example 9 was attached to the backlight side of the manufactured IPS-mode liquid-crystal cell so that the absorption axis became parallel to the rubbing direction of the liquid-crystal cell and the cellulose acylate film of the invention faced the liquid-crystal cell side. Subsequently, the polarizing plate P0 was attached to another side of the IPS-mode liquid-crystal cell in a cross-Nicol position.

Back tint of the liquid-crystal display device thus manufactured was observed at all azimuthal angle directions at an angle of 60 degree but change in tint was hardly observed. In addition, visible luminous foreign matter was also not observed.

### INDUSTRIAL APPLICABILITY

According to the invention, a substantially optically isotropic cellulose acylate film having a small optical anisotropy (Re, Rth) can be rapidly formed and the production cost can be reduced.

Moreover, according to the invention, a cellulose acylate film having larger elastic modulus and smaller water vapor permeability as compared with conventional ones can be obtained.

Furthermore, according to a further preferred embodiment, in addition to the above properties, a cellulose acylate film containing little luminous foreign matter can be provided.

The entire disclosure of each and every foreign patent application from which the benefit of foreign priority has been claimed in the present application is incorporated herein by reference, as if fully set forth.

1. A process for producing a cellulose acylate film comprising:
casting a solution of a cellulose acylate having an acyl substitution degree of from 2.85 to 3.00 dissolved in at least one organic solvent onto an endless metal support;
cooling the solution at 0° C. to −50° C. to effect gelation, so as to form a film;
peeling the film off from the endless metal support; and
drying the film.

2. The process for producing a cellulose acylate film according to claim 1, wherein the solution is a cellulose acylate solution containing a cellulose acylate in an amount of from 18 to 24% by mass.

3. The process for producing a cellulose acylate film according to claim 1, wherein the cellulose acylate is dissolved in at least one organic solvent at a temperature of 70° C. or higher.

4. The process for producing a cellulose acylate film according to claim 3, wherein the cellulose acylate is dissolved in at least one organic solvent under heating in line.

5. The process for producing a cellulose acylate film according to claim 3, wherein the cellulose acylate is dissolved in at least one organic solvent under heating by utilizing a microwave.

6. The process for producing a cellulose acylate film according to claim 1, wherein the cellulose acylate is a cellulose acylate having a parameter of from 2.5 to 14.0, in which the parameter is obtained by dividing a 6% viscosity value of the cellulose acylate by a storage elastic modulus E′ (25) value of a 17% by mass solution when dissolved at 25° C.

7. The process for producing a cellulose acylate film according to claim 1, wherein the acyl group of the cellulose acylate is an acetyl group.

8. A cellulose acylate film produced by a process according to claim 1.

9. The cellulose acylate film according to claim 8, which has an absolute value of a retardation in a thickness direction Rth of 25 nm or less.

10. The cellulose acylate film according to claim 8, which has an elastic modulus of from 4.2 GPa to 6.0 GPa.

11. The cellulose acylate film according to claim 8,
wherein a water vapor permeability of the cellulose acylate film when a thickness of the cellulose acylate film is converted into 80 μm is from 350 to 450 g/m²/day.

12. An optically-compensatory film comprising a cellulose acylate film according to claim 8.

13. A polarizing plate comprising:
a polarizer; and
at least one cellulose acylate film according to claim 8,
wherein the at least one cellulose acylate film is utilized as a protective film of the polarizer.

14. A liquid-crystal display device comprising a cellulose acylate film according to claim 8.

15-16. (canceled)
